(19) United States
(12) Patent Application Publication
(10) Pub. No.: US 2026/0197047 A1
(43) Pub. Date: Jul. 9, 2026

(54) COORDINATED BEAMFORMING INFORMATION EXCHANGE FOR A TRANSMISSION PHASE

(71) Applicant: QUALCOMM Incorporated, San Diego, CA (US)

(72) Inventors: Jialing Li CHEN, San Diego, CA (US); Sameer VERMANI, San Diego, CA (US); Bin TIAN, San Diego, CA (US); Youhan KIM, Saratoga, CA (US); Alfred ASTERJADHI, San Diego, CA (US); Sherief HELWA, San Diego, CA (US); Ahmed Ragab ELSHERIF, San Jose, CA (US)

(21) Appl. No.: 19/437,883

(22) Filed: Dec. 31, 2025

Related U.S. Application Data
(60) Provisional application No. 63/741,742, filed on Jan. 3, 2025.
(60) Provisional application No. 63/754,484, filed on Feb. 5, 2025.
(60) Provisional application No. 63/767,506, filed on Mar. 5, 2025.
(60) Provisional application No. 63/801,728, filed on May 7, 2025.

(51) Int. Cl. H04B 7/06; H04W 28/02

(52) U.S. Cl. CPC H04B 7/0617; H04W 28/0278

(57) ABSTRACT

This disclosure provides methods, components, devices and systems for coordinated beamforming (CoBF) information exchange for a transmission phase. Some aspects more specifically relate to information exchange between access points (APs) to support a transmission phase for a CoBF procedure and, additionally, or alternatively, a C-SR procedure. In some examples, a first AP may transmit an invite message associated with a CoBF procedure, the invite message comprising information that pertains to a universal signal (U-SIG), information that pertains to at least one of a legacy signal (L-SIG) and a common field of a ultra-high reliability signal (UHR-SIG), and user information associated with one or more user fields of the UHR-SIG. The first AP may receive, from a second AP and in response to transmission of the invite message, a response message associated with the CoBF procedure.

### CROSS REFERENCES

This patent application claims the benefit of U.S. Provisional Patent Application No. 63/801,728 by CHEN et al., entitled “COORDINATED BEAMFORMING INFORMATION EXCHANGE FOR A TRANSMISSION PHASE,” filed May 7, 2025, U.S. Provisional Patent Application No. 63/767,506 by CHEN et al., entitled “COORDINATED BEAMFORMING INFORMATION EXCHANGE FOR A TRANSMISSION PHASE,” filed Mar. 5, 2025, U.S. Provisional Patent Application No. 63/754,484 by CHEN et al., entitled “COORDINATED BEAMFORMING INFORMATION EXCHANGE FOR A TRANSMISSION PHASE,” filed Feb. 5, 2025, and U.S. Provisional Patent Application No. 63/741,742 by CHEN et al., entitled “COORDINATED BEAMFORMING INFORMATION EXCHANGE FOR A TRANSMISSION PHASE,” filed Jan. 3, 2025, each of which is assigned to the assignee hereof, and each of which is expressly incorporated by reference in its entirety herein.

### TECHNICAL FIELD

This disclosure relates generally to wireless communication and, more specifically, to coordinated beamforming (CoBF) information exchange for a transmission phase. Various aspects relate generally to information exchange for a CoBF transmission phase, and related techniques for information exchange for coordinated spatial reuse (C-SR) transmission. In some implementations, some aspects more specifically relate to a multistage information exchange associated with a transmission phase of a CoBF procedure. In some implementations, some aspects more specifically relate to C-SR transmission, which may also use a multistage information exchange or, additionally, or alternatively, a single stage information exchange, prior to the C-SR transmission.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first access point (AP), as described. The method may include transmitting an invite message associated with a coordinated beamforming (CoBF) procedure, the invite message including baseline information that includes control information and preamble information, where the preamble information includes information that pertains to a universal signal (U-SIG), information that pertains to at least one of a legacy signal (L-SIG) and a common field of an ultra-high reliability signal (UHR-SIG), user information associated with one or more user fields of the UHR-SIG, or any combination thereof and receiving, from a second AP and in response to transmission of the invite message, a response message associated with the CoBF procedure.

Another innovative aspect of the subject matter described in this disclosure can be implemented in a first AP for wireless communications, as described. The first AP may include a processing system that includes processor circuitry and memory circuitry that stores code. The processing system may be configured to cause the first AP to transmit an invite message associated with a CoBF procedure, the invite message including baseline information that includes control information and preamble information, where the preamble information includes information that pertains to a U-SIG, information that pertains to at least one of a L-SIG and a common field of an UHR-SIG, user information associated with one or more user fields of the UHR-SIG, or any combination thereof and receive, from a second AP and in response to transmission of the invite message, a response message associated with the CoBF procedure.

Another innovative aspect of the subject matter described in this disclosure can be implemented in another first AP for wireless communications, as described. The first AP may include means for transmitting an invite message associated with a CoBF procedure, the invite message including baseline information that includes control information and preamble information, where the preamble information includes information that pertains to a U-SIG, information that pertains to at least one of a L-SIG and a common field of an UHR-SIG, user information associated with one or more user fields of the UHR-SIG, or any combination thereof and means for receiving, from a second AP and in response to transmission of the invite message, a response message associated with the CoBF procedure.

Another innovative aspect of the subject matter described in this disclosure can be implemented in a non-transitory computer-readable medium storing code for wireless communications is described. The code may include instructions executable by one or more processors to transmit an invite message associated with a CoBF procedure, the invite message including baseline information that includes control information and preamble information, where the preamble information includes information that pertains to a U-SIG, information that pertains to at least one of a L-SIG and a common field of an UHR-SIG, user information associated with one or more user fields of the UHR-SIG, or any combination thereof and receive, from a second AP and in response to transmission of the invite message, a response message associated with the CoBF procedure.

Some examples of the method, first APs, and non-transitory computer-readable medium described herein may further include operations, features, means, or instructions for transmitting, in response to reception of the response message, a synchronization message that indicates that the CoBF procedure may be to begin.

In some examples of the method, first APs, and non-transitory computer-readable medium described herein, the synchronization message includes second baseline information, the second baseline information includes second control information and second preamble information, and the second preamble information includes information that pertains to a second U-SIG, information that pertains to at least one of a second L-SIG and a common field of a second UHR-SIG, second user information associated with one or more user fields of the second UHR-SIG, or any combination thereof.

In some examples of the method, first APs, and non-transitory computer-readable medium described herein, the synchronization message indicates optional information and the optional information includes third information that pertains to a second U-SIG, third information that pertains to at least one of a second L-SIG and a common field of a second UHR-SIG, third user information associated with one or more user fields of the second UHR-SIG, or any combination thereof.

In some examples of the method, first APs, and non-transitory computer-readable medium described herein, the invite message, the response message, the synchronization message, or any combination thereof includes a trigger frame, wherein the trigger frame includes a buffer status report poll (BSRP) trigger frame, a station-specific BSRP trigger frame, a multi-user request-to-send (MU-RTS) trigger frame, a MU-RTS transmit opportunity sharing (TXS) trigger frame, a new trigger type frame, or any combination thereof, and the invite message, the response message, the synchronization message, or any combination thereof triggers transmission of a physical layer protocol data unit (PPDU) including a quality of service (QoS) null frame, a BlockAck frame, a multi-station BlockACK frame, or any combination thereof.

In some examples of the method, first APs, and non-transitory computer-readable medium described herein, the response message indicates participation by the second AP in the CoBF procedure.

In some examples of the method, first APs, and non-transitory computer-readable medium described herein, the response message includes second baseline information that includes second control information and second preamble information, the second control information includes an indication of participation of the second AP in the CoBF procedure, bandwidth information associated with the second AP, synchronization leader information, an immediate response notification, a multi-AP scheme, an information type, or any combination thereof, and the second preamble information includes information that pertains to a second U-SIG, information that pertains to at least one of a second L-SIG and a common field of a second UHR-SIG, second user information associated with one or more user fields of the second UHR-SIG, or any combination thereof.

Another innovative aspect of the subject matter described in this disclosure can be implemented in a method for wireless communications by a second AP, as described. The method may include receiving, from a first AP, an invite message associated with a CoBF procedure, the invite message including baseline information that includes control information and preamble information, where the preamble information includes information that pertains to a U-SIG, information that pertains to at least one of a L-SIG and a common field of an UHR-SIG, user information associated with one or more user fields of the UHR-SIG, or any combination thereof and transmitting, in response to reception of the invite message, a response message associated with the CoBF procedure.

Another innovative aspect of the subject matter described in this disclosure can be implemented in a second AP for wireless communications, as described. The second AP may include a processing system that includes processor circuitry and memory circuitry that stores code. The processing system may be configured to cause the second AP to receive, from a first AP, an invite message associated with a CoBF procedure, the invite message including baseline information that includes control information and preamble information, where the preamble information includes information that pertains to a U-SIG, information that pertains to at least one of a L-SIG and a common field of an UHR-SIG, user information associated with one or more user fields of the UHR-SIG, or any combination thereof and transmit, in response to reception of the invite message, a response message associated with the CoBF procedure.

Another innovative aspect of the subject matter described in this disclosure can be implemented in another second AP for wireless communications, as described. The second AP may include means for receiving, from a first AP, an invite message associated with a CoBF procedure, the invite message including baseline information that includes control information and preamble information, where the preamble information includes information that pertains to a U-SIG, information that pertains to at least one of a L-SIG and a common field of an UHR-SIG, user information associated with one or more user fields of the UHR-SIG, or any combination thereof and means for transmitting, in response to reception of the invite message, a response message associated with the CoBF procedure.

Another innovative aspect of the subject matter described in this disclosure can be implemented in a non-transitory computer-readable medium storing code for wireless communications, as described. The code may include instructions executable by one or more processors to receive, from a first AP, an invite message associated with a CoBF procedure, the invite message including baseline information that includes control information and preamble information, where the preamble information includes information that pertains to a U-SIG, information that pertains to at least one of a L-SIG and a common field of an UHR-SIG, user information associated with one or more user fields of the UHR-SIG, or any combination thereof and transmit, in response to reception of the invite message, a response message associated with the CoBF procedure.

Some examples of the method, second APs, and non-transitory computer-readable medium described herein may further include operations, features, means, or instructions for receiving, in response to transmission of the response message, a synchronization message that indicates that the CoBF procedure may be to begin.

In some examples of the method, second APs, and non-transitory computer-readable medium described herein, the synchronization message includes second baseline information, the second baseline information includes second control information and second preamble information, and the second preamble information includes information that pertains to a second U-SIG, information that pertains to at least one of a second L-SIG and a common field of a second UHR-SIG, second user information associated with one or more user fields of the second UHR-SIG, or any combination thereof.

In some examples of the method, second APs, and non-transitory computer-readable medium described herein, the synchronization message indicates optional information and the optional information includes third information that pertains to a second U-SIG, third information that pertains to at least one of a second L-SIG and a common field of a second UHR-SIG, third user information associated with one or more user fields of the second UHR-SIG, or any combination thereof.

Some examples of the method, second APs, and non-transitory computer-readable medium described herein may further include operations, features, means, or instructions for determining, for inclusion in the invite message or based on information included in the response message, one or more physical layer protocol data unit (PPDU) bandwidth parameters and punctured channel information.

In some examples of the method, second APs, and non-transitory computer-readable medium described herein, the invite message, the response message, the synchronization message, or any combination thereof includes a trigger frame, wherein the trigger frame includes a BSRP trigger frame, a station-specific BSRP trigger frame, a MU-RTS trigger frame, a MU-RTS TXS trigger frame, a new trigger type frame, or any combination thereof, and the invite message, the response message, the synchronization message, or any combination thereof triggers transmission of a PPDU including a QoS null frame, a BlockAck frame, a multi-STA BlockACK frame, or any combination thereof.

In some examples of the method, second APs, and non-transitory computer-readable medium described herein, the response message indicates participation by the second AP in the CoBF procedure.

In some examples of the method, second APs, and non-transitory computer-readable medium described herein, the response message includes second baseline information that includes second control information and second preamble information, the second control information includes an indication of participation of the second AP in the CoBF procedure, bandwidth information associated with the second AP, synchronization leader information, an immediate response notification, a multi-AP scheme, an information type, or any combination thereof, and the second preamble information includes information that pertains to a second U-SIG, information that pertains to at least one of a second L-SIG and a common field of a second UHR-SIG, second user information associated with one or more user fields of the second UHR-SIG, or any combination thereof.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIGS. 4 and 5 show examples of timing diagrams that support coordinated beamforming (CoBF) and coordinated spatial reuse (C-SR) information exchange for a transmission phase.

FIG. 6 shows an example of a process flow that supports CoBF information exchange for a transmission phase.

FIGS. 7A and 7B show examples of timing diagrams that support CoBF information exchange for a transmission phase.

FIG. 8 shows a block diagram of an example wireless communication device that supports CoBF information exchange for a transmission phase.

FIGS. 9 and 10 show flowcharts illustrating example processes performable by or at a first access point that supports CoBF information exchange for a transmission phase.

FIG. 11 shows a block diagram of an example wireless communication device that supports CoBF information exchange for a transmission phase.

FIG. 12 shows a flowchart illustrating an example process performable by or at a first access point that supports CoBF information exchange for a transmission phase.

FIG. 13 shows a flowchart illustrating an example process performable by or at a second access point that supports CoBF information exchange for a transmission phase.

FIG. 14 shows a block diagram of an example wireless communication device that supports coordinated beamforming information exchange for a transmission phase.

FIG. 15 shows a flowchart illustrating an example process performable by or at a first access point that supports coordinated beamforming information exchange for a transmission phase.

FIG. 16 shows a flowchart illustrating an example process performable by or at a second access point that supports coordinated beamforming information exchange for a transmission phase.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communications systems, access points (APs) (e.g., wireless devices, UEs, network entities) may participate in coordinated beamforming (CoBF), coordinated spatial reuse (C-SR), other multi-AP (MAP) schemes (e.g., coordinated time division multi-access (Co-TDMA), joint transmission (JT) from multiple APs to a single user, JT from multiple APs to multiple users associated with a single basic service set (BSS), JT from multiple APs to multiple users associated with multiple BSSs), or any combination thereof. CoBF may enable APs to coordinate beamforming based on measurement or sounding from the APs, and transmission between the APs. This may be divided into at least two phases, including a sounding (e.g., measurement) phase and a transmission phase. Both the sounding phase and the transmission phase may rely on an information exchange between the APs in order to be performed properly. For example, transmissions from different APs may use a common preamble to avoid interference-related issues. The information exchange may allow each AP to determine this common preamble and participate in the phases as expected. However, the sounding phase and the transmission phase may use different transmission opportunities (TXOPs) and bandwidths, which may use different preambles. Information exchange related to both the sounding phase and the transmission phase may be used to generate one common preamble, even though the preamble may change between phases. That is, in order to accommodate these differences, it may be beneficial to separate the information exchange for each phase. Additionally, or alternatively, C-SR may rely on an information exchange before transmission for a C-SR procedure.

Various aspects relate generally to information exchange for a CoBF transmission phase, and related techniques for information exchange for C-SR transmission, as well as other MAP schemes. In some implementations, some aspects more specifically relate to a multistage information exchange associated with a transmission phase of a CoBF procedure. In some cases, the multistage information exchange may include an invite frame, a response frame, and, in some examples, a synchronization (e.g., sync, trigger) frame. For example, an initiating AP (e.g., a sharing AP, TXOP holder) associated with a sharing BSS may transmit an invite message (e.g., frame), which may include baseline information including control information and physical (PHY) preamble information used to form a common preamble in the MAP transmission (e.g., a common preamble in the PPDUs in CoBF transmissions). The preamble information may include information pertaining to a universal signal (U-SIG), legacy signal (L-SIG), a common field of an ultra-high reliability signal (UHR-SIG), one or more user fields of the UHR-SIG, or any combination thereof. A responding AP (e.g., shared AP) associated with the shared BSS may transmit a response message (e.g., response frame), which may indicate an intent to participate in the CoBF transmission phase. Additionally, or alternatively, the response message may include other baseline information pertaining to a U-SIG, L-SIG, UHR-SIG common field, one or more UHR-SIG user fields, or any combination thereof. In some cases, after receiving the response message, the initiating AP, being a synchronization leader (e.g., Sync-Leader, Sync-Reference) as the reference for synchronization, may transmit a sync message to trigger the CoBF transmission phase. In other cases, the responding AP may be designated as a synchronization leader (Sync-Leader), and so may transmit the sync message to the initiating AP. The designation of Sync-Leader may be indicated in the invite message, the response message, the sync message, or any combination thereof. In other cases, the responding AP may be the Sync-Leader and may refrain from transmitting the trigger message, as the trigger message may not include new information for the initiating AP and the response frame could be used for synchronization as well. In some examples, the sync message may be used to transmit other baseline information or optional information. In some examples, the invite message and response message may also carry optional information. The AP that is not designated as the Sync-Leader may be a synchronization follower (Sync-Follower), and may synchronize to the Sync-Leader's frames in time and frequency in the MAP transmission.

In other implementations, some aspects more specifically relate to C-SR transmission, which may also use a multistage information exchange or, additionally, or alternatively, a single stage information exchange, prior to the C-SR transmission. In some implementations, the multi-stage information exchange may, similarly to the CoBF, include an invite message, a response message, and, in some cases, a sync message. The invite message may include information pertaining to an L-SIG or U-SIG, or interference or power control information for the responding AP or initiating AP or any combination thereof, and bandwidth information for the responding AP, or any combination thereof, in some cases. The response message may include an intent to participate in the C-SR transmission, as well as interference or power control information for the responding AP or initiating AP or any combination thereof, and bandwidth information for the responding AP, or any combination thereof, in some cases. The sync message may include the trigger indication and, in some cases, interference or power control information for the responding AP or initiating AP or any combination thereof. This may allow for synchronous transmissions. In other implementations, the multi-stage information exchange may rely on a two frame procedure and may allow for asynchronous transmissions. The two frame procedure may include invite and response messages, which may indicate information, as discussed with respect to the three-frame implementation. In other implementations, the single stage information exchange may combine the invite and sync frame from the initiating AP. The combined message may include information pertaining to a U-SIG, L-SIG, or interference or power control information, or any combination thereof. The initiating AP may assume the responding AP may participate in the C-SR, as the responding AP may not transmit a response message.

Particular aspects of the subject matter described in this disclosure can be implemented to realize one or more of the following potential advantages. In some examples, by including an information exchange specific to a transmission phase for CoBF, the described techniques can be used to limit interference during the transmission phase of CoBF and improve communication reliability. In some examples, by including an information exchange specific to C-SR transmission, the described techniques can be used to limit interference during the C-SR transmission and improve communication reliability.

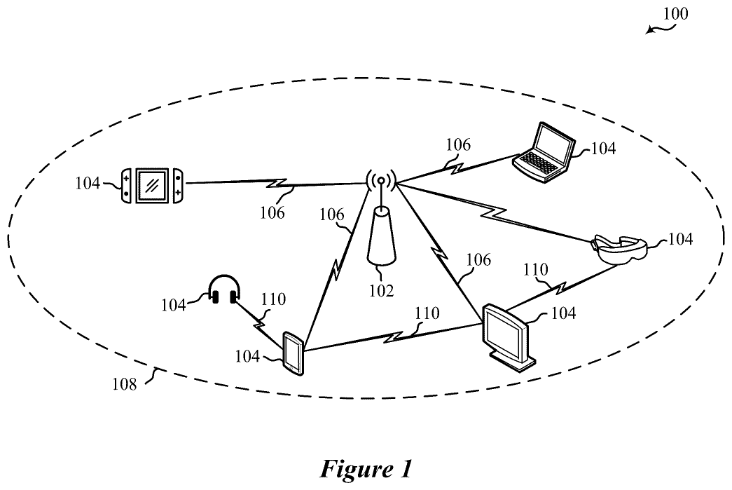

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled with a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

Some wireless communication networks 100 may support information exchange for a CoBF transmission phase, and related techniques for information exchange for C-SR transmission. In some implementations, APs 102 may perform a multistage information exchange associated with a transmission phase of a CoBF procedure. In some cases, the multistage information exchange may include an invite frame, a response frame, and, in some examples, a sync frame (e.g., trigger frame). For example, an initiating AP 102 may transmit an invite message (e.g., frame), which may include baseline information including control information and preamble information. The preamble information may include information pertaining to a U-SIG, L-SIG, a common field of a UHR-SIG, one or more user fields of the UHR-SIG, or any combination thereof. A responding AP 102 may transmit a response message (e.g., response frame), which may indicate an intent to participate in the CoBF transmission phase and may include baseline information, optional information, or both. Additionally, or alternatively, the response message may include information pertaining to a U-SIG, L-SIG, UHR-SIG common field, one or more UHR-SIG user fields, or any combination thereof. In some cases, after receiving the response message, the initiating AP 102 may transmit a trigger message to trigger the CoBF transmission phase. In other cases, the responding AP 102 may be designated as a Sync-Leader, and so may transmit the sync message to the initiating AP 102, which may include other baseline information, optional information, or both. The designation of Sync-Leader may be indicated in the invite message, the response message, or both. In other cases, the responding AP 102 may be the Sync-Leader and may refrain from transmitting the sync message, as the sync message may not include new information for the initiating AP 102.

In some implementations, APs 102 may perform C-SR transmission, which may also use a multistage information exchange or, additionally, or alternatively, a single stage information exchange, prior to the C-SR transmission. In some implementations, the multi-stage information exchange may, similarly to the CoBF, include an invite message, a response message, and, in some cases, a sync message. The invite message may include L-SIG and U-SIG information, as well as interference or power control information and bandwidth information, in some cases. The response message may include an intent to participate in the C-SR transmission, as well as interference or power control information and bandwidth information, in some cases. The sync message may include the trigger indication and, in some cases, interference or power control information. This may allow for synchronous transmissions. In other implementations, the multi-stage information exchange may rely on a two frame procedure and may allow for asynchronous transmissions. The two frame procedure may include invite and response messages, which may indicate information, as discussed with respect to the three-frame implementation. In other implementations, the single stage information exchange may combine the invite and trigger frame from the initiating AP 102. The combined message may include U-SIG information, L-SIG information, and interference or power control information. The initiating AP 102 may assume the responding AP 102 may participate in the C-SR, as the responding AP 102 may not transmit a response message.

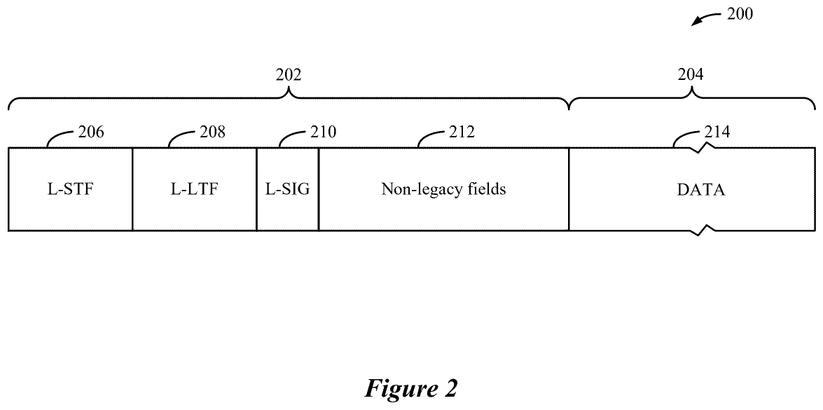

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

Some wireless communications networks may support information exchange for a CoBF transmission phase, and related techniques for information exchange for C-SR transmission. In some implementations, APs may perform a multistage information exchange associated with a transmission phase of a CoBF procedure. In some cases, the multistage information exchange may include an invite frame, a response frame, and, in some examples, a trigger frame. For example, an initiating AP may transmit an invite message (e.g., frame), which may include baseline information including control information and preamble information. The preamble information may include information pertaining to a U-SIG, L-SIG, a common field of a UHR-SIG, one or more user fields of the UHR-SIG, or any combination thereof. A responding AP may transmit a response message (e.g., response frame), which may indicate an intent to participate in the CoBF transmission phase. Additionally, or alternatively, the response message may include information pertaining to a U-SIG, L-SIG, UHR-SIG common field, one or more UHR-SIG user fields, or any combination thereof. In some cases, after receiving the response message, the initiating AP may transmit a sync message to trigger the CoBF transmission phase. In other cases, the responding AP may be designated as a Sync-Leader, and so may transmit the sync message to the initiating AP. The designation of Sync-Leader may be indicated in the invite message, the response message, or both. In other cases, the responding AP may be the Sync-Leader and may refrain from transmitting the sync message, as the sync message may not include new information for the initiating AP.

In some implementations, APs may perform C-SR transmission, which may also use a multistage information exchange or, additionally, or alternatively, a single stage information exchange, prior to the C-SR transmission. In some implementations, the multi-stage information exchange may, similarly to the CoBF, include an invite message, a response message, and, in some cases, a sync message. The invite message may include L-SIG and U-SIG information, as well as interference or power control information and bandwidth information, in some cases. The response message may include an intent to participate in the C-SR transmission, as well as interference or power control information and bandwidth information, in some cases. The sync message may include the trigger indication and, in some cases, interference or power control information. This may allow for synchronous transmissions. In other implementations, the multi-stage information exchange may rely on a two frame procedure and may allow for asynchronous transmissions. The two frame procedure may include invite and response messages, which may indicate information, as discussed with respect to the three-frame implementation. In other implementations, the single stage information exchange may combine the invite and trigger frame from the initiating AP. The combined message may include U-SIG information, L-SIG information, and interference or power control information. The initiating AP may assume the responding AP may participate in the C-SR, as the responding AP may not transmit a response message.

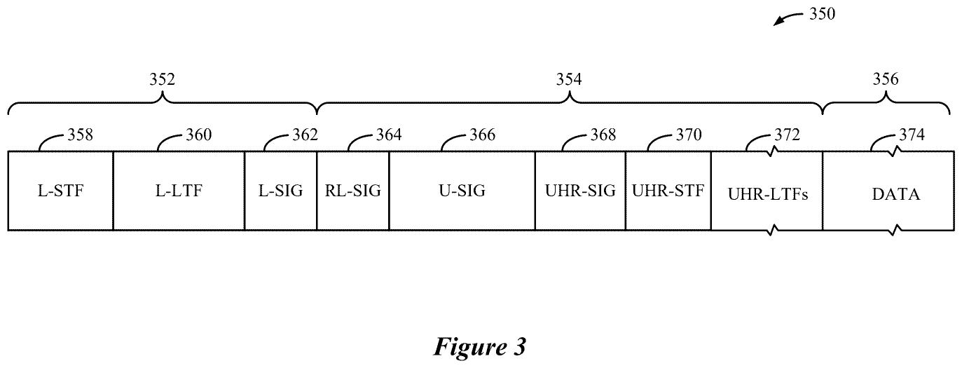

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (for example, a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (for example, a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

Some wireless communications networks may support information exchange for a CoBF transmission phase, and related techniques for information exchange for C-SR transmission. In some implementations, APs may perform a multistage information exchange associated with a transmission phase of a CoBF procedure. In some cases, the multistage information exchange may include an invite frame, a response frame, and, in some examples, a trigger frame. For example, an initiating AP may transmit an invite message (e.g., frame), which may include baseline information including control information and preamble information. The preamble information may include information pertaining to a U-SIG, L-SIG, a common field of a UHR-SIG, one or more user fields of the UHR-SIG, or any combination thereof. A responding AP may transmit a response message (e.g., response frame), which may indicate an intent to participate in the CoBF transmission phase. Additionally, or alternatively, the response message may include information pertaining to a U-SIG, L-SIG, UHR-SIG common field, one or more UHR-SIG user fields, or any combination thereof. In some cases, after receiving the response message, the initiating AP may transmit a sync message to trigger the CoBF transmission phase. In other cases, the responding AP may be designated as a Sync-Leader, and so may transmit the sync message to the initiating AP. The designation of Sync-Leader may be indicated in the invite message, the response message, or both. In other cases, the responding AP may be the Sync-Leader and may refrain from transmitting the sync message, as the sync message may not include new information for the initiating AP.

In some implementations, APs may perform C-SR transmission, which may also use a multistage information exchange or, additionally, or alternatively, a single stage information exchange, prior to the C-SR transmission. In some implementations, the multi-stage information exchange may, similarly to the CoBF, include an invite message, a response message, and, in some cases, a sync message. The invite message may include L-SIG and U-SIG information, as well as interference or power control information and bandwidth information, in some cases. The response message may include an intent to participate in the C-SR transmission, as well as interference or power control information and bandwidth information, in some cases. The sync message may include the trigger indication and, in some cases, interference or power control information. This may allow for synchronous transmissions. In other implementations, the multi-stage information exchange may rely on a two frame procedure and may allow for asynchronous transmissions. The two frame procedure may include invite and response messages, which may indicate information, as discussed with respect to the three-frame implementation. In other implementations, the single stage information exchange may combine the invite and trigger frame from the initiating AP. The combined message may include U-SIG information, L-SIG information, and interference or power control information. The initiating AP may assume the responding AP may participate in the C-SR, as the responding AP may not transmit a response message.

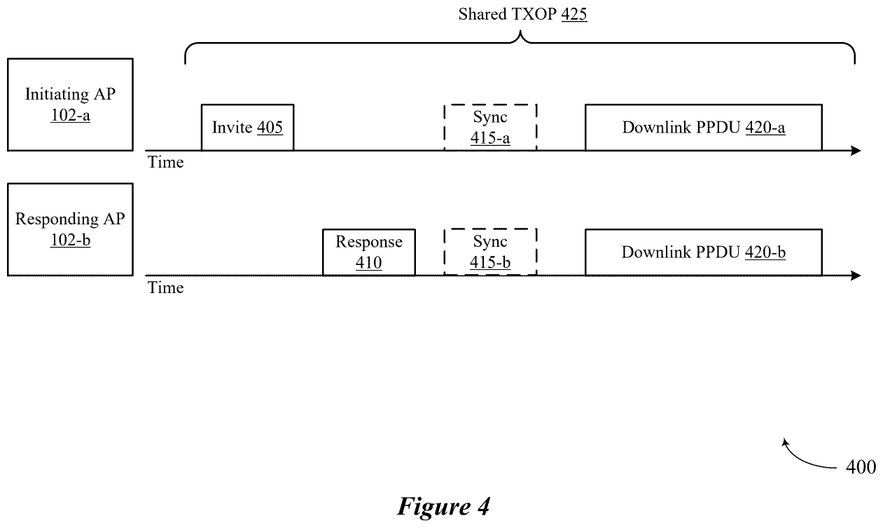

FIG. 4 shows an example of a timing diagram 400 that supports CoBF information exchange for a transmission phase. The timing diagram 400 may implement, or be implemented by, aspects of the wireless communication network 100 or the example PDUs 200 and 300. For example, the timing diagram 400 may include one or more APs 102, including at least the initiating AP 102-a and the responding AP 102-b, which may be examples of corresponding devices as described herein, including with reference to FIG. 1. The techniques described herein in the context of the timing diagram 400 may support the initiating AP 102-a to perform an information exchange with the responding AP 102-b to support CoBF transmission, C-SR transmission, or both. In some examples, by including an information exchange specific to a transmission phase for CoBF or C-SR, the described techniques may be used to limit interference during the transmission phase of CoBF and C-SR, and improve communication reliability.

In some implementations, APs 102, such as an initiating AP 102-a and a responding AP 102-b, may participate in a CoBF procedure. The CoBF procedure may include at least a sounding stage (e.g., phase) and a transmission stage. In both stages, the initiating AP 102-a and the responding AP 102-b may perform transmissions, which may use a common preamble in order to avoid or lessen interference between the transmissions form the different APs 102. In order to generate the common preamble, there may be some unified information exchange between the initiating AP 102-a and the responding AP 102-b, which may apply to both the sounding stage and the transmission stage. The information exchanged may be parameters or information that may be shared between the APs 102 to ensure the common preamble. However, either of the APs 102 may inform the other AP 102 of the specific information. That is, what information is sent from which AP 102 may differ, depending on the wireless communication network.

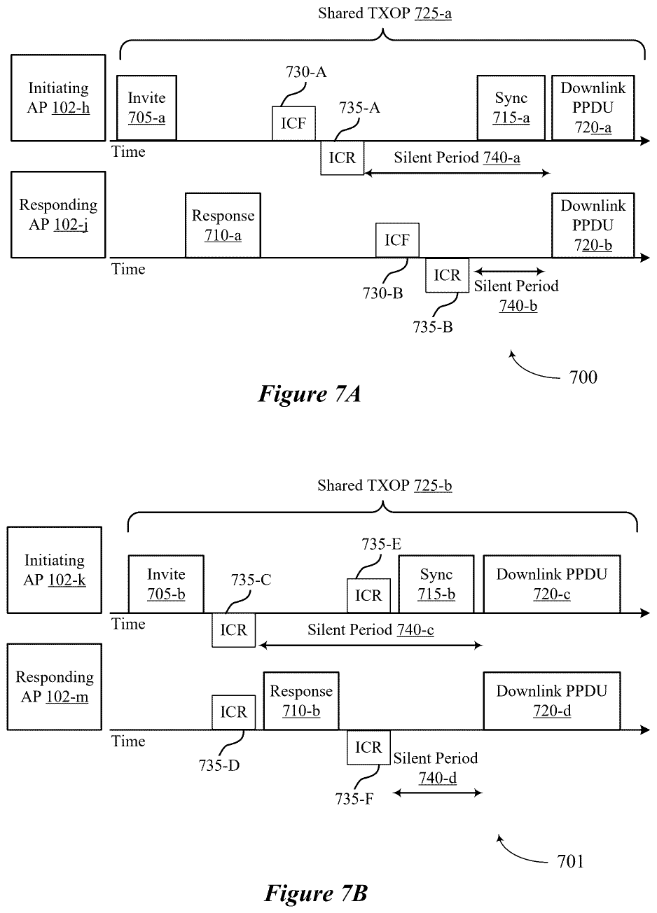

Within the information exchange, there may be two types of information signaled. Information associated with a common preamble, or PHY information, to help form a common preamble in the MAP transmission (e.g., CoBF transmission), may be signaled between the APs 102. For example, subfields in the common preamble may include information related to the common preamble that may be signaled. In some cases, the subfields may include L-SIG fields, U-SIG fields, and UHR-SIG fields, which may include a common field and one or more user fields. Additional control information may also be signaled. For example, the additional control information may include an information type (e.g., an invitation type associated with the invite 405 in the invite frame, a confirmation type associated with the response 410 in the response frame, a rejection type associated with the response 410 in the response frame, a trigger or synchronization type associated with the sync 415 (e.g., trigger, synchronization) in the sync frame (e.g., trigger frame). Additionally, or alternatively, the additional control information may include a multi-access point (MAP) scheme or type, such as an indication of a CoBF procedure, different types of C-SR procedures, a Co-TDMA procedure, or a future MAP scheme (e.g., a procedure associated with JT from multiple APs to a single user, a procedure associated with JT from multiple APs to multiple users associated with a single AP or multiple APs). For example, a Type-I C-SR procedure may include a common L-SIG but may not include a common U-SIG. A Type-II C-SR may include both a common L-SIG and a common U-SIG. In some cases, the MAP type or MAP scheme may be indicated with two or more bits to differentiate between the COBF, the Type-I C-SR, the Type-II C-SR, or some other MAP procedure. In other cases, one or more bits may be used to indicate whether the MAP scheme or type is COBF or a C-SR scheme. An additional one or more bits may, optionally or depending on whether the MAP scheme may be a C-SR scheme, indicate whether U-SIG information may be included in the frame or not, which may differentiate between the Type-I C-SR and the Type-II C-SR. Additionally, or alternatively, the MAP scheme or type may include one indication of no MAP, which may indicate that it may not be a MAP scheme. Additionally, or alternatively, the additional control information may include an indication of whether an AP 102 may be a synchronization leader (e.g., Sync-Leader, Sync-Reference) or a synchronization follower (e.g., Sync-Follower). Additionally, or alternatively, the additional control information may include an immediate response indication, which may indicate whether an AP 102 may be expected to respond within a time frame (e.g., right after a short interframe space (SIFS) period) after receiving a prior frame, as described further with reference to FIGS. 7A and 7B.

In some implementations, information that may be exchanged during the information exchange may be divided into baseline (e.g., essential) information and optional (e.g., non-essential) information. Baseline information may be necessary or required to be exchanged within an information exchange, such as via the invite 405, the response 410, the sync 415 (e.g., trigger) or any combination thereof. Optional information may be optionally exchanged in any of the frames, omitted, or exchanged in the sync 415 (e.g., a final synchronization frame). In some cases, control information, including the additional control information, may be baseline information. The subfields in the common preamble may be divided into baseline information and optional information. For example, each sub-field may include baseline information that may be exchanged, or alternative parameters that may be exchanged in place of the baseline parameter. In some examples, alternative parameters may be exchanged via the invite 405 and response 410 such that some baseline parameters may be derived from the alternative parameters and other information, and the derived baseline parameters may further be exchanged via the sync 415. For example, one or more alternative parameters to indicate the range of data field duration, e.g., average number of data OFDM symbols, minimum number of data OFDM symbols, maximum number of data OFDM symbols, and any combinations thereof, in place of the PPDU length (in the unit of octets) as a subfield in L-SIG, may be exchanged via the invite 405, and the final length (in the unit of octets) as a subfield in L-SIG may be exchanged via the sync 415. In some examples, alternative parameters may be exchanged via any frame (e.g., the invite 405, response 410 and sync 415), such that the final information may be derived from the alternative parameters and other information, and the derived information may not be exchanged via the sync 415. For example, the alternative parameter per-user number of spatial streams (Nss) of users in the sharing BSS may be exchanged via the invite 405, and the alternative parameter per-user Nss of users in the shared BSS may be exchanged via the response 410, in place of the spatial configuration. The spatial configuration may be derived based on the per-user Nss of all users and the user ordering rules and may be omitted from being exchanged via the sync 415. For example, the alternative parameter max total number of spatial streams (Nss, total) allowed for the shared AP may be exchanged via the invite 405, and the alternative parameter extra LTF allowed or not allowed for the shared AP may be exchanged via the response 410. The sharing AP may derive the final number of UHR-LTF symbols based on the per-user Nss and extra LTF allowed or not at both APs, and exchange an alternative parameter extra LTF enabled or not via the sync 415, such that the shared AP may derive the final number of UHR-LTF symbols based on extra LTF enabled or not. In some cases, each sub-field may also include optional information that may not be exchanged or may not be required to be exchanged. In some cases, APs 102 may use one or more fixed values for the optional information fields, which may be pre-configured or indicated. In other cases, the APs 102 may derive the values of the optional information fields based on the indicated baseline information, indicated alternative parameters, other information, or any combination thereof. For example, a quantity of UHR-SIG symbols may be optional information. The quantity of UHR-SIG symbols may be derived based on a UHR-SIG modulation and coding scheme (MCS) and a total quantity of user fields, which may be baseline information. In some examples, a spatial configuration may be optional information, and the spatial configuration may be derived based on a per-user number of spatial streams (Nss) parameter and a user field ordering. Each AP 102 may indicate per-user Nss as an alternative parameter, baseline parameter, or both to support this derivation. In some examples, a subfield or parameter may be, in general, baseline (e.g., essential) information, but the subfield or parameter may become optional (e.g., non-essential) if it may be fixed to a certain value for the MAP transmission (e.g., CoBF transmission). For example, the UHR-SIG MCS may, in general or usually, be baseline information, but it may become optional if it may be fixed to MCS0. Additionally, or alternatively, the LDPC Extra Symbol Segment and Pre-FEC Padding Factor may, in general, be baseline information, but the LDPC Extra Symbol Segment may become optional if it may be fixed to 1 for a lower puncturing ratio, and the Pre-FEC Padding Factor may become optional if it may be fixed to a value such as 3 or 4 to maximize packet size and pre-FEC padding, and avoid post-FEC padding (e.g., an initial pre-FEC padding factor may be fixed to 3, a final pre-FEC padding factor may be fixed to 4 (e.g., with an extra LDPC symbol segment)).

In some cases, some or all optional information may be omitted from the information exchange. That is, no frame (e.g., the invite 405, response 410, sync 415) may include an indication of some or all of the optional information. Additionally, or alternatively, some or all of the optional information may be indicated in a same frame as baseline information in the same field. For example, optional information related for the U-SIG may be indicate din the same frame as baseline information for the U-SIG. Additionally, or alternatively, some or all of the optional information may be indicated in the final frame (e.g., the synchronization or sync 415), or in any frame (including the invite 405, response 410, and sync 415). Table 1 may include an example of different information that may be exchanged, whether the information may be baseline, and, in some cases, alternative parameters related to the information.

TABLE 1
Example of Subfields Divided into Baseline and Optional Information

| Preamble | | | |
|---|---|---|---|
| Field/Control | | | |
| Information | Subfield | Category | Alternative Parameters |
| Control | Information Type | Baseline | |
| Information | (‘Invitation’, | | |
| | ‘Acceptance’ (or | | |
| | ‘Confirmation’ or | | |
| | ‘Response’), | | |
| | ‘Rejection’, | | |
| | ‘Trigger’, | | |
| | ‘Synchronization) | | |
| Control | MAP Scheme | Baseline | |
| Information | (‘COBF’, ‘Type-I | | |
| | C-SR’, ‘Type-II | | |
| | C-SR’, etc.) | | |
| Control | Sync- | Baseline | |
| Information | Leader/Sync- | | |
| | Follower | | |
| | Indication | | |
| | (1 bit) | | |
| Control | Immediate | Baseline | |
| Information | Response | | |
| | Needed | | |
| | (1 bit) | | |
| L-SIG | Length | Baseline | Modified Length (12 bits), |
| | (12 bits) | | Quantity of Data OFDM |
| | | | Symbols (9 bits), Initial |
| | | | Quantity of Data OFDM |
| | | | Symbols (9 bits), Average |
| | | | Modified Length (12 bits), |
| | | | Average Number of Data |
| | | | OFDM Symbols (9 bits), |
| | | | Average Initial Number of |
| | | | Data OFDM Symbols (9 bits), |
| | | | range of length in the form of |
| | | | Minimum Modified Length (12 |
| | | | bits), Maximum Modified |
| | | | Length (12 bits), or [Minimum |
| | | | Modified Length (12 bits), |
| | | | Maximum Modified Length |
| | | | (12 bits)], range of Data field |
| | | | duration in the form of |
| | | | Minimum Number of Data |
| | | | OFDM Symbols (9 bits), |
| | | | Maximum Number of Data |
| | | | OFDM Symbols (9 bit), |
| | | | [Minimum Number of Data |
| | | | OFDM Symbols (9 bits), |
| | | | Maximum Number of Data |
| | | | OFDM Symbols (9 bit)], |
| | | | Minimum Initial Number of |
| | | | Data OFDM Symbols (9 bits), |
| | | | Maximum Initial Number of |
| | | | Data OFDM Symbols (9 bits), |
| | | | or [Minimum Initial Number of |
| | | | Data OFDM Symbols (9 bits), |
| | | | Maximum Initial Number of |
| | | | Data OFDM Symbols (9 bits)], |
| | | | multiple Modified Lengths |
| | | | (12 bits each corresponding to |
| | | | a total number of spatial |
| | | | streams transmitted by shared |
| | | | AP 102 being 1, . . . , Maximum |
| | | | Total number of spatial streams |
| | | | allowed for the shared AP), |
| | | | multiple Number of Data |
| | | | OFDM Symbols (9 bits each |
| | | | corresponding to a total |
| | | | number of spatial streams |
| | | | transmitted by shared AP 102 |
| | | | being 1, . . . , Maximum Total |
| | | | number of spatial streams |
| | | | allowed for the shared AP), |
| | | | multiple Initial Number of |
| | | | Data OFDM Symbols (9 bits |
| | | | each corresponding to a total |
| | | | number of spatial streams |
| | | | transmitted by shared AP being |
| | | | 1, . . . , Maximum Total number |
| | | | of spatial streams allowed for |
| | | | the shared AP) |
| U-SIG | PHY Version | Either | |
| | Identifier | | |
| | Bandwidth | Baseline | |
| | (3 bits) | | |
| | Uplink/Downlink | Optional | |
| | Indication | | |
| | (1 bit) | | |
| | BSS Color(s) | Optional | |
| | (6 bits each) | | |
| | TXOP (7 bits) | Optional | Duration field of the MAC |
| | | | frame |
| | PPDU Type and | Optional | |
| | Compression | | |
| | Mode (2 bits) | | |
| | CoBF/C-SR | Optional | |
| | Indication | | |
| | (1 bit) | | |
| | Punctured | Baseline | |
| | Channel | | |
| | Information | | |
| | (5 bits) | | |
| | UHR-SIG MCS | Optional | |
| | (2 bits) | | |
| | Quantity of | Optional | |
| | UHR-SIG | | |
| | Symbols | | |
| | (5 bits) | | |
| UHR-SIG | Spatial Reuse | Optional | |
| Common Field | (4 bits) | | |
| | GI + LTF Size | Baseline | |
| | (2 bits) | | |
| | Quantity of | Baseline | Maximum Total Number of |
| | UHR-LTF | | Spatial Streams (Nss) allowed |
| | Symbols | | for the shared AP 102 (2 bits), |
| | (3 bits) | | Extra LTF Allowed (1 bit), |
| | | | Extra LTF Enabled (1 bit) |
| | LDPC Extra | Optional | |
| | Symbol Segment | | |
| | (1 bit) | | |
| | Pre-FEC Padding | Either | |
| | Factor (2 bits) | | |
| | PE Disambiguity | Baseline | |
| | (1 bit) | | |
| | Quantity of | Optional | Quantity of CoBF Users in |
| | CoBF Users (e.g., | | sharing BSS (1-2 bits), |
| | Quantity of Non- | | Quantity of CoBF Users in |
| | OFDMA users) | | shared BSS (1-2 bits) |
| | (3 bits) | | |
| UHR-SIG | STA ID (11 bits) | Baseline | |
| User Field | MCS (5 bits) | Baseline | |
| | Spatial | Optional | Nss (1-2 bits) |
| | Configuration | | |
| | (4 bits) | | |
| | BSS Color | Optional | |
| | Indication | | |
| | (1 bit) | | |
| | 2xLDPC (1 bit) | Baseline | 2xLDPC Capability (1 bit) |

In Table 1, the PHY version identifier may be indicated to enable flexibility in field design (e.g., futureproof and determine a field structure). The PHY version identifier may be set to a default value of 1 to indicate Ultra High Reliability (UHR). Additionally, or alternatively, the PHY version identifier may be set to another value to indicate a future generation, and the remaining field structure (e.g., existence, definitions and bitwidths of certain subfields) in each of the CoBF invite 405, response 410 and sync 415 frames may depend on the generation. Therefore, the PHY version identifier may be indicated in any of the CoBF invite 405, response 410 and sync 415 frames. In general, the PHY version identifier may be baseline information, and it becomes optional and derivable in the context of UHR CoBF invite 405, response 410 and sync 415 frames. The uplink/downlink indication may be set to a default value (e.g., 0) to indicate ‘downlink’ (e.g., ‘DL’), and may thus be optional. The BSS color(s) of both the initiating AP 102 and the responding AP 102 may be derived based on the identifiers (e.g., IDs), addresses, or both of the APs 102, and may thus be optional. The TXOP may be derived from the duration field of the MAC frame (e.g., as specified according to current techniques). Depending on the control information MAP scheme, the PPDU type and compression mode may be set to 2 for CoBF and set to 1 for C-SR. The CoBF/C-SR Indication may be set to 0 as a default value, in conjunction with the PPDU type and compression mode being set to 2 to indicate a CoBF transmission, or in conjunction with the PPDU type and compression mode being set to 1 to indicate a C-SR transmission. The UHR-SIG MCS may be fixed to a specific MCS (e.g., MCS0). The quantity (e.g., number) of UHR-SIG symbols may be derived based on the UHR-SIG MCS and the total quantity of user fields associated with the UHR-SIG. The spatial reuse may be set to disabled spatial reuse (e.g., a state of PSR_AND_NON_SRG_OBSS_PD_PROHIBITED) by default. The LDPC extra symbol segment may be a fixed value, such as one. The pre-FEC padding factor may be a baseline parameter if it is not a fixed value, and may be optional if it is a fixed value, such as 3. The PE disambiguity may be derived at each AP 102 if the quantity of data OFDM symbols is known; otherwise the PE disambiguity may be baseline information. The quantity of CoBF users may be derived as the sum of the quantity of users in two BSSs. Each AP 102 may indicate, explicitly or implicitly, the quantity of users. The spatial configuration may be derived based on the per-user Nss and user ordering. Each AP 102 may indicate a per-user Nss for users of the AP 102.

In some implementations, the sounding phase and the transmission phase of a CoBF procedure may occur in different TXOPs 425, with different available bandwidths, or both. In some cases, the APs 102 may use different common preambles for the sounding phase and the transmission phase to reflect these differences in TXOPs 425 and bandwidths. To accommodate multiple different common preambles (e.g., a common preamble specific to the sounding phase and a common preamble specific to the transmission phase), information exchange between the two APs 102 may be divided for the sounding phase and the transmission phase. That is, there may be an information exchange between the initiating AP 102-a and the responding AP 102-b that may be specific to the transmission phase. For example, the information exchange may be specific to each frame (e.g., invite 405, response 410, sync 415) that may set up the CoBF transmission phase for the common preamble purpose. Additionally, or alternatively, an information exchange, as described herein, may set up a common preamble for transmission related to a C-SR procedure.

In some implementations, the information exchange for the CoBF transmission phase may be implemented in a multi-stage procedure. For example, the initiating AP 102-a (e.g., TXOP holder) may transmit a CoBF invite 405 (e.g., invite frame, invite message) and share common preamble information, in addition to indicating the serving clients of the initiating AP 102-a. The responding AP 102-b may transmit a CoBF response 410 (e.g., response frame, response message), in which the responding AP 102-b may acknowledge an ability to null the signal from the responding AP 102-b for the clients of the initiating AP 102-a, and may indicate (e.g., declare) the serving clients for the responding AP 102-b. In some cases, the initiating AP 102-a may transmit a CoBF trigger/sync 415-a (e.g., trigger frame, sync message, CoBF sync), which may acknowledge that the initiating AP 102-a may null its signal for the clients of the responding AP 102-b. The sync 415 (e.g., sync 415-a, sync 415-b) may also serve as a synchronization message (e.g., CoBF sync) if the initiating AP 102-a may be designated as a synchronization leader (e.g., Sync-Leader). In other cases, the responding AP 102-b may be designated a synchronization leader (e.g., Sync-Leader). The responding AP 102-b, as the Sync-Leader, may transmit the sync 415-b, or may not transmit a sync 415-b at all. That is, there may be no sync 415 transmitted, while the CoBF response 410 may also serve as a synchronization message. After the sync 415, the APs 102 may perform the CoBF downlink PPDU 420 transmission within the shared TXOP 425. For example, the downlink PPDUs 420 may be examples of UHR PPDUs and may include an un-beamformed common preamble based on the information exchange over the invite 405, the response 410, and the sync 415. Between each frame (e.g., the invite frame, response frame, sync frame, PPDU frame), there may be some short interframe space (SIFS).

The CoBF invite 405 sent from the initiating AP 102-a to the responding AP 102-b may include or indicate various different information. In some implementations, the CoBF invite 405 may indicate an invite for the responding AP 102-b to participate in the CoBF procedure. In some implementations, the CoBF invite 405 may contain information associated with a U-SIG. In some cases, the information associated with the U-SIG may be between 19 and 30 bits. The information associated with the U-SIG may include a physical layer (PHY) version identifier (e.g., 3 bits), a bandwidth of the PPDU sent by the initiating AP 102-a (e.g., 3 bits), an indication of the TXOP 425 duration (e.g., 7 bits), a PPDU type and compression mode (e.g., 2 bits), an indication of a CoBF procedure or a C-SR procedure (e.g., 1 bit), punctured channel information (e.g., 5 bits), a UHR-SIG modulation and coding scheme (MCS) (e.g., 2 bits to indicate one UHR-SIG MCS within a set of 4 MCS, 1 bit for a reduced set of 2 MCS, or omitted if only one UHR-MCS is used or configured), or any combination thereof. The PPDU type and compression mode, as well as the CoBF or C-SR indication, may jointly serve to differentiate between a CoBF procedure information exchange and a C-SR procedure information exchange, for determining related and remaining information. In some examples, the combinations of these two fields may be reduced to total 1 bit. For example, the APs 102 may either perform downlink multi-user MIMO (MU-MIMO) with a CoBF procedure, or a single user (SU) transmission with a C-SR procedure. Similarly, the UHR-SIG MCS may be 1 bit for a reduced set, such as a reduced quantity of possible options, or omitted if one MCS is used or configured. In some examples, the CoBF invite 405 may also include an indication of uplink or downlink communication (e.g., 1 bit) for the PPDU sent by the initiating AP 102-a. If only downlink is supported, this may be omitted. In some examples, the CoBF invite 405 may include an identifier associated with the responding AP 102-b, which may be an AP ID or a basic service set (BSS) color (e.g., 6 bits).

In some cases, the CoBF invite 405 may include bandwidth and punctured channel information of the PPDUs for the CoBF transmission. The bandwidth (3 bits) and punctured channel information (5 bits) may be subfields in the U-SIG of the PPDUs for the CoBF transmission. The bandwidth and punctured channel information may be associated with the PPDU sent by the initiating AP 102-a in the CoBF transmission. In UHR, the PPDU sent by the responding AP 102-a in the CoBF transmission may have the same bandwidth and punctured channel information. The shared AP 102 (e.g., the AP 102 that may receive the sync 415 (e.g., the synchronization)) may use the bandwidth information to schedule users of different bandwidth capabilities. Based on a clear channel assessment (CCA), the shared AP 102 may determine if it may transmit in the unpunctured subchannels jointly indicated by the bandwidth and punctured channel information. In some cases, for simplicity and efficiency, there may be no bandwidth or punctured pattern negotiation between the two APs. In a future WiFi generation, the PPDU sent by the responding AP 102-b in the CoBF transmission may have a different bandwidth, punctured channel information, or both. In some cases, the CoBF invite 405 may include assigned bandwidth for the responding AP 102-b, assigned punctured channel information for the responding AP 102-b, or both. In some cases, the CoBF response 410 may include the bandwidth for the responding AP 102-b, punctured channel information for the responding AP 102-b, or both.

Additionally, or alternatively, the invite 405 (e.g., the invite frame) may include packet size-related parameters (e.g., rough packet size-related parameters). The shared AP 102 may use the rough knowledge of the packet size to schedule users with different payloads. The exact length in the L-SIG may not be known at the sharing AP 102 before reception of the response 410, because the quantity of UHR-SIG symbols and quantity of UHR-LTF symbols may not be known prior to reception of the response 410. The sharing AP 102 (e.g., the initiating AP 102-a) may determine one or more data field durations or the range of a data field duration and may indicate such baseline information in the invite 405. In some examples, one or more data field durations may be indicated as one or more quantities of data OFDM symbols or one or more initial quantities of data OFDM symbols in the invite 405. Each quantity of Data OFDM Symbols (9 bits) and initial quantity of Data OFDM Symbols (9 bits) may correspond to the total number of spatial streams (Nss) transmitted by the shared AP 102 being a value from 1 to a maximum total number of spatial streams allowed for the shared AP 102, as specified in the invite 405. In some examples, only one data field duration may be indicated as a quantity of data OFDM symbols or an initial quantity of Data OFDM Symbols in the invite 405, and it may correspond to the total number of spatial streams transmitted by the shared AP being a certain value. In some examples, the range of the data field duration may be indicated as an average quantity of data OFDM symbols, a minimum quantity of data OFDM symbols, a maximum quantity of data OFDM symbols, or any combination thereof. In some examples, the range of the data field duration may be indicated as an average initial quantity of data OFDM symbols (e.g., prior to possibly adding an LDPC extra symbol segment, as indicated in the LDPC extra symbol segment subfield), a minimum initial quantity of data OFDM symbols (e.g., prior to possibly adding an LDPC extra symbol segment, as indicated in the LDPC extra symbol segment subfield), a maximum initial quantity of data OFDM symbols (e.g., prior to possibly adding an LDPC extra symbol segment, as indicated in the LDPC extra symbol segment subfield), or any combination thereof. Alternatively, the sharing AP 102 (e.g., the initiating AP 102-a) may determine one or more modified PPDU length (e.g., in the unit of octets) or the range of a modified PPDU length (e.g., in the unit of octets), which may assume the quantity of UHR-symbols and quantity of UHR-LTF symbols based on the number of users scheduled in the sharing BSS and the quantity of spatial streams (Nss) of each user scheduled in the sharing BSS. In some examples, one or more modified PPDU lengths may be indicated as one or more Modified Lengths (12 bits) in the invite 405. Each Modified Length (12 bits) may correspond to the total number of spatial streams transmitted by the shared AP being a value from 1 to a maximum total number of spatial streams allowed for the shared AP 102, as specified in the invite 405. In some examples, only one modified PPDU length may be indicated as a Modified Length (12 bits) in the invite 405, and it may correspond to the total number of spatial streams transmitted by the shared AP being a certain value. In some examples, the range of the modified PPDU length (e.g., in the unit of octets) may be indicated as an average modified PPDU length (e.g., in the unit of octets), a minimum modified PPDU length (e.g., in the unit of octets), a maximum modified PPDU length (e.g., in the unit of octets), or any combination thereof. In some examples, the pre-FEC padding factor and the LDPC extra symbol segment may be indicated to determine the range of the data field duration. In some examples, there may be one or more sets of the pre-FEC padding factor and the LDPC extra symbol segment, which may each be grouped with the one or more quantity of data OFDM symbols, the average quantity of data OFDM symbols, the minimum quantity of data OFDM symbols or the maximum quantity of data OFDM symbols to determine the corresponding one or more data field durations, average data field duration, and minimum data field duration and maximum data field duration, respectively. In some examples, there may be one or more sets of the pre-FEC padding factor and the LDPC extra symbol segment, which may each be grouped with the one or more initial quantities of data OFDM symbols, the average initial quantity of data OFDM symbols, the minimum initial quantity of data OFDM symbols or the maximum initial quantity of data OFDM symbols to determine the corresponding one or more data field durations, average data field duration, and minimum data field duration and maximum data field duration, respectively. In some examples, the pre-FEC padding factor, the LDPC extra symbol segment, or both may be fixed values. For example, the pre-FEC padding factor may be set to a fixed value (e.g., 3, 4) and post-FEC padding may be avoided. The LDPC extra symbol segment may be fixed to 1. Fixing the values of these fields may render them optional and they may, in some examples, be omitted from the invite 405. In some examples, in the sync frame 415, the pre-FEC padding factor (2 bits) and the LDPC extra symbol segment (1 bit), as subfields in the common field of UHR-SIG in the PPDUs in the CoBF transmission, may be indicated for completeness of information. In some examples, if any quantifies of modified PPDU lengths (e.g., in the unit of octets), such as an average modified PPDU length (e.g., in the unit of octets), a minimum modified PPDU length (e.g., in the unit of octets), a maximum modified PPDU length (e.g., in the unit of octets), or any combination thereof, may be indicated in the invite 405, a PE disambiguity bit (1 bit) paired with each of such quantities may be indicated in the invite 405 to resolve the ambiguity in determining the quantity of data OFDM symbols or the initial quantity of data OFDM symbols in the process of deriving the packet size and performing rate matching.

In some cases, the data field duration may be indicated with fewer bits, such as by lessening the granularity of the reported or indicated value. For example, a data field duration may be indicated as a quantity of data OFDM symbols, an initial quantity of data OFDM symbols, or any combination thereof, which may utilize some quantity of bits (e.g., 9 bits). The quantity of data OFDM symbols may be modified by some unit of data OFDM symbols, J. The value of the quantity of data OFDM symbols may be derived from a formula or equation (e.g., ceil (quantity of data OFDM symbols/J)). For example, if J is from {2,3}, 8 bits may be used to indicate the quantity of data OFDM symbols, rather than 9 bits. If J is from {4, 5, 6, 7}, 7 bits may be used to indicate the quantity of data OFDM symbols. If J is from {8, 9, . . . , 15}, 6 bits may be used to indicate the quantity of data OFDM symbols. If J is from {16, 17, . . . , 31}, 5 bits may be used to indicate the quantity of data OFDM symbols. If J is from {32, 33, . . . , 63}, 4 bits may be used to indicate the quantity of data OFDM symbols. If J is from {64, 65, . . . , 127}, 3 bits may be used to indicate the quantity of data OFDM symbols. In some examples, each quantity may be associated with a time unit (e.g., 50 us, 100 us, 200 us, 500 us, 1 ms, or the like), which also may be indicated in the information exchange. For example, the indicated quantities may become the time duration of PPDU or data field, the average, minimum, or maximum time duration of PPDU or data field, the corresponding time duration of PPDU or data field for each total quantity of spatial streams transmitted from the shared AP 102, or the like. The time duration of PPDU may include the time duration of data field and time duration of preamble after L-SIG.

In some implementations, the CoBF invite 405 may include information associated with a L-SIG or a common field of a UHR-SIG. In some cases, the information associated with a L-SIG or a common field of a UHR-SIG may be between 14 and 20 bits. The information associated with a L-SIG or a common field of a UHR-SIG may include a combination of guard interval and long training field size (GI+LTF Size) (e.g., 2 bits to indicate one out of a set of 4 combinations, 2 bits to indicate one of a set of 3 combinations (e.g., {2×LTF+0.8 us GI, 2×LTF+1.6 us GI, 4×LTF+3.2 us GI} with 4×LTF+0.8 us GI disabled, or any such combinations of the 4 combinations), 1 bit for a reduced set of 2 combinations {2×LTF+1.6 us GI, 4×LTF+3.2 us GI}, or omitted if a fixed combination is used or configured), a quantity of CoBF users served by the initiating AP 102-a (e.g., 2 bits), PPDU length and LDPC encoding parameters (e.g., 12 to 16 bits), or any combination thereof. In some examples, the GI+LTF size may be 1 bit for a reduced set such as a reduced quantity of possible options (e.g., 2×LTF+1.6 us GI, 4×LTF+3.2 us GI), or omitted if one GI+LTF size combination is used or configured.

In some examples, both the sharing AP 102 and the shared AP 102 may enable or disable a GI+LTF Size choice that uses 0.8 us GI. For example, during a setup phase of CoBF (e.g., before sounding and transmission phase), each AP 102 may indicate (e.g., one time indication) at least one of whether 0.8GI is allowed or not (1 bit), whether 2×LTF+0.8 us GI is allowed or not (1 bit), or a 2-bit bitmap to indicate whether the AP 102 supports {2×LTF+0.8 us, 4×LTF+0.8 us} in CoBF transmission (1 bit for each GI+LTF choice). Additionally, or alternatively, the sharing AP 102 may indicate the initial choice of GI+LTF Size in the invite 405. The shared AP 102 may indicate whether 0.8GI is allowed or not (1 bit) in the response 410. The sharing AP 102 may indicate the final choice of GI+LTF Size in the sync 415.

In some cases, the GI+LTF size may be determined or decided by the sharing AP 102 (e.g., the initiating AP 102-a or, in some cases, the responding AP 102-b) without negotiation with the shared AP 102. In some examples, 4×LTF+0.8 us GI may be an optional feature for the GI+LTF size that not all users may have implemented. The GI+LTF size may be indicated in the invite 405 so that the shared AP 102 may decide whether to participate in the CoBF transmission, and may schedule CoBF users that support this GI+LTF size option. In some examples, the GI+LTF size may be 2×LTF+1.6 us GI or 4×LTF+3.2 us GI (e.g., reduced set, only one of these options). The GI+LTF size may be indicated in the invite 405 or the sync 415 (e.g., synchronization frame, trigger frame). In some cases, GI+LTF size options may include 1×LTF+1.6 us GI, 2×LTF+0.8 us GI, 2×LTF+1.6 us GI, 4×LTF+0.8 us GI, or 4×LTF+3.2 us GI. In these cases, the GI-LTF size may be indicated in the invite 405 or the sync 415 (e.g., synchronization frame).

In some cases, the UHR-SIG common field may include an interference mitigation (IM) indication or parameter. The IM indication may include a one-bit subfield in the UHR-SIG common field for a non-OFDMA system, which may indicate whether IM is enabled or disabled. For a MAP scheme (e.g., CoBF, C-SR), the APs 102 may assume IM is disable, and the IM indication bit may be set to disabled (e.g., 1). There may be no need to indicate the IM parameter in the invite 405, response 410, or sync 415. If it is indicated, it may be set to disabled.

In some implementations, the CoBF invite 405 may include information from each user served by the sharing AP (e.g., initiating AP 102-a) in a user field of the UHR-SIG (e.g., 18 or 19 bits per user) in the PPDUs in CoBF transmission. The information from each user in a user field of the UHR-SIG may include a STA ID (e.g., 11 bits), an MCS (e.g., 5 bits), a number of spatial streams (Nss) (e.g., 1 bit to indicate 1 spatial stream or 2 spatial streams, or 2 bits to indicate 1 spatial stream, 2 spatial streams and other options), an indication of an LDPC-related coding scheme (e.g., 2×LDPC enabled or disabled (e.g., 1 bit), 2×LDPC capability (e.g., 1 bit or multiple bits, each for a code rate or modulation and coding scheme (MCS)), or any combination thereof. For more than one users served by the sharing AP (e.g., initiating AP 102-a), the user fields or information related to the user fields included in the CoBF invite 405 may be random, may be ordered according to the Nss in a non-increasing order or non-decreasing order, or may be ordered according to any other parameter. In some examples, LDPC may be the default coding scheme and an indication may only be included for 2×LDPC (e.g., to indicate enabling or disabling 2×LDPC).

In some cases, the UHR-SIG MCS may be a fixed value (e.g., MCS0). In these cases, the UHR-SIG MCS may be an optional field and may not be included in the invite 405 (e.g., omitted, or included in the sync 415). In some cases, the quantity of CoBF users (e.g., quantity of Non-OFDMA users) may be derivable based on the information indicated in the invite 405 and in the response 410. For example, the invite 405 may indicate the quantity of CoBF users served by the sharing AP 102 (e.g., the initiating AP 102-a), which may be some quantity of bits (e.g., 1 bit to indicate 1 user or 2 users, or 2 bits to indicate 1 user, 2 users and other options, e.g., 3 users, 4 users). Additionally, or alternatively, the quantity of CoBF users served by the sharing AP 102 (e.g., the initiating AP 102-a) may not be indicated in the invite 405, but may be implied by the number of valid STA IDs indicated in the invite 405. In the response 410, the quantity of CoBF users served by the shared AP 102 (e.g., the responding AP 102-b) may be indicated (e.g., 1 bit to indicate 1 user or 2 users, or 2 bits to indicate 1 user, 2 users and other options, e.g., 3 users, 4 users). Additionally, or alternatively, the quantity of CoBF users served by the shared AP 102 (e.g., the responding AP 102-b) may not be indicated in the response 410, but may be implied by the number of valid STA IDs indicated in the response 410. The quantity of CoBF users (e.g., quantity of Non-OFDMA users) as in the Number of CoBF Users subfield (or Number of Non-OFDMA Users) subfield in the common field of UHR-SIG sent in the PPDUs in CoBF transmission, may be the quantity of CoBF users across both BSSs and derived as the sum of the quantity of CoBF users served by the sharing AP 102 (e.g., the initiating AP 102-a) and the quantity of CoBF users served by the shared AP 102 (e.g., the responding AP 102-b). In some cases, the quantity of CoBF users (e.g., quantity of Non-OFDMA users) may be derived at each AP and omitted in from the information exchange. In other cases, the response 410 may indicate the quantity of CoBF users (e.g., 2-3 bits to indicate total 2, 3 or 4 users) (e.g., quantity of Non-OFDMA users) as in the Number of CoBF Users subfield (or Number of Non-OFDMA Users) subfield in the common field of UHR-SIG sent in the PPDUs in CoBF transmission. In some cases, the sync 415 (e.g., synchronization) may indicate the quantity of CoBF users (e.g., 2-3 bits to indicate total 2, 3 or 4 users) (e.g., quantity of Non-OFDMA users) as in the Number of CoBF Users subfield (or Number of Non-OFDMA Users) subfield in the common field of UHR-SIG sent in the PPDUs in CoBF transmission. In some cases, a quantity of UHR-SIG symbols may be indicated or omitted from the information exchange. For example, if the UHR-SIG MCS is fixed (e.g., MCS0), the quantity of UHR-SIG symbols may be a function of the quantity of CoBF users and the indication of the quantity of UHR-SIG symbols may be omitted from the information exchange, as in Table 2. If the indication of the quantity of UHR-SIG symbols is included or is necessary, it may use 1-5 bits and may be indicated in the response 410 or the sync 415 (e.g., synchronization frame). For example, indicating the quantity of UHR-SIG symbols may use a minimum of 1 bit to indicate 2 or 4 UHR-SIG symbols, or 5 bits to indicate the number of UHR-SIG symbols as in the Number of UHR-SIG Symbols subfield in U-SIG of the PPDUs sent in the CoBF transmission.

TABLE 2
Example of Mapping Between the Quantity of Non-OFDMA
Users to the Quantity of UHR-SIG Symbols for MCS0

| | Maximum Quantity | |
|---|---|---|
| | of Information | |
| Quantity of | Bits per Content | Quantity of |
| Non-OFDMA | Channel in the | UHR-SIG Symbols |
| Users | UHR-SIG | (for MCS0) |
| 2 | 52 | 2 |
| 3 | 85 | 4 |
| 4 | 85 | 4 |

In some cases, a per-user MCS, as the MCS subfield (5 bits) in each user field in UHR-SIG in the PPDUs in CoBF transmissions, may be indicated in the information exchange. In some examples, the per-user MCS for the users in the sharing BSS may be pre-determined by the sharing AP 102 and may be indicated in the invite 405. However, the sharing AP 102 may not know the total quantity of spatial streams across two BSSs and may not have all beamforming and nulling gain parameters. In some examples, the per-user MCS for the users in the shared BSS may be determined by the shared AP 102 and indicated in the response 410, because the shared AP 102 may know all scheduled users and per-user Nss. In some examples, the per-user MCS (e.g., optimal per-user MCS) for the users in the sharing BSS may be determined by the sharing AP 102 and may be indicated in the sync 415 (e.g., synchronization frame).

In some implementations, the per-user 2×LDPC subfield (or bit) may be indicated in the information exchange. In some cases, the 2×LDPC capability may depend on both an AP 102 and a STA (e.g., STA 104, as described in FIG. 1) and, in some examples, may depend on an MCS. For example, if one AP 102 is not capable of transmitting 2×LDPC codewords, the 2×LDPC subfield (or “2×LDPC capability” bit) may be set to 0 for all users served by this AP 102. If one user is not capable of receiving 2×LDPC codewords, the 2×LDPC subfield (or “2×LDPC capability” bit) may be set to 0 for this user. For a given MCS, if both an AP 102 is capable of transmitting 2×LDPC codewords and the user is capable of receiving 2×LDPC codewords, the AP 102 may decide to enable or disable 2×LDPC based on a packet size. Enabling or disabling the 2×LDPC may depend on capability at the users and the APs 102, and may also be a rate adaptation decision at an AP 102. In some examples, each AP 102 may decide on the 2×LDPC subfield for the users served by the AP 102. That is, the per-user 2×LDPC subfield may be determined by serving APs. In the invite 405, since the rough or exact data field duration, bandwidth and punctured channel information may be known, the rough or exact Navbits may be known. For example, if the MCS for the users in the sharing BSS is pre-determined or indicated in the invite 405, the sharing AP 102 may determine and indicate the 2×LDPC bit for the users in the sharing BSS in the invite 405. If the MCS for the users in the sharing BSS is determined by the sharing AP 102 after receiving the response 410 and indicated in the sync 415 (e.g., synchronization frame), the sharing AP 102 may determine (e.g., decide) and indicate the 2×LDPC bit for the users in the sharing BSS in the sync 415 (e.g., synchronization frame). In the response 410, the shared AP 102 may determine (e.g., decide) and indicate the 2×LDPC bit for each scheduled user in the shared BSS or, additionally, or alternatively, the shared AP 102 may indicate the 2×LDPC capability bit for each scheduled user in the shared BSS to indicate that the sharing AP 102 may determine the 2×LDPC bit for each scheduled user in the shared BSS. In some examples, in the sync 415 (e.g., synchronization frame, trigger frame), if the 2×LDPC bit of any user is not yet determined and indicated in previous frames (e.g., the invite 405, response 410), the sharing AP 102 may determine and indicate the 2×LDPC bit (e.g., via the sync 415).

In some implementations, the CoBF invite 405 may include other optional information. For example, the CoBF invite 405 may include an assigned bandwidth for the responding AP 102-b, the assigned punctured channel information for the responding AP 102-b, or both. In some cases, the responding AP 102-b may use a partial bandwidth, and the information indicating the assigned bandwidth may be 2 bits. For example, the initiating AP 102-a may operate on a first bandwidth (e.g., 320 MHz-1). The responding AP 102-b may operate only on a part of that bandwidth (e.g., 160 MHz), or on a bandwidth that only partially overlaps with the first bandwidth (e.g., 320 MHz-2 with an overlapping 160 MHz). The two bits may be used to indicate whether the responding AP 102-b is assigned the same bandwidth as the initiating AP 102-a (e.g., the first bandwidth), the lower half of the first bandwidth, or the upper half of the first bandwidth. Additionally, or alternatively, the CoBF invite 405 may include an indication of whether or not the initiating AP 102-a may be a Sync-Leader (e.g., 1 bit, Sync-Leader or Sync-Follower).

In some cases, as described herein, the CoBF invite 405 may include PPDU length and LDPC encoding parameters. These parameters may be included in the CoBF invite 405, and in some cases the CoBF response 410, in order to maintain LDPC rate matching between multiple users served by both the initiating and responding APs 102. There may be multiple parameters indicated or included in the CoBF invite 405 to facilitate this. In some examples, the PPDU length and LDPC encoding parameters may include a length field in the L-SIG (e.g., 12 bits), an LDPC extra symbol segment (e.g., 1 bit), a common pre-forward error correction (FEC) padding factor (e.g., 2 bits), a packet extension disambiguity (e.g., 1 bit), or any combination thereof. This may result in 16 bits of PPDU length and LDPC encoding parameters in the CoBF invite 405. In other examples, the PPDU length and LDPC encoding parameters may include an LDPC extra symbol segment (e.g., 1 bit), an initial pre-FEC padding factor (e.g., 2 bits), an initial quantity of OFDM symbols in a data field (e.g., 9 bits for a lowest first MCS (e.g., MCS0), 10 bits for a lowest second MCS (e.g., MCS15)), or any combination thereof. This may result in 12 or 13 bits of PPDU length and LDPC encoding parameters in the CoBF invite 405. In other examples, the PPDU length and LDPC encoding parameters may include an LDPC extra symbol segment (e.g., 1 bit), the common pre-FEC padding factor (e.g., 2 bits), a quantity of OFDM symbols in a data field (e.g., 9 bits for a lowest first MCS (e.g., MCS0), 10 bits for a lowest second MCS (e.g., MCS15)), or any combination thereof. This may result in 12 or 13 bits of PPDU length and LDPC encoding parameters in the CoBF invite 405. For any of the examples, the LDPC extra symbol segment may be fixed (e.g., to 1), the common pre-FEC padding actor may be fixed (e.g., to 4), the initial pre-FEC padding factor may be fixed (e.g., to 3), or any combination thereof. The PPDU length and LDPC encoding parameters may not include an indication of the fixed values.

The CoBF response 410, sent from the responding AP 102-b to the initiating AP 102-a, may also include or indicate various different information. In some implementations, the CoBF response 410 may indicate an intent for the responding AP 102-b to participate in the CoBF procedure. This may be explicitly signaled (e.g., 1 bit to indicate ‘Acceptance’ (or ‘Confirmation’ or ‘Response’) or ‘Rejection’), or may be implicit, such as based on transmission of the CoBF response 410 or based on a state of some field in the CoBF response 410. This may also be indicated by a CoBF or C-SR indication (e.g., 1 bit), which may not be included in a common information field or a special user information field. This may differentiate CoBF and C-SR for the APs 102, which may then determine remaining information based on the determination. In some cases, the CoBF response 410 may include a bandwidth of the responding AP 102-b, punctured channel information of the responding AP 102-b, or both. If partial bandwidth CoBF is used, as described with reference to the invite message 405, the bandwidth of the responding AP 102-b may be 2 bits. Additionally, or alternatively, the CoBF response 410 may include a Sync-Leader indication (e.g., 1 bit, indicates whether the responding AP 102-b may be a Sync-Leader or Sync-Follower).

In some implementations, the CoBF response 410 may also include information associated with the L-SIG or a common field of the UHR-SIG (e.g., between 14 and 18 bits). For example, the information associated with the L-SIG or a common field of the UHR-SIG may include a quantity of CoBF users served by the responding AP 102-b (e.g., 2 bits), a PPDU length and LDPC encoding parameters, as described further with respect to the CoBF invite 405, or any combination thereof. The PPDU length and LDPC encoding parameters may be indicated similarly to described with respect to the CoBF invite 405 (e.g., between 12 and 16 bits). Additionally, or alternatively, the CoBF response 410 may not include an indication of the PPDU length and LDPC encoding parameters, and the responding AP 102-b may tailor the packet sizes and PPDU 420 parameters to fit parameters provided by the initiating AP 102-a, such as via the CoBF invite 405. In some implementations, the CoBF response 410 may also include information for each user served by the shared AP 102 (e.g., the responding AP 102-b) in the user field of the UHR-SIG, as described further with reference to the CoBF invite message 405 (e.g., 18-19 bits per user). As described with reference to the CoBF invite 405, if there are more than one users served by the shared AP (e.g., the responding AP 102-b), the user fields may be ordered randomly, according to the Nss in non-increasing order or non-decreasing order, or according to some other parameter.

In some implementations, a quantity of UHR-SIG symbols may be calculated by the APs 102 according to the total quantity of user fields, which may be determined by the summation of the quantity of users served by the initiating AP 102-a and the quantity of users served by the responding AP 102-b. A quantity of UHR-LTF symbols may be calculated or determined may be specified by the Sync-Leader AP 102 (e.g., the AP 102 that may send the CoBF sync 415), or, additionally, or alternatively, a minimum quantity of UHR-LTF symbols may be determined based on a total Nss in CoBF transmission. In some cases, a spatial reuse parameter may be set to a state to disable spatial reuse during the CoBF procedure and there may be no information exchange on the spatial reuse parameter between the two APs 102 (e.g., or no information exchange may be necessary). In some cases, the quantity of CoBF users (e.g., quantity of non-OFDMA users) may be a total quantity of CoBF users across two BSSs (e.g., the summation of the quantity of users served by the initiating AP 102-a and the quantity of users served by the responding AP 102-b), and all of the user fields across two BSSs, as in the UHR-SIG of the PPDUs sent in the CoBF transmission, may be ordered and the spatial configuration subfield set based on one or more rules. The user fields may be ordered according to Nss in non-increasing order. In some cases, the user fields of users served by the same AP in one BSS may be contiguous, and not separated by user fields of users served by another AP in another BSS. In some examples, the order of the user fields of the BSS may be explicitly indicated (e.g., 1 bit to indicate the user fields of the users served by the sharing AP in the sharing BSS are before or after the user fields of the users served by the shared AP in the shared BSS) or implicitly implied (e.g., by the user field ordering) in the sync 415 (e.g., synchronization frame) or, additionally, or alternatively, may use a fixed order such that in the case where the user fields of either BSS may go first, while preserving the Nss in non-increasing order, the user fields of the sharing BSS may be ordered first or the order of the user fields of the shared BSS may be ordered first. The spatial configuration for each user may be derived based on per-user Nss and user ordering.

In some cases, the quantity of UHR-LTF symbols may be unknown at the time of the invite 405, as the total quantity of spatial streams and any extra LTFs may not be known. In the invite 405, the sharing AP 102 (e.g., initiating AP 102-a) may indicate the per-user Nss of the users served by the sharing AP 102 (implying the total quantity of spatial streams in the sharing BSS) and may indicate the maximum total quantity of spatial streams allowed for the shared AP 102. Additionally, or alternatively, the sharing AP 102 may also indicate, in the invite 405, whether extra LTFs may be allowed or not in the sharing BSS. In the response 410, the shared AP 102 (e.g., responding AP 102-b) may indicate the per-user Nss of the users served by the shared AP (e.g., implying the total quantity of spatial streams in the shared BSS and the total quantity of spatial streams across two BSSs) and may indicate whether extra LTFs may be allowed or not in the shared BSS. In some examples, the shared AP 102 may determine the quantity of UHR-LTF symbols (e.g., based on the total quantity of spatial streams across the two BSSs and whether extra LTFs may be allowed in each BSS) and may indicate the quantity of UHR-LTF symbols (e.g., 1-3 bits, 1 bit to indicate whether extra LTF may be enabled, 1-bit to indicate two values of the quantity of UHR-LTF symbols for each total quantity of spatial streams across two BSSs, or 2-3 bits to indicate the quantity of UHR-LTF symbols) in the response 410. In other examples, the sharing AP 102 may determine the quantity of UHR-LTF symbols (e.g., based on the total quantity of spatial streams across the two BSSs and whether extra LTFs may be allowed in each BSS) and may indicate, in the sync 415 (e.g., synchronization frame), the quantity of UHR-LTF symbols (e.g., 1-3 bits, 1 bit to indicate whether extra LTF may be enabled, 1-bit to indicate two values of the quantity of UHR-LTF symbols for each total quantity of spatial streams across two BSSs or not, 1-bit to indicate two values of the quantity of UHR-LTF symbols for each total quantity of spatial streams across two BSSs). Table 3 may provide an example mapping between the quantity of spatial streams across two BSSs (Nss, total) and the quantity of UHR-LTF symbols (e.g., N_{LTF}, with and without extra LTFs).

TABLE 3
Example of Mapping Between Quantity of Spatial Streams
per BSS and the Quantity of UHR-LTF Symbols

| | | | Minimum | |
|---|---|---|---|---|
| | | | N_{LTF} (e.g., | |
| N_{SStotal} | N_{SStotal} | | N_{LTF} without | N_{LTF} with |
| in BSS1 | in BSS2 | N_{SStotal} | Extra LTF) | Extra LTF |
| 1 | 1 | 2 | 2 | 4 |
| 1 | 2 | 3 | 4 | 8 |
| 1 | 3 | 4 | 4 | 8 |
| 2 | 2 | 4 | 4 | 8 |

In some implementations, PPDU length and LDPC encoding parameters, which may be included in the CoBF invite 405, the CoBF response 410, or both, may be determined or derived by an AP 102 based on an initial pre-FEC padding factor and an initial quantity of OFDM symbols for each BSS in a same LDPC rate matching algorithm as multiple users in one BSS. That is, based on indicated parameters, each AP 102 may determine values for the PPDU length and LDPC encoding to preserve rate matching between users. For example, the PPDU length and PHY coded bits boundary may be chosen from a reference BSS, which may have a data field with longer length. If two BSSs have a same PHY coded bits boundary and a same value in the LDPC extra symbol segment, there may be no need to change or update the parameters. However, if two BSSs have same PHY coded bits boundary but different values in the LDPC extra symbol segment, the AP 102 may choose the BSS that has an LDPC extra symbol segment being et to OFF (e.g., 0) to be a reference BSS. The AP 102 may update the initial pre-FEC padding factor and the initial quantity of OFDM symbols of a BSS that may not be the reference BSS according to those of the reference BSS, and may recalculate the LDPC encoding parameters as such. In some examples (e.g., if the LDPC extra symbol segment is enabled (e.g., ON, 1) in at least one BSS), the AP 102 may determine the LDPC extra symbol segment. Each AP 102 may update the parameters accordingly and following the same rules, and thus may not require further exchange of information.

In some implementations, a CoBF sync 415 may be transmitted, from the initiating AP 102-a or the responding AP 102-b. The CoBF sync 415 may include a CoBF trigger indication, an indication differentiating between a CoBF and a C-SR procedure (e.g., 1 bit) (e.g., if not included in a common information field or special user information field), or any combination thereof. In some cases, the CoBF sync 415 may also include a quantity of UHR-LTF symbols (e.g., between 1 and 3 bits), or, additionally, or alternatively, a Sync-Leader indication (e.g., 1 bit, indicates whether the AP 102 transmitting the sync 415 may be a Sync-Leader or Sync-Follower). The quantity of UHR-LTF symbols may be three bits indicative of a complete set of quantities of UHR-LTF symbols (e.g., a conventional or legacy quantity of bits), or the quantity of UHR-LTF symbols may be 1 or 2 bits indicative of a reduced set of quantities of UHR-LTF symbols no less than the minimum quantity of UHR-LTF symbols. In some cases, the CoBF sync 415 may be used for synchronization before a CoBF transmission.

The PHY information exchange may allow parameters to be indicated in the invite 405, response 410, and the syncs 415 (e.g., synchronization frames). In some implementations, optional PHY information may be omitted (e.g., fixed value, derivable at each AP 102), or may be signaled in any of the three frames (e.g., invite 405, response 410, sync 415). The sync 415 may repeat some of the PHY information that may be carried in or derived from the invite 405 and the response 410.

In some cases, two frames (e.g., invite 405 and response 410) may be used to complete the information exchange of baseline information. Baseline PHY information may be exchanged in the two frames, and the packet size or sizes, MCS or MCSs, and rate matching for the sharing BSS may be pre-determined and indicated in the invite 405. Different parameters may be indicated or determined in the two frames, as in Table 4 (Option 1).

TABLE 4
Example of Subfields Indicated by Frame for Two Frame Option (e.g., Option 1) (B = Baseline, O = Optional)

| Preamble | | | | | | |
|---|---|---|---|---|---|---|
| Field/Control | | | Carried in | Carried in | Carried in | |
| Information | Subfield | Category | Invite 405 | Response 410 | Sync 415 | Rule |
| Control | Information | B | Yes | Yes | Yes | |
| Information | Type | | (‘Invitation’) | (‘Confirmation’) | (‘Trigger’/ | |
| | | | | | ‘Synchronization’) | |
| Control | MAP | B | Yes | Yes | Yes | |
| Information | Scheme | | (‘CoBF’) | (‘CoBF’) | (‘CoBF’) | |
| | (‘COBF’, | | | | | |
| | ‘Type-I C- | | | | | |
| | SR’, ‘Type- | | | | | |
| | II C-SR’, | | | | | |
| | etc.) | | | | | |
| Control | Sync- | B | Yes | | | |
| Information | Leader/Sync- | | | | | |
| | Follower | | | | | |
| | Indication | | | | | |
| | (1 bit) | | | | | |
| Control | Immediate | B | Yes | Yes | Yes | |
| Information | Response | | | | | |
| | Needed | | | | | |
| | (1 bit) | | | | | |
| L-SIG | Length | B | Rough length/ | Yes | | The final |
| | (12 bits) | | duration (e.g., | | | length |
| | | | Modified Length | | | (octets) may |
| | | | (e.g., in the | | | be derived |
| | | | unit of octets) | | | based on the |
| | | | (12 bits), | | | rough length/ |
| | | | Quantity of | | | duration and |
| | | | OFDM Symbols | | | the final |
| | | | (9 bits), | | | quantity of |
| | | | Initial | | | UHR-LTF |
| | | | Quantity of | | | symbols |
| | | | OFDM Symbols | | | |
| | | | (9 bits) | | | |
| U-SIG | PHY Version | B | Yes (set to 1) | Yes (set to 1) | Yes (set to 1) | |
| | Identifier | | | | | |
| | Bandwidth | B | Yes | | | |
| | (3 bits) | | | | | |
| | Uplink/ | O | | | | |
| | Downlink | | | | | |
| | Indication | | | | | |
| | (1 bit) | | | | | |
| | BSS Color(s) | O | | | | |
| | (6 bits each) | | | | | |
| | TXOP | B | | | | |
| | (7 bits) | | | | | |
| | PPDU Type | O | | | | |
| | and Compression | | | | | |
| | Mode (2 bits) | | | | | |
| | CoBF/C-SR | O | | | | |
| | Indication | | | | | |
| | (1 bit) | | | | | |
| | Punctured | B | Yes | | | |
| | Channel | | | | | |
| | Information | | | | | |
| | (5 bits) | | | | | |
| | UHR-SIG | O | | | | |
| | MCS (2 bits) | | | | | |
| | Quantity of | O | | | | Determined |
| | UHR-SIG | | | | | by the |
| | Symbols | | | | | quantity of |
| | (5 bits) | | | | | user fields |
| | | | | | | and the UHR- |
| | | | | | | SIG MCS |
| UHR-SIG | Spatial | O | | | | |
| Common | Reuse | | | | | |
| Field | (4 bits) | | | | | |
| | GI + LTF | B | Yes | | | |
| | Size | | | | | |
| | (2 bits) | | | | | |
| | Quantity of | B | Extra | Number Of | | Shared AP |
| | UHR-LTF | | LTF | UHR-LTF | | 102 |
| | Symbols | | Allowed | Symbols | | determines |
| | (3 bits) | | (1 bit), | (3 bits) | | the final |
| | | | Maximum | | | quantity of |
| | | | Total Nss | | | UHR-LTF |
| | | | allowed | | | symbols |
| | | | at shared | | | |
| | | | AP (2 bits) | | | |
| | LDPC | Either | Yes (or | | | Shared AP |
| | Extra | | fixed to | | | 102 tailors |
| | Symbol | | 1) | | | packet size(s) |
| | Segment | | | | | to meet pre- |
| | (1 bit) | | | | | FEC padding |
| | Pre-FEC | Either | Yes (or | | | boundary |
| | Padding | | fixed to | | | |
| | Factor | | a valued | | | |
| | (2 bits) | | (e.g., 3)) | | | |
| | PE | B | Yes | Yes (or | | |
| | Disambiguity | | | omitted) | | |
| | (1 bit) | | | | | |
| | Quantity of | O | Quantity | Quantity | | Determined |
| | CoBF Users | | of CoBF | of CoBF | | by the total |
| | (e.g., | | Users | Users | | quantity of |
| | Quantity of | | served by | served by | | CoBF users |
| | Non-OFDMA | | the sharing | the shared | | |
| | users) | | AP 102 | AP 102 | | |
| | (3 bits) | | (1-2 bits) | (1-2 bits), | | |
| | | | | or Quantity | | |
| | | | | of CoBF | | |
| | | | | Users (2-3 | | |
| | | | | bits for the | | |
| | | | | total number | | |
| | | | | across two | | |
| | | | | BSSs) | | |
| UHR-SIG | STA ID | B | Yes (for | Yes (for | | |
| User Field | (11 bits) | | users in | users in | | |
| | | | the sharing | the shared | | |
| | | | BSS) | BSS) | | |
| | MCS | B | Yes (for | Yes (for | | |
| | (5 bits) | | users in | users in | | |
| | | | the sharing | the shared | | |
| | | | BSS) | BSS) | | |
| | Spatial | O | Nss | Nss | | Determined, |
| | Configuration | | (1-2 bits) | (1-2 bits) | | as described |
| | (4 bits) | | (for the | (for the | | with reference |
| | | | users in | users in | | to Table 1 |
| | | | the sharing | the shared | | |
| | | | BSS) | BSS) | | |
| | BSS Color | 0 | | | | |
| | Indication | | | | | |
| | (1 bit) | | | | | |
| | 2xLDPC | B | Yes (for | Yes (for | | |
| | (1 bit) | | users in | users in | | |
| | | | the sharing | the shared | | |
| | | | BSS) | BSS) | | |

For the two frames option (e.g., Option 1, Table 4), the sharping AP 102 may indicate in the CoBF invite 405, whether extra LTF is allowed (e.g., 1 bit) and a maximum total quantity of spatial streams (Nss,total) allowed for the shared AP 102 (e.g., 2 bits to indicate the maximum total quantity of spatial stream that the shared AP 102 may transmit). The shared AP 102 may determine and indicate, in the CoBF response 410, the final quantity of UHR-LTF symbols. In some cases, if the sharing AP 102 indicates that the extra LTF may not be allowed, the shared AP 102 may use the minimum quantity of UHR-LTF symbols (e.g., derived based on the total quantity of spatial streams transmitted by the two APs 102) as the quantity of UHR-LTF symbols. In other cases, if the sharing AP 102 may indicate that extra LTF may be allowed, the shared AP 102 may determine the quantity of UHR-LTF symbols based on the minimum quantity of UHR-LTF symbols (e.g., derived based on the total quantity of spatial streams transmitted by the two APs 102) and whether the extra LTF is allowed by both APs 102.

In some cases, the sharing AP 102 may indicate, in the CoBF invite 405, a rough or estimated length or duration for the L-SIG (9-12 bits), the LDPC extra symbol segment (1 bit), a pre-FEC padding factor (2 bits), a PE disambiguity (1 bit), or any combination thereof. The rough length or duration may be a modified length (e.g., in the unit of octets) (e.g., assuming the length is only derived based on a quantity of data OFDM symbols, quantity of UHR-SIG symbols corresponding to the quantity of users in the sharing BSS, and a minimum quantity of UHR-LTF symbols corresponding to the total quantity of spatial streams transmitted by the sharing AP 102), a quantity of OFDM Symbols, an initial quantity of OFDM symbols, other parameters, or any combination thereof. In some examples, the PE disambiguity may be derived based on the modified length (octets). By specifying the rough length or duration, the LDPC extra symbol segment, and the pre-FEC padding factor, the sharing AP 102 may determine the pre-FEC padding boundary and PHY coded bits boundary. In some cases, the shared AP 102 may tailor the packet size(s) to meet the pre-FEC padding boundary. Additionally, or alternatively, the shared AP 102 also determines the final quantity of UHR-LTF symbols. In some cases, the final length (12 bits), as the Length subfield in L-SIG in the PPDUs sent in the CoBF transmission, and PE disambiguity (1 bit), as a subfield in the common field of UHR-SIG in the PPDUs sent in the CoBF transmission, may be derived and indicated in the CoBF response 410, or may be omitted as each AP 102 may derive these parameters individually.

In some implementations, three frames (e.g., invite 405, response 410, sync 415) may be used to complete the information exchange. Baseline PHY information may be exchanged in the three frames, and the packet size or sizes, MCS or MCSs, and rate matching for the sharing BSS may be determined and indicated in the invite 405, while the packet size or sizes, MCS or MCSs, and rate matching for the shared BSS may be determined by the shared AP 102 and indicated in the response 410. The final packet size or sizes and rate matching may be determined or performed individually ta each AP 102. Different parameters may be indicated or determined in the three frames, as in Tables 5-7. In Table 5, packet size(s), MCS(s), and rate matching may be indicated in the invite 405 (Option 2a). In Table 6, packet size(s) and MCS(s) in the sharing BSS and rate matching may be determined by the sharing AP 102 and may be indicated in the sync 415 (Option 2b). In Table 7, packet size(s) and MCS(s) in the sharing BSS may be determined by the sharing AP 102 and may be indicated in the sync 415, while rate matching may be pre-determined (Option 2c).

TABLE 5
Example of Subfields Indicated by Frame for Option 2a (B = Baseline, O = Optional)

| Preamble | | | | | | |
|---|---|---|---|---|---|---|
| Field/Control | | | Carried in | Carried in | Carried in | |
| Information | Subfield | Category | Invite 405 | Response 410 | Sync 415 | Rule |
| Control | Information | B | Yes | Yes | Yes | |
| Information | Type | | (‘Invitation’) | (‘Confirmation’) | (‘Trigger’/ | |
| | | | | | ‘Synchronization’) | |
| Control | MAP | B | Yes | Yes | Yes | |
| Information | Scheme | | (‘CoBF’) | (‘CoBF’) | (‘CoBF’) | |
| | (‘COBF’, | | | | | |
| | ‘Type-I C- | | | | | |
| | SR’, ‘Type- | | | | | |
| | II C-SR’, | | | | | |
| | etc.) | | | | | |
| Control | Sync- | B | Yes | | | |
| Information | Leader/Sync- | | | | | |
| | Follower | | | | | |
| | Indication | | | | | |
| | (1 bit) | | | | | |
| Control | Immediate | B | Yes | Yes | Yes | |
| Information | Response | | | | | |
| | Needed | | | | | |
| | (1 bit) | | | | | |
| L-SIG | Length | B | Rough length/ | | Yes | The final |
| | (12 bits) | | duration (e.g., | | | length |
| | | | Modified Length) | | | (octets) may |
| | | | (e.g., in the | | | be derived |
| | | | unit of octets) | | | based on the |
| | | | (12 bits), | | | rough length/ |
| | | | Quantity of | | | duration and |
| | | | OFDM Symbols | | | the final |
| | | | (9 bits), | | | quantity of |
| | | | Initial | | | UHR-LTF |
| | | | Quantity of | | | symbols |
| | | | OFDM Symbols | | | |
| | | | (9 bits) | | | |
| U-SIG | PHY Version | B | Yes (set to 1) | Yes (set to 1) | Yes (set to 1) | |
| | Identifier | | | | | |
| | Bandwidth | B | Yes | | | |
| | (3 bits) | | | | | |
| | Uplink/ | O | | | | |
| | Downlink | | | | | |
| | Indication | | | | | |
| | (1 bit) | | | | | |
| | BSS Color(s) | O | | | | |
| | (6 bits each) | | | | | |
| | TXOP | B | | | | |
| | (7 bits) | | | | | |
| | PPDU Type | O | | | | |
| | and Compression | | | | | |
| | Mode (2 bits) | | | | | |
| | CoBF/C-SR | O | | | | |
| | Indication | | | | | |
| | (1 bit) | | | | | |
| | Punctured | B | Yes | | | |
| | Channel | | | | | |
| | Information | | | | | |
| | (5 bits) | | | | | |
| | UHR-SIG | O | | | | |
| | MCS (2 bits) | | | | | |
| | Quantity of | O | | | | Determined |
| | UHR-SIG | | | | | by the |
| | Symbols | | | | | quantity of |
| | (5 bits) | | | | | user fields |
| | | | | | | and the UHR- |
| | | | | | | SIG MCS |
| UHR-SIG | Spatial | O | | | | |
| Common | Reuse | | | | | |
| Field | (4 bits) | | | | | |
| | GI + LTF | B | Yes (or | 0.8GI | Yes (if not | |
| | Size | | omitted) | Allowed | indicated in | |
| | (2 bits) | | | (1 bit) | the CoBF | |
| | | | | | Invite 405) | |
| | Quantity of | B | Maximum | Extra LTF | Quantity of | Sharing AP |
| | UHR-LTF | | Total Nss | Allowed | UHR-LTF | 102 |
| | Symbols | | allowed | (1 bit) | Symbols | determines |
| | (3 bits) | | at shared | | (3 bits) | the final |
| | | | AP (2 bits) | | | quantity of |
| | | | | | | UHR-LTF |
| | | | | | | symbols |
| | LDPC | Either | Yes (or | | | Shared AP |
| | Extra | | fixed to | | | 102 tailors |
| | Symbol | | 1) | | | packet size(s) |
| | Segment | | | | | to meet pre- |
| | (1 bit) | | | | | FEC padding |
| | Pre-FEC | Either | Yes (or | | | boundary |
| | Padding | | fixed to | | | |
| | Factor | | a valued | | | |
| | (2 bits) | | (e.g., 3)) | | | |
| | PE | B | Yes | Yes (or | Yes | |
| | Disambiguity | | | omitted) | | |
| | (1 bit) | | | | | |
| | Quantity of | O | Quantity | Quantity | | Determined |
| | CoBF Users | | of CoBF | of CoBF | | by the total |
| | (e.g., | | Users | Users | | quantity of |
| | Quantity of | | served by | served by | | CoBF users |
| | Non-OFDMA | | the sharing | the shared | | |
| | users) | | AP 102 | AP 102 | | |
| | (3 bits) | | (1-2 bits) | (1-2 bits) | | |
| UHR-SIG | STA ID | B | Yes (for | Yes (for | | |
| User Field | (11 bits) | | users in | users in | | |
| | | | the sharing | the shared | | |
| | | | BSS) | BSS) | | |
| | MCS | B | Yes (for | Yes (for | | |
| | (5 bits) | | users in | users in | | |
| | | | the sharing | the shared | | |
| | | | BSS) | BSS) | | |
| | Spatial | O | Nss | Nss | | Determined, |
| | Configuration | | (1-2 bits) | (1-2 bits) | | as described |
| | (4 bits) | | (for users in | (for users in | | with reference |
| | | | the sharing | the shared | | to Table 1 |
| | | | BSS) | BSS) | | |
| | BSS Color | O | | | | |
| | Indication | | | | | |
| | (1 bit) | | | | | |
| | 2xLDPC | B | Yes (for | Yes (for | | |
| | (1 bit) | | users in | users in | | |
| | | | the sharing | the shared | | |
| | | | BSS) | BSS) | | |

TABLE 6
Example of Subfields Indicated by Frame for Option 2b (B = Baseline, O = Optional)

| Preamble | | | | | | |
|---|---|---|---|---|---|---|
| Field/Control | | | Carried in | Carried in | Carried in | |
| Information | Subfield | Category | Invite 405 | Response 410 | Sync 415 | Rule |
| Control | Information | B | Yes | Yes | Yes | |
| Information | Type | | (‘Invitation’) | (‘Confirmation’) | (‘Trigger’/ | |
| | | | | | Synchronization’) | |
| Control | MAP | B | Yes | Yes | Yes | |
| Information | Scheme | | (‘CoBF’) | (‘CoBF’) | (‘CoBF’) | |
| | (‘COBF’, | | | | | |
| | ‘Type-I C-SR’, | | | | | |
| | ‘Type-II C-SR’, | | | | | |
| | etc.) | | | | | |
| Control | Sync-Leader/ | B | Yes | | | |
| Information | Sync-Follower | | | | | |
| | Indication | | | | | |
| | (1 bit) | | | | | |
| Control | Immediate | B | Yes | Yes | Yes | |
| Information | Response | | | | | |
| | Needed (1 bit) | | | | | |
| L-SIG | Length (12 bits) | B | Range of | | Yes | |
| | | | length/ | | | |
| | | | duration | | | |
| | | | (e.g., | | | |
| | | | [Minimum | | | |
| | | | Quantity | | | |
| | | | of Data | | | |
| | | | OFDM | | | |
| | | | Symbols | | | |
| | | | (9 bits), | | | |
| | | | Maximum | | | |
| | | | Quantity | | | |
| | | | of Data | | | |
| | | | OFDM | | | |
| | | | Symbols | | | |
| | | | (9 bits)] | | | |
| U-SIG | PHY Version | B | Yes (set | Yes (set | Yes (set | |
| | Identifier | | to 1) | to 1) | to 1) | |
| | Bandwidth | B | Yes | | | |
| | (3 bits) | | | | | |
| | Uplink/Downlink | O | | | | |
| | Indication | | | | | |
| | (1 bit) | | | | | |
| | BSS Color(s) | O | | | | |
| | (6 bits each) | | | | | |
| | TXOP (7 bits) | B | | | | |
| | PPDU Type and | O | | | | |
| | Compression | | | | | |
| | Mode (2 bits) | | | | | |
| | CoBF/C-SR | O | | | | |
| | Indication | | | | | |
| | (1 bit) | | | | | |
| | Punctured | B | Yes | | | |
| | Channel | | | | | |
| | Information | | | | | |
| | (5 bits) | | | | | |
| | UHR-SIG | O | | | | |
| | MCS (2 bits) | | | | | |
| | Quantity of | O | | | | Determined |
| | UHR-SIG Symbols | | | | | by the |
| | (5 bits) | | | | | quantity of |
| | | | | | | user fields |
| | | | | | | and the UHR- |
| | | | | | | SIG MCS |
| UHR-SIG | Spatial | O | | | | |
| Common | Reuse (4 | | | | | |
| Field | bits) | | | | | |
| | GI + LTF | B | Yes (or | 0.8GI | Yes (if not | |
| | Size (2 | | omitted) | Allowed | indicated in | |
| | bits) | | | (1 bit) | the CoBF | |
| | | | | | Invite 405) | |
| | Quantity of | B | Maximu, | Extra LTF | Quantity of | Sharing AP |
| | UHR-LTF | | Total Nss | Allowed | UHR-LTF | 102 |
| | Symbols (3 bits) | | allowed | (1 bit) | Symbols (3 bits) | determines |
| | | | at shared | | | the final |
| | | | AP 102 | | | quantity of |
| | | | (2 bits) | | | UHR-LTF |
| | | | | | | symbols |
| | LDPC Extra | B | | | Yes (or | Shared AP |
| | Symbol Segment | | | | fixed to 1) | 102 tailors |
| | (1 bit) | | | | | packet size(s) |
| | Pre-FEC Padding | B | | | Yes (or fixed | to meet pre- |
| | Factor (2 bits) | | | | to a valued | FEC padding |
| | | | | | (e.g., 3)) | boundary |
| | PE Disambiguity | B | | | Yes | |
| | (1 bit) | | | | | |
| | Quantity of | O | Quantity | Quantity | | Determined |
| | CoBF | | of CoBF | of CoBF | | by the total |
| | Users (e.g., | | Users served | Users served | | quantity of |
| | Quantity of | | by the sharing | by the shared | | CoBF users |
| | Non-OFDMA | | AP 102 | AP 102 | | |
| | users) (3 bits) | | (1-2 bits) | (1-2 bits) | | |
| UHR-SIG | STA ID (11 bits) | B | Yes (for | Yes (for | | |
| User Field | | | users in | users in | | |
| | | | the sharing | the shared | | |
| | | | BSS) | BSS) | | |
| | MCS (5 bits) | B | | Yes (for | Yes (for | |
| | | | | users in | users in | |
| | | | | the shared | the sharing | |
| | | | | BSS) | BSS) | |
| | Spatial | O | Nss (1-2 | Nss (1-2 | | Determined, |
| | Configuration | | bits) (for | bits) (for | | as described |
| | (4 bits) | | users in | users in | | with |
| | | | the sharing | the shared | | reference to |
| | | | BSS) | BSS) | | Table 1 |
| | BSS Color | O | | | | |
| | Indication | | | | | |
| | (1 bit) | | | | | |
| | 2xLDPC (1 bit) | B | | Yes (or | Yes (for | |
| | | | | 2xLDPC | users in | |
| | | | | Capability | sharing | |
| | | | | (1 bit)) | BSS, or for | |
| | | | | (for users | all users if | |
| | | | | in the shared | the 2xLDPC | |
| | | | | BSS) | bit(s) for the | |
| | | | | | users in the | |
| | | | | | shared BSS not | |
| | | | | | indicated in | |
| | | | | | the CoBF | |
| | | | | | Response 410) | |

TABLE 7
Example of Subfields Indicated by Frame for Option 2c (B = Baseline, O = Optional)

| Preamble | | | | | | |
|---|---|---|---|---|---|---|
| Field/Control | | | Carried in | Carried in | Carried in | |
| Information | Subfield | Category | Invite 405 | Response 410 | Sync 415 | Rule |
| Control | Information | B | Yes | Yes | Yes | |
| Information | Type | | (‘Invitation’) | (‘Confirmation’) | (‘Trigger’/ | |
| | | | | | ‘Synchronization’) | |
| Control | MAP | B | Yes | Yes | Yes | |
| Information | Scheme | | (‘CoBF’) | (‘CoBF’) | (‘CoBF’) | |
| | (‘COBF’, | | | | | |
| | ‘Type-I C-SR’, | | | | | |
| | ‘Type-II C-SR’, | | | | | |
| | etc.) | | | | | |
| Control | Sync-Leader/ | B | Yes | | | |
| Information | Sync-Follower | | | | | |
| | Indication | | | | | |
| | (1 bit) | | | | | |
| Control | Immediate | B | Yes | Yes | Yes | |
| Information | Response | | | | | |
| | Needed (1 bit) | | | | | |
| L-SIG | Length (12 bits) | B | Range of | | Yes | |
| | | | length/ | | | |
| | | | duration | | | |
| | | | (e.g., | | | |
| | | | [Minimum | | | |
| | | | Quantity | | | |
| | | | of Data | | | |
| | | | OFDM | | | |
| | | | Symbols | | | |
| | | | (9 bits), | | | |
| | | | Maximum | | | |
| | | | Quantity | | | |
| | | | of Data | | | |
| | | | OFDM | | | |
| | | | Symbols | | | |
| | | | (9 bits)] | | | |
| U-SIG | PHY Version | B | Yes (set | Yes (set | Yes (set | |
| | Identifier | | to 1) | to 1) | to 1) | |
| | Bandwidth | B | Yes | | | |
| | (3 bits) | | | | | |
| | Uplink/ | O | | | | |
| | Downlink | | | | | |
| | Indication | | | | | |
| | (1 bit) | | | | | |
| | BSS | O | | | | |
| | Color(s) (6 | | | | | |
| | bits each) | | | | | |
| | TXOP (7 bits) | B | | | | |
| | PPDU | O | | | | |
| | Type and | | | | | |
| | Compression | | | | | |
| | Mode (2 bits) | | | | | |
| | CoBF/C-SR | O | | | | |
| | Indication | | | | | |
| | (1 bit) | | | | | |
| | Punctured | B | Yes | | | |
| | Channel | | | | | |
| | Information | | | | | |
| | (5 bits) | | | | | |
| | UHR-SIG | O | | | | |
| | MCS (2 | | | | | |
| | bits) | | | | | |
| | Quantity of | O | | | | Determined |
| | UHR-SIG | | | | | by the |
| | Symbols (5 | | | | | quantity of |
| | bits) | | | | | user fields |
| | | | | | | and the UHR- |
| | | | | | | SIG MCS |
| UHR-SIG | Spatial | O | | | | |
| Common | Reuse (4 | | | | | |
| Field | bits) | | | | | |
| | GI + LTF | B | Yes (or | 0.8GI | Yes (if not | |
| | Size (2 | | omitted) | Allowed | indicated in | |
| | bits) | | | (1 bit) | the CoBF | |
| | | | | | Invite 405) | |
| | Quantity of | B | Maximum | Extra LTF | Quantity of | Shared AP 102 |
| | UHR-LTF | | Total Nss | Allowed | UHR-LTF | determines |
| | Symbols (3 | | allowed | (1 bit) | Symbols (3 | the final |
| | bits) | | at shared | | bits) | quantity of |
| | | | AP 102 | | | UHR-LTF |
| | | | (2 bits) | | | symbols |
| | LDPC Extra | O | | | | Shared AP |
| | Symbol | (fixed | | | | 102 tailors |
| | Segment (1 | to 1) | | | | packet size(s) |
| | bit) | | | | | to meet pre- |
| | Pre-FEC | O | | | | FEC padding |
| | Padding | (fixed to | | | | boundary |
| | Factor (2 | a value | | | | |
| | bits) | (e.g., 3)) | | | | |
| | PE | B | | | Yes | |
| | Disambiguity | | | | | |
| | (1 bit) | | | | | |
| | Quantity of | O | Quantity | Quantity | | Determined |
| | CoBF | | of CoBF | of CoBF | | by the total |
| | Users (e.g., | | Users | Users | | quantity of |
| | Quantity of | | served by | served by | | CoBF users |
| | Non-OFDMA | | the sharing | the shared | | |
| | users) (3 bits) | | AP 102 | AP 102 | | |
| | | | (1-2 bits) | (1-2 bits) | | |
| UHR-SIG | STA ID (11 | B | Yes (for | Yes (for | | |
| User Field | bits) | | users in | users in | | |
| | | | the sharing | the shared | | |
| | | | BSS) | BSS) | | |
| | MCS (5 | B | | Yes | Yes (for | |
| | bits) | | | | users in the | |
| | | | | | sharing | |
| | | | | | BSS) | |
| | Spatial | O | Nss (1-2 | Nss (1-2 | | Determined, |
| | Configuration | | bits) (for | bits) (for | | as described |
| | (4 bits) | | users in | users in | | with |
| | | | the sharing | the shared | | reference to |
| | | | BSS) | BSS) | | Table 1 |
| | BSS Color | O | | | | |
| | Indication | | | | | |
| | (1 bit) | | | | | |
| | 2xLDPC (1 | B | | Yes (or | Yes (for | |
| | bit) | | | 2xLDPC | users in | |
| | | | | Capability | sharing | |
| | | | | (1 bit)) | BSS, or for | |
| | | | | (for users | all users if | |
| | | | | in the | the 2xLDPC | |
| | | | | shared | bit(s) for the | |
| | | | | BSS) | users in the | |
| | | | | | shared BSS | |
| | | | | | not yet | |
| | | | | | indicated in | |
| | | | | | the CoBF | |
| | | | | | Response | |
| | | | | | 410) | |

For the three frame options (e.g., Options 2a, 2b, and 2c, Tables 5-7), the sharing AP 102 may indicate, in the CoBF invite 405, a maximum total Nss at the shared AP 102 (e.g., 2 bits to indicate a maximum total quantity of spatial streams (Nss) that the shared AP 102 may transmit (e.g., may be allowed to transmit). The sharing AP 102 may also indicate whether the extra LTF may be allowed (1 bit) or may omit this. The shared AP 102 may determine and indicate, in the CoBF response 410, whether the extra LTF may be allowed. The sharing AP 102 may indicate, in the sync 415, the final quantity of UHR-LTF symbols. In some cases, if the shared AP 102 indicates that the extra LTF may not be allowed, the sharing AP 102 may use the minimum quantity of UHR-LTF symbols (e.g., derived based on the total quantity of spatial streams transmitted by the two APs 102) as the quantity of UHR-LTF symbols. In other cases, if the shared AP 102 may indicate that extra LTF may be allowed, the sharing AP 102 may determine the quantity of UHR-LTF symbols based on the minimum quantity of UHR-LTF symbols (e.g., derived based on the total quantity of spatial streams transmitted by the two APs 102) and whether the extra LTF is allowed by both APs 102.

In some cases (e.g., option 1 and Table 4, option 2a and Table 5), the sharing AP may indicate, in the CoBF invite 405, the rough length or data field duration. In other cases (e.g., option 2b and Table 6, option 2c and Table 7), the sharing AP 102 may indicate, in the CoBF invite 405, the rough range of the length or data field duration. In some cases (e.g., option 1 and Table 4, option 2a and Table 5), the MCS and 2×LDPC bits for the users in the sharing BSS may be pre-determined by the sharing AP 102 and may be indicated in the invite 405. In other cases (e.g., option 2b and Table 6, option 2c and Table 7), the MCS and 2×LDPC bits for the users in the sharing BSS may be determined by the sharing AP 102 after receiving the response 410, and may be indicated in the sync 415 (e.g., synchronization frame). In some cases (e.g., option 1 and Table 4, option 2a and Table 5), the LDPC encoding parameters (e.g., LDPC extra symbol segment, pre-FEC padding factor) may be baseline (e.g., pre-determined and indicated in the invite 405) or optional (e.g., fixed values, omitted or not indicated). In other cases (e.g., option 2b and Table 6), the LDPC encoding parameters may be baseline (e.g., determined by the sharing AP 102 after receiving the response 410 and indicated in the sync 415). In other cases (e.g., option 2c and Table 7), the LDPC encoding parameters may be optional (e.g., fixed values, omitted or not indicated).

In some cases, the APs 102 may implement a trigger-based (TB) BlockAck (BA) information exchange during the CoBF information exchange (or a C-SR information exchange). For example, after the CoBF (or C-SR) transmission, the APs 102 may use coordinated uplink TB transmission to solicit BA from multiple CoBF users, which may include concurrent transmission from all CoBF users across two BSSs, and may follow immediately after a Data PPDU in the CoBF transmission (e.g., may be enabled or disabled for C-SR). In some examples, the uplink TB PPDU may be an uplink OFDMA transmission, uplink non-OFDMA MU-MIMO transmission, or a mixture of uplink OFDMA and MU-MIMO transmission, and the co-uplink TB BA may always be uplink OFDMA without MU-MIMO in any RU. In some examples, the sync 415 may carry various information related to the TB BA. For example, the sync 415 may include control information, such as a bit to indicate immediate TB BA ON or OFF for all CoBF users (OFF may mean a delayed BA), two bits to indicate immediate TB BA ON or OFF for CoBF users in two separate BSSs (1-bit for CoBF users in sharing BSS and 1-bit for CoBF users in shared BSS), or any combination thereof. Additionally, or alternatively, the sync 415 may include common information for the TB PPDU, including uplink length (e.g., 12 bits), a GI and UHR-LTF type (e.g., 2 bits, if not fixed or using 1 bit for a reduced set), a quantity of UHR-LTF symbols (e.g., 3 bits, if not fixed or using 1 or 2 bits for a reduced set of choices), a LDPC extra symbol segment indication (e.g., 1 bit, if not fixed, e.g., to 1), pre-FEC padding factor indication (e.g., 2 bits, if not fixed, e.g., to 4), a PE disambiguity indication (e.g., 1 bit), distributed RU (DRU) or regular RU (RRU) indication (e.g., 4 bits, if not fixed to RRU only), or any combination thereof. Additionally, or alternatively, the APs 102 may assume spatial reuse is disabled and interference mitigation (IM) is disabled. Additionally, or alternatively, the sync 415 may include per-user info for the TB PPDU to carry the BA frames, including RU type (e.g., RRU or DRU, if not fixed to either RRU or DRU), RU allocation (e.g., total 9 bits including the 8-bit RU Allocation and 1-bit PS160), coding type (e.g., 1 bit, if not fixed, e.g., LDPC), MCS (e.g., 5 bits), 2×LDPC bit (e.g., 1 bit), uplink target receive power (e.g., 7 bits), spatial stream allocation (e.g., total 5 bits) including starting stream index (e.g., 3 bits) and quantity of spatial streams (e.g., 2 bit) in the case of RRU, a spatial stream allocation (e.g., total 5 bits) including distribution bandwidth (e.g., 2 bits), reserved bits (e.g., 2 bits), a quantity of spatial streams (e.g., 1 bit, DRU) in the case of DRU, or any combination thereof.

In some cases, APs 102 may perform and indicate STA selection and grouping. In some examples, STA selection and grouping may depend on a spatial correlation of channels. For example, for grouping (e.g., long term or short term), in-BSS STAs and overlapping BSS (OBSS) STAs may be grouped with one or more channels with larger spatial separation, rather than smaller spatial separation. For selection (e.g., short term, for a particular transmission), scheduling users may depend on both STA grouping and payload size. In some examples, there may be no STA grouping information exchange. For joint NDP sounding, each AP 102 may collect the global CSI and may implement grouping and selection accordingly. For sequential NDP sounding, each AP 102 may listen to the in-BSS sounding section of the other AP 102 and record the CSI feedback, and may implement grouping and selection accordingly.

In other examples, there may be a post-sounding information exchange of a recommended STA grouping. For example, this may be a one-time exchange where each AP 102 may send the information to each other (e.g., bidirectional information exchange). In other examples, there may be a per-TXOP information exchange. For example, there may be information included in the invite 405, response 410, sync 415, or any combination hereof (e.g., unidirectional from sharing AP 102 to shared AP 102). A per-TXOP information exchange may aid in accurately determining a MCS and range of data field duration in the invite 405 when the sharing AP 102 selects users in the sharing BSS. In other examples, a combination of a per-TXOP information exchange and a post-sounding information exchange may be implemented for sharing information for STA selection and grouping. For example, there may be a long-term exchange for a group of more candidate OBSS STA for each in-BSS STA, and there may also be a per-TXOP exchange to narrow down the selection to a smaller number of OBSS STAs.

For both long term feedback associated with STA selection and grouping (e.g., post-sounding information exchange, combined information exchange) and short term feedback (per-TXOP information exchange, combined information exchange), there may be one or more parameters that may be derived by the APs 102. For example, for each in-BSS STA, a list of preferred OBSS STAs in a grouping may be derived (e.g., a list of the STAs (e.g., IDs) in the form of [STA_ID_1_BSS_2, STA_ID_2_BSS_2] for an in-BSS STA with STA_ID_1_BSS_1) (e.g., a bitmap (binary: 1 means preferred, 0 means negative) with 1 bit for each OBSS STA, where the order of OBSS STAs may be known (e.g., according to STA ID in increasing order or order of STA number in sounding (e.g., STA info fields ordering in NDPA))). Additionally, or alternatively, a list of OBSS STAs to avoid in grouping (e.g., list or bitmap, as described with reference to the list of preferred OBSS STAs) may be derived. Additionally, or alternatively, a list of preference rating of OBSS STAs may be derived. For example, for each in-BSS STA, there may be a rating (e.g., scale 1-5) for each OBSS STA to indicate a level of preference. Some OBSS STAs may have the same rating. Additionally, or alternatively, an ordered of OBSS STAs according to preference may be derived (e.g., in the form of an ordered list of STAs (e.g., IDs, STA number according to STA ID in increasing order, or STA number in sounding)).

For a per-TXOP information exchange associated with STA selection and grouping, the sharing AP 102 may indicate users in the sharing BSS in the invite 405. The shared AP 102 may select users and the per-user Nss according to a maximum total Nss allowed for the shared AP 102, as indicated in the invite 405, and may indicate users in the shared BSS in the response 410. The sharing AP 102 may down select the users in the shared BSS and indicates the information in the sync 415. In some examples, the per-user Nss, MCS, and 2×LDPC information may not change in the down selection. In some examples, the sharing AP 102 may select none of the users in the shared BSS and may disable or reject the shared AP 102 for the CoBF transmission opportunity. The transmission to follow may no longer be a CoBF transmission between the two APs 102. In some examples, the sharing AP 102, shared AP 102, or both may indicate a list of STAs (e.g., IDs, STA number according to STA ID in increasing order, STA number according to user field ordering in the Response frame, a bitmap (1 meaning user is selected, 0 meaning not selected), or the like). In some examples, the sharing AP 102 may indicate a list of candidate users in the shared BSS in the invite 405 and may let the shared AP 102 down select from the list, the shared AP 102 may indicate the down selection in the response 410. In some examples, the sharing AP 102 may indicate a list of users in the shared BSS in the invite 405 and may let the shared AP 102 accept the list, or reject the CoBF opportunity in the response 410.

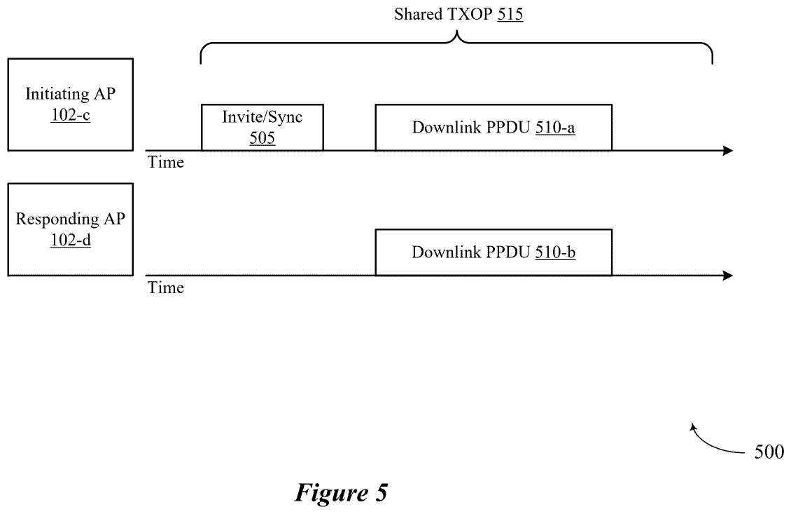

Although the techniques described so far regarding FIG. 4 may be described with respect to a CoBF procedure, a similar information exchange may be applicable for a C-SR procedure. For example, similar to a CoBF procedure, a C-SR procedure may use a three frame handshaking procedure (e.g., invite 405, response 410, sync 415) for information exchange prior to a C-SR procedure, such as synchronous C-SR. Synchronous C-SR may also be possible with a one frame information exchange, as explained further with respect to FIG. 5. In other cases, asynchronous C-SR may be possible with a two frame system, as explained further with respect to FIG. 5.

For C-SR information exchange, regardless of the frame setup, a subset of information may be exchanged in comparison to the information exchange for the CoBF procedure. The C-SR transmissions may share a common preamble up to a portion of the message, such as the L-SIG or the U-SIG or both. That is, the C-SR may be divided into two types (e.g., modes). Type-I C-SR may not include same U-SIG contents (e.g., the transmit sequence may include a C-SR trigger/sync frame followed by the PPDUs in C-SR transmission where the PPDUs share the same/common L-SIG contents while possible different U-SIG contents or different SIG fields after L-SIG). Type-I C-SR may be used for UHR+EHT, EHT+UHR, or EHT+EHT combinations of PPDUs in C-SR transmissions, and may be provided if non-UHR EHT non-AP STA(s) may be recipient STA(s). Type-II C-SR may include the same L-SIG and U-SIG contents (e.g., the transmit sequence may include a C-SR trigger/sync frame followed by the PPDUs in C-SR transmission where the PPDUs share same/common L-SIG contents and same/common U-SIG contents). Type-II C-SR may be implemented for UHR+UHR C-SR transmission. In some examples, a C-SR invite 405 may include a C-SR invite indication. The C-SR invite 405 may include a C-SR invite 405 may include information for the L-SIG, such as a length field (e.g., as described with reference to the CoBF invite 405) (e.g., if the C-SR transmission share a common preamble up to at least the L-SIG), information for the U-SIG (e.g., as described with reference to the CoBF invite 405) (e.g., if the C-SR transmission share a common preamble up to at least the U-SIG), or any combination thereof. In some cases, the C-SR invite 405 may include interference or power control information for the responding AP 102-b or the initiating AP 102-a or both, an assigned bandwidth of the responding AP 102-b (e.g., if partial bandwidth C-SR is allowed or used), or any combination thereof. The C-SR response 410 may include an intent to participate in the C-SR procedure or a C-SR response indication and, additionally, or alternatively, interference or power control information for the responding AP 102-b or the initiating AP 102-a or both, an assigned bandwidth of the responding AP 102-b (e.g., if partial bandwidth is allowed or used), or any combination thereof. The C-SR sync 415 may include a C-SR trigger indication and, additionally, or alternatively, interference or power control information for the responding AP 102-b or the initiating AP 102-a or both. For both C-SR types, the two PPDUs 420 for the APs 102 may start and end at the same time. In some examples, a UHR PPDU 420 for C-SR transmission may be used for either type of C-SR when UHR transmission may be implemented. There may an indication in the U-SIG field to indicate that the UHR PPDU 420 may be a UHR PPDU 420 for C-SR transmission.

In some cases, such as for Type-II C-SR (e.g., common preamble up to UHR-LTF), the preamble design may support clean channel estimation and interfering channel estimation. The common preamble may include L-SIG (and RL-SIG), U-SIG, UHR-SIG, UHR-STF, UHR-LTF, or any combination thereof, in addition to L-STF and L-LTF. The UHR-LTF may be a joint LTF, where each AP 102 may transmit non-overlapping sets of spatial streams. The UHR-SIG for C-SR may use the same design as in CoBF. In some examples, although the PPDU Type and Compression Mode may indicate 1, the quantity of Non-OFDMA users in the UHR-SIG common field may indicate two users and there may be two different user fields (one for each user in each BSS) with the MU-MIMO user field format. This preamble design may be implemented for Type-II C-SR, or may be a sub-option for a preamble for Type-II C-SR such as Type-II-b C-SR.

In some cases, not all users may support Type-II C-SR or Type-II-b C-SR. For example, not all users may support processing a total quantity of spatial streams (e.g., total 8 spatial streams C-SR allows each AP 102 to transit up to 4 spatial streams) and at least eight LTF symbols. In this case, the total quantity of UHR-LTF symbols may be negotiated. The shared AP 102 may select STAs that may support Type-II C-SR or Type-II-b C-SR and may support the reception of the quantity of LTF symbols in the C-SR transmission. In some examples (e.g., Type-II C-SR only), the control information signaling may be as described herein. In other cases, there may be new signaling to differentiate Type-II C-SR subtypes (e.g., Type-II-b C-SR) from the original Type-II C-SR (e.g., Type-II-a C-SR). In some examples, in the MAP scheme or advanced scheme subfield, besides the values for other MAP schemes or advanced schemes, there may be 3 values for C-SR, including Type-I C-SR, Type-II-a C-SR and Type-II-b C-SR. In other examples, there may be no change to the MAC scheme or advanced scheme subfield design. However, if the MAC scheme or advanced scheme subfield is set to Type-II C-SR, there may be an additional 1-bit field to indicate Type-II-a (common preamble up to U-SIG) or Type-II-b C-SR (common preamble up to UHR-LTF). In other examples, If the MAP scheme or advanced scheme subfield indicates ‘C-SR’ (no details in type), there may be an additional 2-bit field to indicate ‘Type-I’, ‘Type-II-a’ and ‘Type-II-b’ C-SR.

In some cases, as described herein, a one-frame sequence may be used for C-SR, such as Type-II-b C-SR. A one-frame sequence may not allow for enough PHY layer information exchange to support Type-II-b C-SR. In some sequences, such as the three-frame sequence, it may be necessary or possible to indicate UHR-SIG information. In some examples, the information exchange through three frames (e.g., invite 405, response 410, sync 415) for a C-SR transmission may be the same as the CoBF transmission, except the sharing AP 102 may indicate ‘Type-II C-SR’ or ‘Type-II-b C-SR’ instead of ‘CoBF’ in all frames (e.g., invite 405, response 410, sync 415). Additionally, or alternatively, the C-SR invite 405 may indicate the 12-bit length field instead of the range of PPDU duration or range of Data field duration. Additionally, or alternatively, control of N_{LTF} for a C_SR transmission may be implemented differently from CoBF. For example, the sharing AP 102 may not control the quantity of spatial streams transmitted at the shared AP 102 (e.g., may not indicate the Maximum Total Nss Allowed for Shared AP 102). Additionally, or alternatively, the sharing AP 102 may indicate the Maximum Total Nss Allowed for Shared AP 102 to control the total quantity of spatial streams in the joint LTF and the quantity of LTF symbols to ensure the users for the sharing AP 102 or the shared AP 102 may process the joint LTF. Additionally, or alternatively, the sharing AP 102 may determine and indicate MCS and 2×LDPC bit for the user in the sharing BSS in the invite 405. In some examples, the invite 405 may include control info and basic PHY info of length (12 bits) in L-SIG, PE disambiguity, bandwidth, punctured channel information, GI+LTF Size, maximum total Nss allowed for shared AP, maximum quantity of UHR-LTF symbols, per-user Nss for the single user in the sharing BSS, power control or interference control information, or any combination thereof. The invite 405 may, in some cases, also carry an indication of a LDPC extra symbol segment and pre-FEC padding factor, if these values are not fixed. The response 410 may indicate “acceptance” or “rejection”. In the case of “acceptance”, the shared AP 102 may send the same information as in the CoBF response 410. The sync 415 may carry the per-user STA ID, MCS and 2×LDPC of the users in the sharing BSS or both BSSs.

In some implementations, an AP 102 that may transmit the C-SR sync 415 (e.g., synchronization frame) may be known as a sharing AP 102. The AP 102 that may receive the sync 415 may be the shared AP 102. The sharing AP 102, that may transmit the trigger frame as part of a transmission sequence in a multi-AP coordinated transmission scheme, may identify the shared AP 102 via an AP ID carried in a field (e.g., the AID12 field) of a user information field (including a trigger-dependent user info field where the field size and structure may depend on the trigger type) for the sync frame 415. Multi-AP coordinated transmission schemes may include C-SR, CoBF and coordinated time division multiple access (Co-TDMA). That is, in some cases, the sharing AP 102 that initiates the C-SR transmission may transmit the C-SR sync 415 to initiate concurrent C-SR transmissions with one or more APs 102 within the obtained TXOP bandwidth. In some examples, the addressed non-AP STAs may be UHR STAs, and the concurrent C-SR transmission may start after some gap (e.g., SIFS period) after the C-SR sync 415. For C-SR, the trigger 415 that may initiate the concurrent C-SR transmissions between the APs 102 may include the duration of the data PPDU 420 transmitted by the sharing AP 102 and the duration of the data PPDU 420 transmitted by the shared AP 102, which may be the same and may be transmitted after the sync 415. Additionally, or alternatively, the sync 415 may include other parameters related to the C-SR transmission.

In some cases, C-SR transmission may include negotiation between APs 102. For example, for a three-frame sequence (e.g., C-SR invite 405, C-SR response 410, C-SR sync 415), negotiation for current transmission or future transmissions (such as for a next transmission) may be allowed. Negotiations between the APs 102 may be for parameters, such as type of C-SR, PPDU length, PPDU duration, bandwidth and punctured channel information, GI+LTF size, generation-specific SIG MCS (such as UHR-SIG MCS if one PPDU in C-SR transmission uses a UHR MU PPDU, or EHT-SIG MCS if one PPDU in C-SR transmission uses an EHT MU PPDU), a quantity of generation-specific SIG symbols (such as a quantity of UHR-SIG symbols if one PPDU in C-SR transmission uses a UHR MU PPDU, or a quantity of EHT-SIG symbols if one PPDU in C-SR transmission uses an EHT MU PPDU), or any combination thereof, which may occur in any of the three frames (e.g., bandwidth at the shared AP 102 may be indicated in the C-SR response 410, punctured channel information at the shared AP 102 may be indicated in the C-SR response 410). In a one-frame sequence (e.g., C-SR sync 415), no negotiation may be allowed. In this case, if the shared AP accepts the C-SR invite, it may start the C-SR transmission SIFS after the Sync frame; otherwise, it doesn't transmit. In some cases, negotiation may be enabled or disabled. In some examples, negotiation may be disabled or may not be allowed. For example, no negotiation may occur during an information exchange associated with a C-SR procedure. In other examples, negotiation may be enabled or may be allowed (e.g., always allowed). In other examples, an indication of whether negotiation is enabled may be transmitted in the C-SR invite 405. For example, 1 bit may indicate whether negotiation is allowed or whether negotiation is enabled or disabled. Additionally, or alternatively, a bitmap in the C-SR invite 405 may be used to indicate information about the C-SR negotiation. For example, negotiation may be allowed between APs 102 for specific aspects of the information exchange. The bitmap may indicate for which aspects negotiation may be allowed. For example, the bitmap may include 1 bit indicating whether negotiation is allowed for a type of C-SR, 1 or 2 bits for bandwidth and punctured channel information, 1 bit for length, 1 bit for a GI+LTF size, 1 to 2 bits for generation-specific SIG MCS (such as UHR-SIG MCS or EHT-SIG MCS) and a quantity of generation-specific SIG symbols (such as a quantity of UHR-SIG symbols or a quantity of EHT-SIG symbols), or any combination thereof.

Additionally, or alternatively, negotiation may be implemented for a specific transmission. That is, the APs 102 may receive some information or may determine some information about when negotiation may be effective or enabled. In some cases, the APs 102 may be pre-configured or configured with when to implement negotiation. In some examples, the negotiation may apply to a current transmission. In other examples, the current transmission may not be negotiable, and the negotiation may be for the next transmission. In some cases, the sharing AP 102 may indicate whether the negotiation may be effective for the current transmission or a next transmission in the C-SR invite 405. For example, one bit in the C-SR invite 405 may indicate that the negotiation is for the current transmission, or that the negotiation is for the next transmission. In some cases, the indication of whether the negotiation may be effective for the current transmission or a next transmission may be included in the C-SR response 410. For example, an information type set to “acceptance” may indicate negotiation for the current transmission (e.g., which negotiation details in other signaling). An information type set to “rejection” may indicate negotiation for the next transmission (e.g., with negotiation details in other signaling). In some implementations, the three-frame sequence may include some parameters for negotiation or for informative purposes. A sharing AP 102-a (e.g., initiating AP 102-a) may include one or more parameters in the C-SR invite 405. For example, the C-SR invite 405 may include (e.g., advertise) a PHY version identifier of a first PPDU that the sharing AP 102-a may plan or intend to transmit during the C-SR procedure (e.g., EHT, UHR). Additionally, or alternatively, the C-SR invite 405 may include a threshold transmit power (e.g., maximum power limit) for transmission of a second PPDU from a shared AP 102-b (e.g., responding AP 102-b) during the C-SR procedure. For example, the sharing AP 102-a may indicate a maximum transmit power for the shared AP 102-b to limit interference between transmissions from the APs 102 during the C-SR procedure. In some cases, the threshold transmit power may indicate, to the shared AP 102-b, which STAs may be possible candidates for C-SR transmission within the BSS of the shared AP 102-b. For example, the shared AP 102-b may choose a STA based on the threshold transmit power, as the shared AP 102-b may be able to reach some STAs with a transmit power below the threshold but may not be able to reach other STAs. In some examples, the threshold transmit power may be indicated as a transmit power limit per frequency (e.g., transmit power limit per 20 MHz). The threshold transmit power per frequency may enable more flexibility for the shared AP 102-b to determine a transmit power for a C-SR transmission.

Additionally, or alternatively, the C-SR invite 405 may include an indication of a bandwidth for the transmission of the first PPDU, punctured channel information for the first PPDU, or both. In some cases, the bandwidth, punctured channel information, or both may be considered baseline information. Additionally, or alternatively, the C-SR invite 405 may include an indication of an L-SIG length for the first PPDU and the second PPDU (e.g., the first PPDU and second PPDU may have the same L-SIG length). In some examples, the L-SIG length may be indicated as a quantity of data symbols for the L-SIG. Additionally, or alternatively, the C-SR invite 405 may include the GI+LTF combination that the sharing AP 102-a may use for transmission of the first PPDU. In some examples, indicating the GI+LTF combination may increase accuracy of channel estimation and phase tracking. Additionally, or alternatively, the C-SR invite 405 may include the transmit power the sharing AP 102-a may use for the transmission of the first PPDU. In some cases, the shared AP 102-b may choose a STA for transmission of the second PPDU, an MCS for transmission of the second PPDU, another parameter, or any combination thereof based on the indication of the transmit power for the first PPDU. In some examples, the transmit power may be indicated as a transmit power per frequency (e.g., per-20 MHz transmit power indication).

In some implementations, the shared AP 102-b may include one or more parameters in the C-SR response 410, which may be based on parameters included in the C-SR invite 405. For example, the C-SR response 410 may include a PHY version identifier of the second PPDU that the shared AP 102-a may plan or intend to transmit during the C-SR procedure. Additionally, or alternatively, the C-SR response 410 may include an indication of a transmit power for the second PPDU. The transmit power for the second PPDU indicated in the C-SR response 410 may be less than the threshold transmit power indicated in the C-SR invite 405. In some examples, the transmit power may be less than the threshold transmit power indicated in the C-SR invite 405, which may indicate less interference from the second PPDU on the transmission of the first PPDU. The sharing AP 102-a may adjust one or more parameters based on the transmit power being different from the threshold transmit power. In some examples, the transmit power may be indicated as a transmit power per frequency (e.g., per-20 MHz transmit power indication). Additionally, or alternatively, the C-SR response 410 may include the GI+LTF combination that the shared AP 102-b may use for transmission of the second PPDU, which may be different from the GI+LTF indicated in the C-SR invite 405 for transmission of the first PPDU. In some examples, the GI+LTF combination that the shared AP 102-b may use for transmission of the second PPDU may use an LTF symbol duration (without the GI) different from the LTF symbol duration in the GI+LTF indicated in the C-SR invite 405 for transmission of the first PPDU. Additionally, or alternatively, the C-SR response 410 may include an indication of a bandwidth for the transmission of the second PPDU, punctured channel information for the second PPDU, or both. In some examples, the non-punctured channels indicated jointly by the bandwidth and the punctured channel information in the C-SR response 410 for the second PPDU may enable C-SR transmission from the shared AP 102-b to be in a subset of non-punctured channels indicated jointly by the bandwidth and punctured channel information in the C-SR invite 405 for the first PPDU. In some examples, the C-SR transmission from the shared AP 102-b (i.e., the second PPDU) may be using a reduced bandwidth compared to the bandwidth of the C-SR transmission from the sharing AP 102-a (e.g., the first PPDU). For example, the sharing AP 102-a may transmit a first PPDU of a 320 MHz PPDU, while the shared AP 102-b may transmit a second PPDU of a 160 MHz PPDU. Additionally, or alternatively, the C-SR response 410 may indicate a requested L-SIG length, or candidate L-SIG length. For example, the shared AP 102-b may request an L-SIG length different from the L-SIG length indicated in the C-SR invite 405. For example, the requested L-SIG length may be longer than the L-SIG length indicated in the C_SR invite 405. In some examples, the L-SIG length may be indicated as a quantity of data symbols for the requested L-SIG.

In some implementations, the sharing AP 102-a may include one or more parameters in the C-SR sync 410, which may be based on parameters included in the C-SR response 410. For example, the contents of the C-SR sync 415 may be based on the type of C-SR procedure (e.g., Type I, Type II). In some cases, for a Type II C-SR procedure, the C-SR sync 415 may include additional PHY parameters related to the common U-SIG (e.g., PHY Version Identifier, TXOP, bandwidth, punctured channel information, BSS color of the sharing AP, BSS color of the shared AP, UHR-SIG MCS, Quantity of UHR-SIG Symbols). A sync 415 for a Type I C-SR procedure may, in some examples, include fewer PHY parameters. In some cases, the C-SR sync 415 may include a final L-SIG length or final quantity of symbols for an L-SIG. For example, if the shared AP 102-b negotiates the L-SIG length via the C-SR response 410, the C-SR sync 415 may indicate the final L-SIG length (e.g., the requested L-SIG length, the L-SIG length in the C-SR invite 405, or a different L-SIG length).

In some cases, one or more parameters for the C-SR procedure may be predefined, preconfigured (e.g., standardized), or signaled as fixed values. For example, an EHT-SIG MCS, a UHR-SIG MCS, or both may be fixed values (e.g., MCS0). Fixing the EHT-SIG MCS, UHR-SIG MCS, or both may increase communication reliability despite interference for the C-SR procedure. Additionally, or alternatively, a quantity of symbols of the EHT-SIG, UHR-SIG, or both may be predefined, preconfigured, or signaled as fixed values. The fixed value may be a minimum quantity of data symbols to convey the information. For example, the EHT-SIG, UHR-SIG, or both may not include padding (e.g., extra SIG symbols). For an EHT-SIG, a UHR-SIG, or both with an MCS of MCS0, the fixed value may be two symbols for a single user case.

In some cases, an LTF duration for a first PPDU transmitted by the sharing AP 102-a may be different from an LTF duration for a second PPDU transmitted by the shared AP 102-b, which may increase channel smoothing and phase tracking. In some examples, using different LTF durations may make a same L-SIG length difficult to signal. For example, the first PPDU may use a 4x+3.2 μs cyclic prefix (CP) as a GI, while the second PPDU may use a 2x+1.6 μs CP as a GI, which may result in a delay between the end times of the PPDUs, despite using a same quantity of data symbols (e.g., 8 us time difference). In some cases, the shared AP 102-b may adjust the packet size of the second PPDU such that the first PPDU and the second PPDU may end at a same time or within a threshold duration. For example, a C-SR transmission may implement a fixed nominal packet extension (PE) (e.g., 16 μs, 20 μs, or the like). The sharing AP 102-a may indicate the L-SIG length for a C-SR transmission (e.g., via the C-SR invite 405, the C-SR sync 415). Based on the L-SIG length, the shared AP 102-b may select (e.g., choose, determine) a packet size (e.g., quantity of data OFDM symbols and a pre-FEC padding factor) to adjust the pre-FEC padding boundary, the data, and the PE field durations for the second PPDU. This may enable the shared AP 102-b to match the overall PPDU duration for the second PPDU in the shared BSS with the L-SIG length indicated by the sharing AP 102-a. The gap between end times of the first PPDU and the second PPDU may be within the threshold duration (e.g., 4 us), which may allow the same L-SIG length field to be valid for both BSSs (e.g., the granularity of the L-SIG field may be 4 us).

In some cases, a type of C-SR procedure may be negotiated between APs 102. A sharing AP 102 may not be affected if a shared AP 102 may transmit an EHT MU PPPDU or a UHR MU PPDU in the C-SR transmission. That is, no negotiation may be needed between the APs 102, and the sharing AP may indicate the control information (e.g., MAP scheme, information type (‘Invite’/‘Sync’) and Sync-Reference indication), L-SIG information (Length field value), U-SIG information (bandwidth, punctured channel information, generation-specific SIG MCS (such as UHR-SIG MCS), a quantity of generation-specific SIG symbols (such as Quantity of UHR-SIG Symbols)) and other information (e.g., GI+LTF Size, quantity of generation-specific LTF Symbols (such as quantity of UHR-LTF Symbols)), in a C-SR invite 405 (e.g., 3-frame sequence) or a C-SR sync 415 (e.g., 1-frame sequence or 3-frame sequence). In some cases, the sharing AP 102 may indicate ‘Type-I C-SR’ or ‘Type-II C-SR’ in the MAP scheme subfield. The shared AP 102 may follow the indication of the type of C-SR procedure, and, in some examples, may accept or reject the indication of the type of C-SR procedure. Accepting or rejecting the indication may be performed without sending an indication (e.g., 1-frame sequence), or by indicating ‘Acceptance’ or ‘Rejection’ in the C-SR response 410 (e.g., 3-frame sequence) In some cases, the MAP scheme subfield may only indicate the C-SR procedure, without an indication of a type of C-SR procedure (e.g., Type 1, Type 2). The sharing AP 102 may indicate ‘C-SR’, and may further indicate ‘Type-I’ (e.g., without common U-SIG) or Type-II (e.g., with common U-SIG) in a frame (e.g., with an extra bit) or the ‘PHY Version Identifier of the PPDU in the Sharing BSS’ (3 bits, similar to the PHY Version Identifier subfield, e.g., value 0 for EHT, value 1 for UHR, etc.). The shared AP 102 may indicate the ‘PHY Version Identifier of the PPDU in the Shared BSS’ (3 bits, similar to the PHY Version Identifier subfield (e.g., value 0 for EHT, value 1 for UHR, and the like)) in the C-SR response 410 (e.g., 3-frame sequence).

In some cases, the type of C-SR indication (e.g., as a state in the MAP scheme subfield, or using a 1-bit field if the MAP Scheme subfield is set to ‘C-SR’) may be included in the C-SR invite 405. If the sharing AP 102 schedules an EHT user for an EHT MU PPDU, the sharing AP 102 may indicate Type-I C-SR in the C-SR invite 405. If the sharing AP 102 schedules a UHR user for a UHR MU PPDU, the sharing AP 102 may choose or select between Type-I and Type-II C-SR and may indicate the C-SR type in the C-SR invite 405 accordingly. Additionally, or alternatively, the sharing AP 102 may indicate a Type-II C-SR in the C-SR invite 405 (e.g., may always be Type-II C-SR). In some examples, negotiation of the type of C-SR may be allowed. The shared AP 102 may agree with the indication of the type of C-SR from the sharing AP 102 (e.g., form the C-SR invite 405) and may indicate the same type of C-SR in the C-SR response 410. Additionally, or alternatively, the shared AP 102 may indicate a different type of C-SR in the C-SR response 410. For example, the sharing AP 102 may indicate a Type-II C-SR in the C-SR invite 405, while the shared AP 102 may indicate Type-I C-SR in the C-SR response 410 (e.g., the shared AP 102 may prefer Type-I C-SR, may not want to share a common U-SIG because some information may be different). The shared AP 102 may negotiate the type of C-SR for multiple reasons. For example, the shared AP 102 may send an EHT MU PPDU to an EHT user. Additionally, or alternatively, the shared AP 102 may want to send a PPDU with a reduced bandwidth or the same bandwidth but with a different punctured subchannels. Additionally, or alternatively, the shared AP 102 may want to use different generation-specific SIG MCS (such as UHR-SIG MCS), different quantities of generation-specific SIG symbols (such as quantities of UHR-SIG symbols), or both. In some examples, the sharing AP 102 may accept the request of the shared AP 102. For example, the sharing AP 102 may indicate a same type of C-SR in the C-SR sync 415, if the sharing AP 102 accepts the negotiation. In other examples, the sharing AP 102 may reject the request of the shared AP 102. For example, the sharing AP 102 may indicate a ‘rejection’ (e.g., in the Information Type subfield) to reject the TXOP sharing in C-SR transmission (e.g., no C-SR transmission).

In some cases, a length of a PPDU (e.g., PPDU duration) may be negotiated between APs 102. For example, the sharing AP 102 may send a 12-bit length field value in the C-SR invite 405. If negotiation is allowed, the shared AP 102 may indicate a proposed PPDU length or duration in the C-SR response 410. The proposed PPDU length or duration may be a 12-bit Proposed Length field, a 9-bit Proposed Number of Data OFDM Symbols field, a multi-bit Proposed PPDU Duration field (in a time unit, e.g., 100 us), or any combination thereof. The sharing AP 102 may send a final 12-bit length field value in the C-SR sync 415. In some examples, the negotiation may be for the current transmission, and the final value may be the proposed value by the shared AP 102 if the sharing AP 102 accepts it. If the sharing AP 102 rejects the proposed value, it may indicate a ‘rejection’ (e.g., in the Information Type subfield) to reject the TXOP sharing in C-SR or CoBF transmission, or alternatively, set the final value to be the same as the original value of the sharing AP 102, and the C-SR or CoBF transmission may still be scheduled. In some examples, the negotiation may be for the next transmission. The final value may be the same as the original value of the sharing AP 102. The sharing AP 102 may indicate ‘acceptance’ or ‘rejection’ in a 1-bit Length Of Next Transmission Negotiated field. In the next transmission, the sharing AP 102 may use and indicate a length value same as or slightly greater than the proposed one by the shared AP 102.

In some cases, other fields or parameters may be negotiated between APs 102. For example, the sharing AP 102 may indicate values for one or more fields, such as GI+LTF Size, generation-specific SIG MCS (such as UHR-SIG MCS or EHT-SIG MCS), Quantity of generation-specific SIG symbols (such as Quantity of UHR-SIG Symbols or Quantity of EHT-SIG Symbols), or any combination thereof, (e.g., for the PHY preamble in the PPDU sent from the sharing AP 102 in the C-SR transmission) in the C-SR invite 405. The shared AP 102 may indicate values for the one or more fields (e.g., for the PHY preamble in the PPDU sent from the shared AP 102 in the C-SR transmission) in the C-SR response 410. If negotiation is allowed, the negotiation may be for the current transmission and may also be used for the next C-SR transmission. In some examples, if Type-II C-SR is indicated in both the C-SR invite 405 (e.g., by the sharing AP 102) and the C-SR response 410 (e.g., by the shared AP), the values in the generation-specific SIG MCS (such as UHR-SIG MCS or EHT-SIG MCS) and Quantity of generation-specific SIG Symbols (such as Quantity of UHR-SIG Symbols or Quantity of EHT-SIG Symbols) fields may be the same in both the C-SR invite 405 and the C-SR response 410. If values in at least one of the generation-specific SIG MCS (such as UHR-SIG MCS or EHT-SIG MCS) and Quantity of generation-specific SIG Symbols (such as Quantity of UHR-SIG Symbols or Quantity of EHT-SIG Symbols) fields are different from the ones from the sharing AP 102, this may indicate Type-I C-SR. In some cases, in the C-SR sync 415, the sharing AP 102 may indicate ‘Sync’ in the Information Type subfield if a negotiation or proposed value form the shared AP 102 is accepted. If the sharing AP 102 rejects the negotiation or proposed value, it may indicate a ‘rejection’ (e.g., in the Information Type subfield) to reject the TXOP sharing in C-SR transmission (e.g., no C-SR transmission).

In some implementations, the CoBF or C-SR invite 405, response 410, or sync 415 may be frames that may use a trigger frame (e.g., a UHR variant trigger frame, BSRP trigger frame (e.g., a STA-specific BSRP trigger frame (individually addressed to a single AP 102) that solicits PPDU(s) not using TB PPDU format(s) (e.g., HE/EHT/UHR TB PPDU formats)), MU-RTS trigger frame, MU-RTS TXS trigger frame), or a new trigger type frame. For example, a PHY version identifier in the special user information field in the trigger frame may be set to a value to indicate UHR (e.g., 1). Additionally, or alternatively, a common information field (including a trigger-dependent common info field where the field size and structure may depend on the trigger type) or special user information field (including a trigger-dependent user info field where the field size and structure may depend on the trigger type) may include a MAP subfield. The MAP subfield may include 1 bit (e.g., to indicate MAP or no MAP), or two bits (e.g., indicative of {no MAP, CoBF, C-SR}, or {no MAP, MAP Invite, MAP Response, MAP Trigger/Sync}), or three bits (e.g., indicative of {no MAP, CoBF Invite, CoBF Response, CoBF Trigger/Sync, C-SR Invite, C-SR Response, C-SR Trigger/Sync}). Any state except “No MAP” may indicate that user information fields (including a trigger-dependent user info field where the field size and structure may depend on the trigger type) convey information for other APs 102. UHR non-AP STAs may terminate processing of the sync 415 (e.g., the trigger frame) if any state except “No MAP” is indicated, while high efficiency and extremely high throughput (HE/EHT) non-AP STAs may keep processing the trigger frame. Additionally, or alternatively, the trigger frame (e.g., a UHR variant trigger frame) may include one or more user information fields (e.g., UHR variant AP information fields), which may follow the special user information field, and may have a field (e.g., AID12) that may be set to the AP ID of another AP 102, and may carry information for the other AP 102. For example, the AP ID may be chosen from a range (e.g., 2008-4094, in particular 2008-2044 and 2046-4094) that may not be used to indicate any non-AP STAs. In some cases, in each UHR variant AP information field, a first set of bits (e.g., B0-B11) may be the field (e.g., AID12 field) set to an AP ID, one bit (e.g., B39) may be a reserved field and may be set to 1, and there may be 28 bits (e.g., B12-B39) or 27 bits (e.g., B12-B38) for carrying information for the APs 102. Unused bits in each AP information field may be reserved bits. In some examples, bits after the reserved bits (e.g., after B39) may be trigger dependent user information. For example, a first set of bits (e.g., B0-B11) may be the field (e.g., AID12 field) set to an AP ID or a special value (e.g., 2009), yielding 28 available bits. A second set of bits (e.g., B12-B22) may be used for a STA ID, a next bit (e.g., B23) may be a BSS color indication, a third set of bits (e.g., B24-B28) may be an MCS, a next bit (e.g., B29) may be a 2×LDPC indication, fourth set of bits (e.g., B30-B33) may be a Nss or spatial configuration indication (e.g., B30 may indicate Nss of 1 or 2 spatial streams and B31-B33 may be reserved in the Invite 405, and B30-B33 may indicate the spatial configuration in the Sync 415), and a fifth set of bits (e.g., B34-B39) may be a BSS color or may be otherwise reserved bits.

In some cases, a first set of bits (e.g., B0-B11) may be interpreted as the AID12 field. A range of values (e.g., [1, 2006]) may be used for non-AP STAs. The first set of bits (e.g., B0-B11) may be assigned within a range of unused or reserved values (e.g., [2048, 4095], or [2049, 4054]) by setting the MSB (e.g., B11) to a value (e.g., 1) as a disambiguity bit. In this way, the set of bits (e.g., B0-B10) may be available bits without ambiguity (e.g., the set of bits (e.g., B0-B10) may be assigned any value without making a non-AP STA or AP wrongly identify the AID12 field value as its AID value). In some examples, a value of 4095 may indicate a start of padding for HE/EHT frames. A second set of bits (e.g., B12-B39) may be reserved, yielding a total of 39 available bits (e.g., B0-B11 and B12-B39). Bits after the second set of bits (e.g., after B39) may be trigger dependent user information. For example, the first set of bits (e.g., B0-B10) may be a STA ID, while a next bit (e.g., B11) may be a disambiguity bit set to a value (e.g., 1), which may take the place of an AID12 field (e.g., unused range [2049, 4054]), which may yield remaining 28 available bits (after the first 11 bits are used for a STA ID). The remaining 28 available bits may be used for a BSS color indication (e.g., reuse 1-bit “UL FEC Coding Type”), MCS, 2×LDPC, and Spatial Configuration and Nss (e.g., total 5 bits to reuse “SS Allocation”), which may reuse the field structure in the original UHR variant user info field for these fields. The frame may or may not include RU allocation information. For example, a frame without RU allocation information may include a first set of bits (e.g., B0-B10) for a STA ID, a next bit (e.g., B11) for a disambiguity indication (e.g., set to 1), a second set of bits (e.g., B12-B19) that may be reserved, a next bit (e.g., B20) for a BSS color indication, a third set of bits (e.g., B21-B25) as a MCS indication, a next bit (e.g., B26) for a 2×LDPC indication, a fourth set of bits (e.g., B27-B30) as a spatial configuration indication, a next bit (e.g., B31) as an Nss indication, a fifth set of bits (e.g., B32-B37) for a BSS color indication, or as reserved bits, and a sixth set of bits (e.g., B38-B39) that may be reserved. A frame with RU allocation information may be the same as without but may include the RU allocation in the second set of bits (e.g., B12-B19), and may use a final bit (e.g., B39) for a PS160 bit (e.g., 9 bits for RU allocation information).

In some cases, a user field size may be flexible. For example, a first set of bits (e.g., B0-B11) may be the AID12, which may be set to a value (e.g., 4095, 4094 in UHR) to indicate the start of padding, which may allow a user field of K-octets. For example, a second set of bits may be defined by K and may be reserved (e.g., B12-B(8*K−1)), which may be a quantity of 8*K−12 reserved bits. Bits after the second set of bits may be trigger dependent user information.

In some cases, a BSRP trigger frame (e.g., BSRP G13 trigger frame) may be individually addressed to a single STA, and may include an indication to set the GI and HE/UHR-LTF Size field in the UHR variant common information field to a value (e.g., 3) in order to indicate that the solicited PPDU may not use TB PPDU format(s) (e.g., HE/EHT/UHR TB PPDU formats) and may be a non-HT PPDU or non-HT duplicate PPDU. In some examples, the invite 405 may be a BSRP G13 trigger frame (e.g., a

BSRP trigger frame variant that may solicit a response in non-HT (duplicate) PPDU format). When a BSRP GI3 trigger variant is used for the invite 405, the frame length of the response 410 may be equal to or shorter than the value of the “Uplink Length” field in the BSRP GI3 Trigger frame. This may be a generic rule for all BSRP GI3 Trigger frames, or may be a rule exclusive for CoBF, C-SR, or other MAP schemes.

In some cases, padding control may be implemented for the invite 405, response 410, and sync 415 frames. For example, padding may be used for the invite 405, response 410, and sync 415 frames to ensure the AP 102 that receives the frame may have time to perform calculations (e.g., additional 100-150 us, 200 us) and to respond with a next PPDU at a given time. The sharing AP 102 may implement padding in the invite 405 such that the shared AP 102 may have enough time to perform STA and per-user Nss selection and calculate per-user information (e.g., MCS, 2×LDPC), and the like. Padding may be indicated or implemented through the Padding field in the invite 405 (e.g., if the invite 405 is a Trigger frame, or through padding after the invite 405 if the invite 405 is a MPDU (e.g., use the pre-EOF padding or a pre-defined sequence or a combination thereof)). The sharing AP 102 may also implement padding in the sync 415 so that the shared AP 102 may have enough time to perform rate matching and calculate the per-user packet size, and the like. Padding for the sync 415 may be implemented or indicated in the same way as in for the invite 405. In some examples, the response 410 may also implement padding such that the sharing AP 102 may perform rate matching, calculate per-user information (e.g., MCS, 2×LDPC), further perform STA down-selection, and the like. The padding in the response 410 may be controlled by the sharing AP 102, the shared AP 102, or both APs 102. For example, the sharing AP 102 may indicate a large enough “Uplink Length” field (or “Length” field) value in the invite 405 for the PPDU that carriers the response 410 to follow. The sharing AP 102 may indicate a low and reliable MCS in the invite 405 for the PPDU that carries the response 410 to follow, if the response 410 is carried in a TB PPDU. Additionally, or alternatively, there may be a rule, configuration, or pre-configuration (e.g., standardization) that may define a fixed low and reliable MCS (e.g., MCS0) for the response 410. The sharing AP 102 may indicate in the invite 405 an amount of padding (e.g., in the unit of time (50/100/150/200 us)) may be needed in the response 410. Additionally, or alternatively, the shared AP 102 may control the length, as for the BSRP G13 trigger variants for the CoBF invite 405.

In some cases, as described herein, the invite 405 and sync 415 may be examples of BSRP G13 trigger frames or MU-RTS TXS frames, and there may be some unified design between the invite 405 and the sync 415. For example, both BSRP G13 trigger frames and MU-RTS TXS trigger frames may include a special user information field (e.g., AID12 set to 2007, PHY version identifier set to 1 for UHR) (including a trigger-dependent user info field where the field size and structure may depend on the trigger type). For a BSRP G13 trigger frame, the GI and HE/UHR-LTF type subfield may be set to a value (e.g., 3). For the MU-RTS TXS trigger frame, the TXS mode subfield may be set to a value (e.g., 3) to indicate the MAP scheme. In some examples, some bits (e.g., B22, B26, B53, and B63) in the common information field of the trigger frames may be reserved or left for MAC features, while some existing fields in the trigger frames may be leveraged or reused to carry PHY information. The control information and non-user specific PHY information may be indicated in the common information field (including a trigger-dependent common info field where the field size and structure may depend on the trigger type) and special user information field (e.g., with AID12 field set to 2007) (including a trigger-dependent user info field where the field size and structure may depend on the trigger type). With trivial re-organization of fields, the control information may be indicated in either the common information field (including the trigger-dependent user info field) or special user information field (e.g., with AID12 field set to 2007) (including the trigger-dependent user info field), the non-user specific PHY information related to L-SIG (e.g., Minimum Quantity of Data OFDM Symbols, Maximum Quantity of Data OFDM Symbols, Length) and information related to U-SIG (e.g., Punctured channel information, TXOP, BSS Color 1, BSS Color 2, Quantity of UHR-SIG Symbols) may be indicated in the common information field (including the trigger-dependent common info field), while the non-user specific information related to the common field of UHR-SIG (e.g., GI+LTF Size, Maximum Total Quantity of Spatial Streams Allowed for Shared AP, Quantity of UHR-LTF Symbols, LDPC Extra Symbol Segment, Pre-FEC Padding Factor, PE Disambiguity, Quantity of CoBF Users in sharing BSS, Quantity of CoBF Users in Shared BSS, Quantity of CoBF Users) may be indicated in the special user information field (e.g., with AID12 field set to 2007) (including the trigger-dependent user info field). Information for each user may be indicated in one CoBF user information field (including the trigger-dependent user info field), and, in some cases, each BSS color may be indicated in the CoBF user field or fields of an associated user or users. This may yield a size of the user field based on the quantity of users, N (e.g., a minimum size (from the beginning of the common info field to the end of user field list and before Padding field) of 8+5+5N octets). Table 8 may provide a broad example of a trigger format for a MAP scheme, where the user information fields (1 to N) may be the CoBF user information fields (including the trigger-dependent user info field).

TABLE 8
Trigger Frame Format for MAP

| | | | | | | Special User | | | | | |
|---|---|---|---|---|---|---|---|---|---|---|---|
| | | | | | | Information | User | | User | | |
| Frame | Frame | | | | Common | Field (PHY | Information | | Information | | |
| Parameter | Control | Duration | RA | TA | Information | Version ID = 1) | Field 1 | . . . | Field N | Padding | FCS |
| Quantity of | 2 | 2 | 6 | 6 | 8 | 5 | 5 | 5 | 5 | Variable | 4 |
| Octets | | | | | | | | | | | |

The CoBF invite 405, response 410, and sync 415 may use the AP information field to carry the relevant information for the CoBF procedure. For example, the CoBF invite 405, may include a first AP information field (e.g., up to 25 or 27 bits), which may include a PHY Version Identifier (e.g., 3 bits), a bandwidth of the PPDU sent by the initiating AP 102-a (3 bits), uplink or downlink indication of the initiating AP 102-a (e.g., 1 bit), the BSS color of the responding AP (e.g., 6 bits), the shared TXOP 425 duration (e.g., 7 bits), a PPDU Type And Compression Mode (e.g., 2 bits), a CoBF/C-SR Indication (e.g., 1 bit), an assigned bandwidth of the responding AP 102-b (e.g., 2 bits), and, additionally, or alternatively, an information type or MAP subfield (e.g., 2 bits, indicate the invite 405, the response 410, or the sync 415, when this may not be indicated in the common information field or the special user information field and set to “MAP Invite”, 3 bits, set to “CoBF Invite”). The CoBF invite 405 may include a second AP information field (e.g., up to 27 bits), which may include punctured channel information (e.g., 5 bits), an indication of a UHR-SIG MCS (e.g., 2 bits), a GI+LTF Size (e.g., 2 bits), a quantity of CoBF users served by the initiating AP 102-a (e.g., 2 bits), a length in the L-SIG (e.g., 12 bits), an LDPC extra symbol segment (e.g., 1 bit), a pre-FEC padding factor (e.g., 2 bits), a PE disambiguity (e.g., 1 bit), or any combination thereof. The CoBF Invite 405 may include at least one AP information field after the second AP information field. Each AP information field (e.g., 19 bits) after the first two (e.g., starting with the third AP information field) may be about information of one user field, which may include a STA ID (e.g., 11 bits), a MCS (e.g., 5 bits), an Nss indication (e.g., 2 bits), an indication of whether 2×LDPC may be used (e.g., 1 bit), or any combination thereof.

For example, the invite 405 and sync 415 frames may be unified and reuse existing fields, as in Tables 9-11.

TABLE 9
Example of Common Information Field for Invite 405 and Sync 415
Using BSRP G13 Trigger Frames or MU-RTS TXS Trigger Frames

| Bits | B0-B3 | B4-B15 | B16 | B17 | B18-B19 | B20-B21 | B22 | B23-B25 |
|---|---|---|---|---|---|---|---|---|
| Invite | Trigger | Uplink | More | CS | Uplink | GI and | Reserved | Maximum |
| 405 | Type | Length | Trigger | Required | Bandwidth | HE/UHR- | | Total Nss |
| | | | Frame | | | LTF | | for Shared |
| | | | | | | Type/TXS | | AP 102 |
| | | | | | | Mode (Set | | and Sync- |
| | | | | | | to 3) | | Reference |
| | | | | | | | | Indication |
| Sync | | Length | | | | | | Quantity |
| 415 | | | | | | | | of UHR- |
| | | | | | | | | LTF Symbols |

| Bits | B26 | B27 | B28-B33 | B34-B35 | B36 | B37-B43 | B44-B48 | B49-B51 | B42-B53 |
|---|---|---|---|---|---|---|---|---|---|
| Invite | Reserved | | Shared | | | TXOP | Punctured | Quantity | Reserved |
| 405 | | | AP 102 | | | | Channel | of CoBF | |
| Sync | | LDPC | Transmit | Pre-FEC | PE | | Information | Users | |
| 415 | | Extra | Power | Padding | Disambiguity | | | | |
| | | Symbol | | Factor | | | | | |
| | | Segment | | | | | | | |

| Bits | B54 | B55 | B56-B58 | B59 | B60 | B61 | B62 | B63 |
|---|---|---|---|---|---|---|---|---|
| Invite | HE/UHR | Special User | MAP | Reserved | IFCS | Protection | Key ID | Reserved |
| 405 | P160 | Information | Scheme | | Present | Indication | | |
| Sync | | Field Flag | | | Flag | | | |
| 415 | | | | | | | | |

TABLE 10
Example of Special User Information Field for Invite 405 and Sync
415 Using BSRP G13 Trigger Frames or MU-RTS TXS Trigger Frames

| Bits | B0-B11 | B12-B14 | B15-B16 | B17-B18 | B19-B36 | B37 | B38-B39 |
|---|---|---|---|---|---|---|---|
| Invite 405 | AID | PHY | Uplink | GI + LTF | Minimum | NPCA | Information |
| | (set to | Version | Bandwidth | Size | Quantity | Primary | Type |
| | 2007) | Identifier | Extension | | of Data | Indication | |
| | | | | | OFDM | | |
| | | | | | Symbols | | |
| | | | | | and | | |
| | | | | | Maximum | | |
| | | | | | Quantity | | |
| | | | | | of Data | | |
| | | | | | OFDM | | |
| | | | | | Symbols | | |
| Sync 415 | | | | | BSS Color | | |
| | | | | | 1 and BSS | | |
| | | | | | Color 2 | | |
| | | | | | and | | |
| | | | | | Quantity | | |
| | | | | | of UHR- | | |
| | | | | | SIG | | |
| | | | | | Symbols | | |

TABLE 11
Example of CoBF User Information Field for Invite 405 and Synce
415 Using BSRP G13 Trigger Frames or MU-RTS TXS Trigger Frames

| Bits | B0-B11 | B12-B22 | B23 | B24-B28 | B29 | B30-B33 | B34-B39 |
|---|---|---|---|---|---|---|---|
| Invite 405 | AID12 | STA ID | BSS Color | | | Nss | Reserved |
| Sync 415 | (set to | | Indication | MCS | 2xLDPC | Spatial | |
| | Shared | | | | | Configuration | |
| | AP ID or | | | | | | |
| | a special | | | | | | |
| | value, | | | | | | |
| | e.g., 2009) | | | | | | |

Table 9 shows a unified design of the common Information field for Invite 405 and Sync 415. For bits B23-B25, for the invite 405, the first two bits may be used to indicate the maximum total Nss for the shared AP 102, and the third bit may be used as a Sync-Reference indication. For the sync 415, all three bits may be used to indicate the quantity of UHR-LTF symbols. Table 10 shows a unified design of the special user information field for Invite 405 and Sync 415. For bits B19-B36, for the invite 405, the first nine bits may be for the minimum quantity of data OFDM symbols, while the second nine bits may be for the maximum quantity of data OFDM symbols. For the sync 415, the first six bits may be for BSS color 1, the next 6 bits may be for BSS color 2, the next bit may be reserved, and the last five bits may be for the quantity of UHR-SIG symbols. Table 11 shows a unified design of the CoBF user information field for Invite 405 and Sync 415. For bits B30-B33, for the invite 405, the first bit may indicate the Nss, and the last three bits may be reserved. For the sync 415, all four bits may be used to indicate the spatial configuration.

Tables 12-14 may provide alternative design examples for the BSRP G13 trigger frame or MU-RTS TXS trigger frame, as exemplified in Tables 9-13.

TABLE 12
Example of Common Information Field for Invite 405 and Sync 415
Using BSRP G13 Trigger Frames or MU-RTS TXS Trigger Frames

| Bits | B0-B3 | B4-B15 | B16 | B17 | B18-B19 | B20-B21 | B22 | B23-B25 |
|---|---|---|---|---|---|---|---|---|
| Invite | Trigger | Uplink | More | CS | Uplink | GI and | Reserved | Maximum |
| 405 | Type | Length | Trigger | Required | Bandwidth | HE/UHR-LTF | | Total Nss |
| | | | Frame | | | Type/TXS | | for Shared |
| | | | | | | Mode (Set | | AP 102 |
| | | | | | | to 3) | | and Sync- |
| | | | | | | | | Ref |
| Sync | | Length | | | | | | Quantity |
| 415 | | | | | | | | of UHR- |
| | | | | | | | | LTF Symbols |

| Bits | B26 | B27 | B28-B33 | B34-B35 | B36 | B37-B43 | B44-B48 | B49-B51 | B42-B53 |
|---|---|---|---|---|---|---|---|---|---|
| Invite | Reserved | | Shared | | | TXOP | Punctured | Quantity | Reserved |
| 405 | | | AP 102 | | | | Channel | of CoBF | |
| Sync | | LDPC | Transmit | Pre- | PE | | Information | Users | |
| 415 | | Extra | Power | FEC | Disambiguity | | | | |
| | | Symbol | | Padding | | | | | |
| | | Segment | | Factor | | | | | |

| Bits | B54 | B55 | B56-B58 | B59 | B60 | B61 | B62 | B63 |
|---|---|---|---|---|---|---|---|---|
| Invite | HE/UHR | Special | MAP | Reserved | IFCS | Protection | Key ID | Reserved |
| 405 | P160 | User | Scheme | | Present | Indication | | |
| Sync | | Information | | | Flag | | | |
| 415 | | Field Flag | | | | | | |

TABLE 13
Example of Special User Information Field for Invite 405 and Sync
415 Using BSRP G13 Trigger Frames or MU-RTS TXS Trigger Frames

| Bits | B0-B11 | B12-B14 | B15-B16 | B17-B18 | B19-B36 | B37 | B38-B39 |
|---|---|---|---|---|---|---|---|
| Invite 405 | AID | PHY | Uplink | GI + LTF | Minimum | NPCA | Information |
| | (set to | Version | Bandwidth | Size | Quantity | Primary | Type |
| | 2007) | Identifier | Extension | | of Data | Indication | |
| | | | | | OFDM | | |
| | | | | | Symbols and | | |
| | | | | | Maximum | | |
| | | | | | Quantity | | |
| | | | | | of Data | | |
| | | | | | OFDM | | |
| | | | | | Symbols | | |
| Sync 415 | | | | | Shared AP | | |
| | | | | | ID and | | |
| | | | | | Quantity of | | |
| | | | | | UHR-SIG | | |
| | | | | | Symbols | | |

TABLE 14
Example of CoBF User Information Field for Invite 405 and Sync
415 Using BSRP G13 Trigger Frames or MU-RTS TXS Trigger Frames

| Bits | B0-B11 | B12-B22 | B23 | B24-B28 | B29 | B30-B33 | B34-B39 |
|---|---|---|---|---|---|---|---|
| Invite 405 | AID12 | STA ID | BSS Color | | | Nss | BSS Color |
| Sync 415 | (set to a | | Indication | MCS | 2xLDPC | Spatial | |
| | special | | | | | Configuration | |
| | value, | | | | | | |
| | e.g., 2009) | | | | | | |

Table 9 may be the same as Table 12, but may be combined with Tables 13 and 14 to include different signaling of information. Table 12, similar to Table 9, shows a unified design of the common information field for Invite 405 and Sync 415. In Table 12, bits B23-B25, for the invite 405, may include a first two bits to indicate the maximum total Nss for the shared AP 102 and a third bit as a Sync-Ref indication, while, for the sync 415, all three bits may be used to indicate the quantity of UHR-LTF symbols. Table 13, similar to Table 10, shows a unified design of the special user information field for Invite 405 and Sync 415. For bits B19-B36, for the invite 405, the first nine bits may be for the minimum quantity of data OFDM symbols, while the second nine bits may be for the maximum quantity of data OFDM symbols. For the sync 415, the first twelve bits may be for the shared AP 102 ID, the next bit may be reserved, and the last five bits may be for the quantity of UHR-SIG symbols. Table 14, similar to Table 11, shows a unified design of the CoBF user information field for Invite 405 and Sync. As in Table 11, for bits B30-B33 of Table 14, for the invite 405, the first bit may indicate the Nss, and the last three bits may be reserved. For the sync 415, all four bits may be used to indicate the spatial configuration.

In some implementations, a BSRP G13 trigger frame or MU-RTS TXS trigger frame may be used as a reject frame. For example, a reject frame may be sent instead of a sync 415 to reject CoBF or a MAP procedure. In some cases, the reject frame may only include a common information field and a special information field, which may be a total size of 8+5 octets, as in Table 15. In some examples, the ‘length’ field may be set to a value (e.g., 0), which may indicate that no response may be necessary, or the bit may be reserved, the shared AP 102 ID field may be in the common information field (including a trigger-dependent common info field where the field size and structure may depend on the trigger type) or special user information field (e.g., for the MU-RTS TXS trigger frame, which may be broadcast) (including a trigger-dependent user info field where the field size and structure may depend on the trigger type). That is, the reject frame may use the same bits in the special user information field as in the sync 415. In other cases, a user information field with an AID12 field set to the ID of the shared AP 102 may be included in the reject frame, and all other bits may be set to reserved, as in Table 16.

TABLE 15
Example of Common Information Field for a Reject Frame Using
BSRP G13 Trigger Frames or MU-RTS TXS Trigger Frames

| Bits | B0-B3 | B4-B15 | B16 | B17 | B18-B19 | B20-B21 | B22-B53 |
|---|---|---|---|---|---|---|---|
| Reject | Trigger | Length | More | CS | Uplink | GI and | Reserved |
| | Type | (set to 0) | Trigger | Required | Bandwidth | HE/UHR- | |
| | | or | Frame | | | Type/TXS | |
| | | Recerved | | | | Mode (Set | |
| | | | | | | to 3) | |

| Bits | B54 | B55 | B56-B58 | B59 | B60 | B61 | B62 | B63 |
|---|---|---|---|---|---|---|---|---|
| Reject | HE/UHR | Special | MAP | Reserved | IFCS | Protection | Key ID | Reserved |
| | P160 | User | Scheme | | Present | Indication | | |
| | | Information | | | Flag | | | |
| | | Field Flag | | | | | | |

TABLE 16
Example of Special User Information Field for a Reject Frame
Using BSRP G13 Trigger Frames or MU-RTS TXS Trigger Frames

| Bits | B0-B11 | B12-B14 | B15-B16 | B17-B18 | B19-B30 | B31-B36 | B37 | B38-B39 |
|---|---|---|---|---|---|---|---|---|
| Reject | AID | PHY | Uplink | Reserved | Shared AP | Reserved | NPCA | Information |
| | (set to | Version | Bandwidth | | 102 ID | | Primary | Type |
| | 2007) | Identifier | Extension | | | | Indication | |

In some implementations, an AP 102 may use the information to be indicated in the invite 405, sync 415, or reject frames to determine a solicited PDDU and trigger frame field structure, which may be based on a trigger type, GI and HE/UHR-LTF type field, a MAP field, an information type field, or any combination thereof, as in Table 17, for a BSRP G13 trigger frame. For a MU-RTS TXS trigger frame, the solicited PPDU and trigger frame field structure may be based on the trigger type, TXS mode field, the MAP field, the information type field, or any combination thereof, as in Table 18.

TABLE 17
Example for Using a BSRP G13 Trigger Frames for an Invite 405, Sync 415, or Reject Frame

| | GI and HE/ | | Information | | B4-B15 in | |
|---|---|---|---|---|---|---|
| Trigger | UHR-LTF Type | MAP Field | Type Field | Solicited | Common | |
| Type | Field Value | Value | Value | PPDU | Info Field | Rules |
| BSRP | 0-2 | Not present | Not present | TB PPDU | Uplink | N/A |
| (value 4) | | or any value | or any value | | Length field | |
| | | (if present) | (if present) | | (in octets, a | |
| | | | | | multiple of | |
| | | | | | 3 plus 1) | |
| BSRP | 3 | ‘CoBF’ or | ‘Sync’ | MU PPDU | Length field | N/A |
| (value 4) | | ‘(Type-I or | | (in CoBF or | (in octets, a | |
| (A Sub- | | Type-II) | | C-SR | multiple of | |
| Type: | | C-SR’ | | transmission) | 3) | |
| BSRP | | ‘CoBF’ or | ‘Reject’ | None | Uplink | No response |
| GI3) | | ‘(Type-I or | | | Length field | is needed |
| | | Type-II) | | | (set to 0) or | |
| | | C-SR’ | | | Reserved | |
| | | ‘CoBF’ or | ‘Invite’ | Non-HT | UL Length | For example, |
| | | ‘(Type-I or | | (Duplicate) | field (in | the length of |
| | | Type-II) | | PPDU that | octets, a | the solicited |
| | | C-SR’ | | contains a | multiple of | PPDU can be |
| | | | | Multi-STA | 3) | equal to or |
| | | | | BlockAck | | shorter than |
| | | | | | | the value of |
| | | | | | | the Uplink |
| | | | | | | Length field. |
| | | | | | | (e.g., MCS0 |
| | | | | | | is used for |
| | | | | | | the solicited |
| | | | | | | PPDU as a |
| | | | | | | rule or MCS |
| | | | | | | is indicated |
| | | | | | | in the invite |
| | | | | | | 405) |
| | | ‘No MAP’ | Not present | Non-HT | Uplink | N/A |
| | | | or any value | (Duplicate) | Length field | |
| | | | (if present) | PPDU that | (in octets, a | |
| | | Not present | ‘No MAP | contains a | multiple of | |
| | | or any value | Info’ | Multi-STA | 3) | |
| | | (if present) | | BlockAck | | |

Other combinations

TABLE 18
Example for a Reject Frame Using a MU-RTS TXS
Trigger Frame for a Sync 415 or Reject Frame

| | TXS Mode | | Information | | B4-B15 in |
|---|---|---|---|---|---|
| Trigger | Field | MAP Field | Type Field | Solicited | Common Info |
| Type | Value | Value | Value | PPDU | Field |
| MU-RTS | 0 | Not present or any | | CTS | Reserved |
| | | value (if present) | | | |
| MU-RTS | 1-2 | Not present or any | | CTS | Reserved |
| TXS | | value (if present) | | | |
| MU-RTS | 3 | ‘CoBF’ or | ‘Sync’ | MU PPDU | Length field |
| TXS for | | ‘(Type-I or | | (in CoBF | (in octets, a |
| MAP | | Type-II) | | or C-SR | multiple of 3) |
| | | C-SR’ | | transmission) | |
| | | ‘CoBF’ or | ‘Reject’ | None | Length field |
| | | ‘(Type-I or | | | (set to 0) |
| | | Type-II) | | | or Reserved |
| | | C-SR’ | | | |

Other Combinations

In some cases, the sync 415 may, as described herein, be a BSRP G13 trigger frame or a MU-RTS TXS trigger frame (e.g., total/minimum size is 8+5+5N octets for N users, starting from the beginning of the common information field to the end of user information list (e.g., before the Padding field)). In some examples, for CoBF, a BSRP trigger frame which may not be a BSRP GI3 trigger frame may reuse the ‘GI and HE/UHR-LTF Type’ field as a ‘GI+LTF Size’ (excluding value 3) to indicate up to 3 choices of GI+LTF Size, if the Information Type field indicates ‘Sync’ and the MAP Scheme field indicates ‘CoBF’. In other examples, for CoBF, the AP 102 may not use the spatial reuse field and the DRU or RRU indication field (e.g., 28 bits). There may be an additional user information field (e.g., with AID12 set to the ID of the shared AP 102) to carry all the information (e.g., total size (starting from the beginning of the common info field to the end of user info list (before the Padding field))=8+5+5+5N octets).

In some cases, the invite 405 may, as described herein, be a BSRP G13 trigger frame or a MU-RTS TXS trigger frame (e.g., total/minimum size is 8+5+5N for N users, starting from the common information field). For CoBF, the BSRP trigger frame may solicit a UHR TB PPDU (e.g., PHY version identifier set to 1) by preserving TB PPDU fields. There may an original UHR variant user information field with a AID12 set to the ID of the shared AP 102. To minimize the size of the invite 405, only baseline control information and PHY information may be carried. There may be an extra user information field (e.g., AID12 set to 2010) to carry non-user specific baseline information. The frame may include one user field to carry per-user information for one user (e.g., total size (starting from common information field)=8+15+5N) or two users (e.g., total size (starting from common information field)=8+15+5 for 1 user and 8+15+10 for 2-3 users).

The CoBF Response 410 may include a first AP information field (e.g., up to 21, 22, 23 bits), which may include a CoBF or C-SR indication (e.g., 1 bit), an indication of an intent to participate in CoBF (e.g., 1 bit) or an indication of an information type or MAP subfield (e.g., 2 bits, set to ‘MAP Response’, or 3 bits, set to ‘CoBF Response’) if not yet indicated in the common information field or the special user information field, a bandwidth of the responding AP 102-b (e.g., 2 bits), a quantity of CoBF users served by the responding AP 102-b (e.g., 2 bits), a length in L-SIG (e.g., 12 bits), a LDPC extra symbol segment (e.g., 1 bit), a pre-FEC padding factor (e.g., 2 bits), a PE disambiguity (e.g., 1 bit), or any combination thereof. The CoBF Response 410 may include at least one AP information field after the first AP information field. Each AP information field (e.g., 19 bits) after the first AP information field (e.g., starting from the 2^{nd} one) may be about the information of one user field, including a STA ID (e.g., 11 bits), a MCS (e.g., 5 bits), an Nss indication (e.g., 2 bits), an indication of whether 2×LDPC is used (e.g., 1 bit), or any combination thereof. The CoBF sync 415 may also include a first AP information field (e.g., between 2 and 6 bits), which may include a CoBF or C-SR indication (e.g., 1 bit), a CoBF trigger indication (e.g., 1 bit) or information type or MAP subfield (e.g., 2 bits, set to “MAP Trigger/Sync”, 3 bits, set to “CoBF Trigger/Sync”) if not yet indicated in the common information field or the special user information field, a quantity of UHR-LTF symbols (e.g., between 1 and 3 bits), or any combination thereof.

The C-SR procedure, whether three frame or single frame, as described further at FIG. 5, may also utilize the AP information field of the trigger frame, e.g., a UHR variant trigger frame. For example, the C-SR invite 405, or combined C-SR invite and trigger frame for the single frame option, may include a first AP information field (e.g., 25 or 27 bits), which may be similar in design to CoBF invite 405. For example, the first AP information field may include a PHY version identifier (e.g., 3 bits), a bandwidth of the PPDU sent by the initiating AP 102-a (e.g., 3 bits), an uplink or downlink indication of the initiating AP 102-a (e.g., 1 bit), a BSS color of the responding AP 102-b (e.g., 6 bits), an indication of the TXOP duration (e.g., 7 bits), a PPDU Type And Compression Mode (e.g., 2 bits), a CoBF or C-SR indication (e.g., 1 bit), an assigned bandwidth of the responding AP 102-b (e.g., 2 bits), or any combination thereof. Additionally, or alternatively, the first AP information field may include the information type or MAP subfield (e.g., 2 bits to indicate {Invite, Response, Trigger/Sync}, 3 bits to indicate {CoBF Invite, CoBF Response, CoBF Trigger/Sync, C-SR Invite, C-SR Response, C-SR Trigger/Sync}, if not yet indicated in the common information field or special user information field). In some cases, the C-SR invite 405 may include a second AP information field (e.g., 23 bits), which may indicate punctured channel information (e.g., 5 bits), a UHR-SIG MCS (e.g., 2 bits), a length in L-SIG (e.g., 12 bits), interference or power control information for the responding AP 102-b or the initiating AP 102-a or both (e.g., up to 4 bits per AP, total more than 4 bits), or any combination thereof. The C-SR response 410 may include a first AP information field (e.g., up to between 7 and 9 bits), which may include a CoBF or C-SR indication (e.g., 1 bit), an indication of intent to participate in C-SR (e.g., 1 bit) or an information type or MAP subfield (e.g., 2 bits, set to ‘MAP Response’, or 3 bits, set to ‘C-SR Response’), if not yet indicated in the common information field or special user information field, a bandwidth of the responding AP 102-b (e.g., 2 bits), interference or power control information for the responding AP 102-b or initiating AP 102-a or both (e.g., up to 4 bits per AP, total more than 4 bits), or any combination thereof. The C-SR sync 415 may include a first AP information field (e.g., up to 5-7 bits), which may include a CoBF or C-SR Indication (e.g., 1 bit), a C-SR trigger indication (e.g., 1 bit) or information type or MAP subfield (e.g., 2 bits, set to ‘MAP Trigger/Sync’, or 3 bits, set to ‘C-SR Trigger/Sync’) if not yet indicated in the common information field or special user information field, interference or power control information for the responding AP 102-b or initiating AP 102-a or both (e.g., up to 4 bits per AP, total more than 4 bits), or any combination thereof.

In some cases, the invite 405, response 410, and sync 415 may all be BSRP trigger frames that may not be BSRP GI3 trigger frames (e.g., BSRP trigger type, without trigger dependent common information or user information, GI and HE/UHR-LTF type may not be set to 3). The BSRP trigger frame may include one special user information field (e.g., AID12 set to 2007, PHY version identifier se to 1 (UHR)) (including the trigger-dependent user info field). TB PPDU information may be included in the frame, a control and PHY information for another AP 102 may be included. The BSRP frames may include reserved bits in the special user information that may carry basic control information (e.g., MAP, information type). The first AP user information field (e.g., with AID12 set to AP ID) (including the trigger-dependent user info field) may carry TB PPDU information (if present, to solicit an M-BA response). Additional AP user info field(s) (including the trigger-dependent user info field) may carry other information for the other AP 102. The frame may be organized as in Table 8, with additional user information fields for the other users, where each parameter of the one or more other user information fields may be K octets. Examples of invite 405, response 410, and sync 415 frame designs may be indicated in Tables 18-23, Tables 24-27, and Tables 28-33, respectively.

TABLE 18
Example of Common Information Field for an Invite 405 Using BSRP Trigger Frame

| Bits | B0-B3 | B4-B15 | B16 | B17 | B18-B19 | B20-B21 | B22 |
|---|---|---|---|---|---|---|---|
| Invite 405 | Trigger | Uplink | More | CS | Uplink | GI and HE/ | Reserved |
| Parameter | Type | Length | Trigger | Required | Bandwidth | UHR-LTF | |
| | | | | | | Type/TXS | |
| | | | | | | Mode | |

| Bits | B23-B25 | B26 | B27 | B28-B33 | B34-B35 | B36 | B37-B52 | B53 |
|---|---|---|---|---|---|---|---|---|
| Invite 405 | Quantity | Reserved | LDPC | AP | Pre-FEC | PE | UL | Reserved |
| Parameter | of HE/UHR- | | Extra- | Transmit | Padding | Disambiguity | Spatial | |
| | LTF Symbols | | Symbol | Power | Factor | | Reuse | |
| | | | Segment | | | | | |

| Bits | B54 | B55 | B56-B59 | B60 | B61 | B62 | B63 |
|---|---|---|---|---|---|---|---|
| Invite 405 | HE/UHR | Special User | DRU/RRU | IFCS | Protection | Key ID | Reserved |
| Parameter | P160 | Information | Indication | Present | Indication | | |
| | | Field Flag | | Flag | | | |

TABLE 19
Example of Special User Information Field for an Invite 405 Using BSRP Trigger Frame

| Bits | B0-B11 | B12-B14 | B15-B16 | B17-B20 | B21-B24 | B25-B27 | B28-B30 | B31 |
|---|---|---|---|---|---|---|---|---|
| Invite 405 | AID | PHY | Uplink | EHT/UHR | EHT/UHR | MAP | Quantity | Reserved |
| Parameter | (set to | Version | Bandwidth | Spatial | Spatial | Scheme | of CoBF | (set to 1) |
| | 2007) | Identifier | Extension | Reuse 1 | Reuse 2 | | Users | |

| Bits | B32 | B33-B34 | B35-B36 | B37 | B38-B39 |
|---|---|---|---|---|---|
| Invite 405 | Sync-Ref | GI + LTF | Reserved | NFPCA | Information |
| Parameter | Indication | Size | | Primary | Type |
| | | | | Indication | |

TABLE 20
Example of a UHR variant User Information Field where the Shared
AP 102 is a recipient for an Invite 405 Using BSRP Trigger Frame

| Bits | B0-B11 | B12-B19 | B20 | B21-B25 | B26 | B27-B31 | B32-B38 | B39 |
|---|---|---|---|---|---|---|---|---|
| Invite 405 | AID12 | RU | Uplink | Uplink | 2xLDPC | Search | Uplink | PS160 |
| Parameter | (Shared | Allocation | FEC | UHR-MCS | | Space | Target | |
| | AP 102 ID) | | Coding | | | Allocation | Receive | |
| | | | Type | | | | Power | |

TABLE 21
Example of an Additional AP User Information Field to carry non-user
specific information for an Invite 405 Using BSRP Trigger Frame

| Bits | B0-B11 | B12-B16 | B17-B25 | B26-B34 | B35-B36 | B37-B39 |
|---|---|---|---|---|---|---|
| Invite 405 | AID12 | Punctured | Minimum | Maximum | Maximum | Reserved |
| Parameter | (set to a | Channel | Quantity of | Quantity of | Total Nss | |
| | special | information | Data OFDM | Data OFDM | for Shared | |
| | value, | | Symbols | Symbols | AP 102 | |
| | e.g., 2010) | | | | | |

TABLE 22
Example of CoBF User Information Field to carry information
for one user for an Invite 405 Using BSRP Trigger Frame

| Bits | B0-B11 | B12-B22 | B23-B29 | B30 | B31-B39 |
|---|---|---|---|---|---|
| Invite 405 | AID 12 (set | STA ID | Reserved | Nss | Reserved |
| Parameter | to a special | | | | |
| | value, e.g., | | | | |
| | 2009) | | | | |

TABLE 23
Example of CoBF User Information Field to carry information
for two users for an Invite 405 Using BSRP Trigger Frame

| Bits | B0-B11 | B12-B22 | B23 | B24-B25 | B26-B36 | B37 | B38-B39 |
|---|---|---|---|---|---|---|---|
| Invite 405 | AID12 | STA ID of | Nss of a | Reserved | STA ID of | Nss of a | Reserved |
| Parameter | (set to a | a first user | first user | | a second | second | |
| | special | in the user | in the user | | user in the | user in the | |
| | value, | field | field | | user field | user field | |
| | e.g., 2009) | | | | | | |

TABLE 24
Example of Common Information Field for a Response 410 Using BSRP Trigger Frame

| Bits | B0-B3 | B4-B15 | B16 | B17 | B18-B19 | B20-B21 | B22 |
|---|---|---|---|---|---|---|---|
| Response | Trigger | Uplink | More | CS | Uplink | GI and HE/ | Reserved |
| 410 | Type | Length | Trigger | Required | Bandwidth | UHR-LTF | |
| Parameter | | | Frame | | | Type/TXS | |
| | | | | | | Mode | |

| Bits | B23-B25 | B26 | B27 | B28-B33 | B34-B35 | B36 | B37-B52 | B53 |
|---|---|---|---|---|---|---|---|---|
| Response | Quantity | Reserved | LDPC | AP | Pre-FEC | PE | UL | Reserved |
| 410 | of HE/ | | Extra- | Transmit | Padding | Disambiguity | Spatial | |
| Parameter | UHR-LTF | | Symbol | Power | Factor | | Reuse | |
| | Symbols | | Segment | | | | | |

| Bits | B54 | B55 | B56-B59 | B60 | B61 | B62 | B63 |
|---|---|---|---|---|---|---|---|
| Response | HE/UHR | Special | DRU/RRU | IFCS | Protection | Key ID | Reserved |
| 410 | P160 | User | Indication | Present | Indication | | |
| Parameter | | Information | | Flag | | | |
| | | Field Flag | | | | | |

TABLE 25
Example of Special User Information Field for a Response 410 Using BSRP Trigger Frame

| Bits | B0-B11 | B12-B14 | B15-B16 | B17-B20 | B21-B24 | B25-B27 | B28-B30 | B31 |
|---|---|---|---|---|---|---|---|---|
| Response | AID | PHY | Uplink | EHT/UHR | EHT/UHR | MAP | Quantity | Reserved |
| 410 | (set to | Version | Bandwidth | Spatial | Spatial | Scheme | of CoBF | (set to 1) |
| Parameter | 2007) | Identifier | Extension | Reuse 1 | Reuse 2 | | Users | |

| Bits | B32 | B33 | B34-B36 | B37 | B38-B39 |
|---|---|---|---|---|---|
| Response | Extra LTF | 0.8GI | Reserved | NFPCA | Information |
| 410 | Allowed | Allowed | | Primary | Type |
| Parameter | | | | Indication | |

TABLE 26
Example of a UHR variant User Information Field where the Sharing
AP 102 is a recipient for a Response 410 Using BSRP Trigger Frame

| Bits | B0-B11 | B12-B19 | B20 | B21-B25 | B26 | B27-B31 | B32-B38 | B39 |
|---|---|---|---|---|---|---|---|---|
| Response | AID12 | RU | Uplink | Uplink | 2xLDPC | Search | Uplink | PS160 |
| 410 | (set to | Allocation | FEC | UHR- | | Space | Target | |
| Parameter | Sharing | | Coding | MCS | | Allocation | Receive | |
| | AP 102 ID) | | Type | | | | Power | |

TABLE 27
Example of CoBF User Information Field for
a Response 410 Using BSRP Trigger Frame

| Bits | B0-B11 | B12-B22 | B23 | B24-B28 | B29 | B30 | B31-B39 |
|---|---|---|---|---|---|---|---|
| Response | AID12 | STA ID | Reserved | MCS | 2xLDPC | Nss | Reserved |
| 410 | (set to a | | | | | | |
| Parameter | special | | | | | | |
| | value, | | | | | | |
| | e.g., 2009) | | | | | | |

Tables 22 and 23 may be frame design sub-options (e.g., Table 22 may be for a 1-user design, Table 23 may be for a 2-users design).

TABLE 28
Example of Common Information Field for a Sync 415 Using BSRP Trigger Frame

| Bits | B0-B3 | B4-B15 | B16 | B17 | B18-B19 | B20-B21 | B22 |
|---|---|---|---|---|---|---|---|
| Sync 415 | Trigger | Length | More | CS | Uplink | GI + LTF | Reserved |
| Parameter | Type | | Trigger | Required | Bandwidth | Size | |
| | | | Frame | | | (excluding | |
| | | | | | | value 3) | |

| Bits | B23-B25 | B26 | B27 | B28-B33 | B34-B35 | B36 | B37-B52 | B53 |
|---|---|---|---|---|---|---|---|---|
| Sync 415 | Quantity | Reserved | LDPC | Shared | Pre-FEC | PE | UL | Reserved |
| Parameter | of HE/ | | Extra- | AP 102 | Padding | Disambiguity | Spatial | |
| | UHR-LTF | | Symbol | Transmit | Factor | | Reuse | |
| | Symbols | | Segment | Power | | | | |

| Bits | B54 | B55 | B56-B59 | B60 | B61 | B62 | B63 |
|---|---|---|---|---|---|---|---|
| Sync 415 | HE/UHR | Special | DRU/RRU | IFCS | Protection | Key ID | Reserved |
| Parameter | P160 | User | Indication | Present | Indication | | |
| | | Information | | Flag | | | |
| | | Field Flag | | | | | |

TABLE 29
Example of Special User Information Field
for a Sync 415 Using BSRP Trigger Frame

| Bits | B0-B11 | B12-B14 | B15-B16 | B17-B20 | B21-B24 | B25-B27 |
|---|---|---|---|---|---|---|
| Sync 415 | AID (set | PHY | Uplink | EHT/UHR | EHT/UHR | MAP |
| Parameter | to 2007) | Version | Bandwidth | Spatial | Spatial | Scheme |
| | | Identifier | Extension | Reuse 1 | Reuse 2 | |

| Bits | B28-B30 | B31 | B32-B36 | B37 | B38-B39 |
|---|---|---|---|---|---|
| Sync 415 | Quantity of | Reserved | Quantity of | NFPCA | Information |
| Parameter | CoBF | | UHR-SIG | Primary | Type |
| | Users | | symbols | Indication | |

TABLE 30
Example for a Sync 415 Using BSRP Trigger Frame

| Bits | B0-B11 | B12-B16 | B17-B23 | B24-B39 |
|---|---|---|---|---|
| Sync 415 | AID12 (set to | Punctured | TXOP | Reserved |
| Parameter | Shared AP | Channel | | |
| | 102 ID or a | Information | | |
| | special value, | | | |
| | e.g., 2010) | | | |

TABLE 31
Example of CoBF User Information Field for a Sync 415 Using BSRP Trigger Frame

| Bits | B0-B11 | B12-B22 | B23 | B24-B28 | B29 | B30-B33 | B34-B39 |
|---|---|---|---|---|---|---|---|
| Sync 415 | AID12 | STA ID | BSS Color | MCS | 2xLDPC | Spatial | BSS Color |
| Parameter | (set to a | | Indication | | | Configuration | |
| | special | | | | | | |
| | value, | | | | | | |
| | e.g., 2009) | | | | | | |

TABLE 32
Example of an Additional AP User Information Field to carry non-
user specific information for a Sync 415 Using BSRP Trigger Frame

| Bits | B0-B11 | B12-B16 | B17-B23 | B24-B29 | B30-B35 | B36-B39 |
|---|---|---|---|---|---|---|
| Sync 415 | AID 12 | Punctured | TXOP | BSS Color | BSS Color | Reserved |
| Parameter | (set to | Channel | | 1 | 2 | |
| | Shared | Information | | | | |
| | AP 102 | | | | | |
| | ID or a | | | | | |
| | special | | | | | |
| | value, | | | | | |
| | e.g., 2010) | | | | | |

TABLE 33
Example of CoBF User Information Field for a Sync 415 Using BSRP Trigger Frame

| Bits | B0-B11 | B12-B22 | B23 | B24-B28 | B29 | B30-B33 | B34-B39 |
|---|---|---|---|---|---|---|---|
| Sync 415 | AID12 | STA ID | BSS Color | MCS | 2xLDPC | Spatial | Reserved |
| Parameter | (set to a | | Indication | | | Configuration | |
| | special | | | | | | |
| | value, | | | | | | |
| | e.g., 2009) | | | | | | |

Tables 30-33 may be sub-options of frame designs (e.g., Tables 30 and 31 may be for one sub-option, Tables 32 and 33 may be for an alternative sub-option).

In some implementations, an AP 102 may use the information to be indicated in the invite 405, response 410, or sync 415 to determine a solicited PDDU and trigger frame field structure, which may be based on a trigger type, GI and HE/UHR-LTF type field, a MAP field, an information type field, or any combination thereof, as in Table 34, for a BSRP trigger frame.

TABLE 34
Example for Using a BSRP Trigger Frames for an Invite 405, Response 410, or Sync 415

| | GI and | | | | | |
|---|---|---|---|---|---|---|
| | HE/UHR- | | Information | | B4-B15 in | |
| Trigger | LTF Type | MAP Field | Type | Solicited | Common | |
| Type | Field Value | Value | Field Value | PPDU | Info Field | Rules |
| BSRP | 0-2 (the | ‘CoBF’ or | ‘Sync’ | MU PPDU | Length | N/A |
| (value 4) | value may | ‘(Type-I or | | (in CoBF or | Field (in | |
| | indicate | Type-II) C- | | C-SR | octets, a | |
| | GI + LTF | SR’ | | transmission) | multiple of | |
| | Size for the | | | | 3) | |
| | MU PPDU | | | | | |
| | with different | | | | | |
| | encoding) | | | | | |
| | 0-2 | ‘CoBF’ or | ‘Reject’ | None | Uplink | No response |
| | | ‘(Type-I or | | | Length | is needed |
| | | Type-II) C- | | | field (set to | |
| | | SR’ | | | 0) or Reserved | |
| | | ‘CoBF’ or | ‘Invite’ | TB PPDU | Uplink | For |
| | | ‘(Type-I or | | that contains | Length | example, |
| | | Type-II) C- | | a Multi-STA | field (in | the length of |
| | | SR’ | | BlockAck | octets, a | the solicited |
| | | ‘CoBF’ or | ‘Response | | multiple of | PPDU can |
| | | ‘(Type-I or | | | 3 plus 1) | be equal to |
| | | Type-II) C- | | | | or shorter |
| | | SR’ | | | | than the |
| | | | | | | value of the |
| | | | | | | Uplink |
| | | | | | | Length field |
| | | ‘No Map’ | Not present | TB PPDU | Uplink | N/A |
| | | | or any value | that contains | Length | |
| | | | (if present) | a QoS Null | field (in | |
| | | Not present | ‘No Map | frame, e.g., a | octets, a | |
| | | or any value | Info’ | Multi-STA | multiple of | |
| | | (if present) | | BlockAck | 3 plus 1) | |

Other Combinations

In some implementations, as discussed above, with the PPDU length and LDPC encoding parameters conveyed in the CoBF Invite 405 or CoBF Response 410 or both, it may be beneficial to implement LDPC rate matching between transmissions for CoBF. The LDPC rate matching between transmissions for CoBF is based on the 802.11bn (UHR) LDPC rate matching, which is based on the 802.11be (EHT) LDPC rate matching and further includes the 2×LDPC feature and modification in rate matching for the CoBF procedure. A two-step padding process may be applied to an EHT or UHR PPDU. A pre-FEC padding process including both pre-FEC medium access control (MAC) and pre-FEC PHY padding may be applied before conducting FEC coding, and a post-FEC PHY padding process may be applied on the FEC encoded bits. Four pre-FEC padding boundaries may partition the last OFDM symbol of an EHT or UHR PPDU into four symbol segments. The pre-FEC padding may pad toward one of the four possible boundaries. The four pre-FEC padding boundaries may be represented by a pre-FEC padding factor parameter a.

In some implementations, an encoding process may be applied to both an EHT and UHR MU PPDUs with transmission to a single user or multiple users. First, an AP 102 or other device (e.g., a transmitter) may determine an LDPC pre-FEC padding boundary. In an EHT or UHR MU PPDU transmission, the transmitter may first compute the quantity of data bits left in the last OFDM symbol for user u, as in Equation 1.

$${N}_{Excess , u} = ( 8 \cdot A P E {P}_{{LENGTH}_{u}} + {N}_{tail , u} + {N}_{service} ) mod {N}_{DBPS , u} \qquad ( 1 )$$

APEP_{LENGTHu} may be the transmission vector (e.g., TXVECTOR) parameter APEP_{LENGTH} for the u^{th} user; N_{tail,u} may be the quantity of tails bits per encoder for user u, where N_{tail,u}=6 for binary convolution codes (BCC) encoding and N_{tail,u}=0 for LDPC; N_{service} may be the quantity of bits in a SERVICE field (e.g., 16); N_{DBPS,u}=floor(N_{CBPS,u}·Rᵤ) may be the quantity of data bits per OFDM symbol for the u^{th} user, where Ry may be the nominal coding rate for the u^{th} user, N_{CBPS,u}=N_{SD,u}·N_{ss,u}·N_{BPSCS,u} may be the quantity of coded bits per OFDM symbol for user u, in which N_{SD,u} may be the N_{SD} (the effective quantity of data tones carrying unique data in one OFDM symbol) value corresponding to the occupied resource unit (RU) or multiple RU (MRU) size of the u^{th} user, N_{ss,u} may be the Nss for the u^{th} user, and N_{BPSCS,u} may be the quantity of coded bits per OFDM symbol per spatial stream for user u.

Based on N_{Excess,u}, the transmitter may compute the initial quantity of symbol segments in the initial last OFDM symbol, i.e., initial pre-FEC padding factor value a_{init,u} and the initial quantity of OFDM symbols, N_{SYM,init,u}, for user u using Equations 2 and 3.

$${a}_{init , u} = \{ \begin{matrix}4 , & if {N}_{Excess , u} = 0 \\ min ( ⌈ \frac{{N}_{Excess , u}}{{N}_{DBPS , short , u}} ⌉ , 4 ) , & otherwise\end{matrix} \qquad ( 2 )$$

$${N}_{SYM , init , u} = ⌈ \frac{8 \cdot A P E {P}_{{LENGTH}_{u}} + {N}_{tail , u} + {N}_{service}}{{N}_{DBPS , u}} ⌉ \qquad ( 3 )$$

where N_{DBPS,short,u}=N_{CBPS,short,u}·Rᵤ, in which N_{CBPS,short,u}=N_{SD,short,u}·N_{ss,u}·N_{BPSCS,u}, in which N_{SD,short,u} is the N_{SD,short} (effective quantity of data tones carrying unique data in each symbol segment of the first three symbol segments) value corresponding to the occupied RU or MRU size of the u^{th} user.

Among all the users, the transmitter may derive the set of the user indices S, with the longest encoded packet duration as in Equation 4 and select one value from the set as uₘₐₓ.

$$S = arg {max}_{0 \leq u \leq {N}_{user , {total}^{- 1}}} ( {N}_{SYM , init , u} - 1 + \frac{{a}_{init , u}}{4} ) \qquad ( 4 )$$

where arg max f(x):={x∈[0,N_{user,total}−1]:f(y)≤f(x) for all y∈[0,N_{user,total}−1]}. Then the common aᵢₙᵢₜ and N_{SYM,init} values among all the users may be derived using Equations 5 and 6.

$${N}_{SYM , init} = {N}_{SYM , init , {u}_{max}} \qquad ( 5 )$$

$${a}_{init} = {a}_{init , {u}_{max}} \qquad ( 6 )$$

Next, the transmitter may calculate each user's initial quantity of data bits, N_{DBPS,last,init,u}, and initial quantity of coded bits, N_{CBPS,last,init,u}, in a last OFDM symbol, as shown in Equations 7 and 8, respectively.

$${N}_{DBPS , last , init , u} = \{ \begin{matrix}{a}_{init} \cdot {N}_{DBPS , short , u} & if {a}_{init} < 4 \\ {N}_{DBPS , u} & if {a}_{init} = 4\end{matrix} \qquad ( 7 )$$

$${N}_{CBPS , last , init , u} = \{ \begin{matrix}{a}_{init} \cdot {N}_{CBPS , short , u} & if {a}_{init} < 4 \\ {N}_{CBPS , u} & if {a}_{init} = 4\end{matrix} \qquad ( 8 )$$

For each user with LDPC encoding, the parameters N_{pld,u} and N_{avbits,u} may be computed using Equations 9 and 10, respectively.

$${N}_{pld , u} = ( {N}_{SYM , init} - 1 ) {N}_{DBPS , u} + {N}_{DBPS , last , init , u} \qquad ( 9 )$$

$${N}_{avbits , u} = ( {N}_{SYM , init} - 1 ) {N}_{CBPS , u} + {N}_{CBPS , last , init , u} \qquad ( 10 )$$

where N_{pld,u} may be the PHY payload size (e.g., the quantity of data bits including pre-FEC padding bits, that may fit in the PHY payload boundary (or called pre-FEC padding boundary) which may be the end of the symbol segment aᵢₙᵢₜ in the OFDM symbol N_{SYM,init}). N_{avbits,u} may be the quantity of PHY coded bits that may fit in the current PHY coded bits boundary, which may be the end of the symbol segment aᵢₙᵢₜ in the OFDM symbol N_{SYM,init}. The effective code rate based on these two values may be

$$e C {R}_{u} = \frac{{N}_{pld , u}}{{N}_{avbits , u}} = \frac{( {N}_{SYM , init} - 1 ) {N}_{DBPS , u} + {N}_{DBPS , last , init , u}}{( {N}_{SYM , init} - 1 ) {N}_{CBPS , u} + {N}_{CBPS , last , init , u}} = {R}_{u} ,$$

(e.g., the nominal code rate Rᵤ of user u). Adjusting the PHY coded bits boundary by adding one or more OFDM symbols or fraction of symbol (e.g., one or more symbol segments) to accommodate more PHY coded bits may lower the effective code rate and reduce puncturing ratio.

Second, the transmitter may determine an LDPC code word size and quantity (e.g., quantity) of codewords. The transmitter may compute an integer quantity of LDPC codewords to be transmitted for user u, N_{CW,u}, and the length of the codewords to be used for user u, L_{LDPC,u}, based on a table, such as Table 35 (PPDU encoding parameters).

TABLE 35
Example of table for determining PPDU encoding parameters

| Ranges of | Number of LDPC | LDPC codeword length |
|---|---|---|
| N_{avbits}(bits) | codewords (N_{CW}) | L_{LDPC} (bits) |
| Navbits ≤ 648 | 1 | 1296, if N_{avbits} ≥ N_{pld} + 912 × |
| | | (1 − R) 648, otherwise |
| 648 < N_{avbits} ≤ | 1 | 1944, if N_{avbits} ≥ N_{pld} + 1464 × |
| 1296 | | (1 − R) 1296, otherwise |
| 1296 < N_{avbits} ≤ | 1 | 1944 |
| 1944 | | |
| 1944 < N_{avbits} ≤ | 2 | 1944, if N_{avbits} ≥ N_{pld} + 2916 × |
| 2592 | | (1 − R) 1296, otherwise |
| 2592 < N_{avbits} | $⌈ \frac{{N}_{pld}}{1944 \cdot R} ⌉$ | 1944 |

Third, the transmitter may compute the quantity of shortening bits for user u, N_{shrt,u}, to be padded to the N_{pld,u} data bits before encoding, as shown in Equation 11.

$${N}_{shrt , u} = max ( 0 , {N}_{CW , u} \cdot {L}_{LDPC , u} \cdot {R}_{u} - {N}_{pld , u} ) \qquad ( 11 )$$

For N_{shrt,u}=0, shortening may not be performed. For N_{shrt,u}>0, shortening bits may be equally distributed over all N_{CW,u} codewords with the first rem(N_{shrt,u},N_{CW,u}) codewords being shortened one bit more than the remaining codewords. Shortening bits may be appended after data bits. The shortening bits may be discarded after encoding.

Fourth, the transmitter may compute the quantity of bits to be punctured for user u, N_{punc,u}, from the codewords after encoding, as in Equation 12.

$${N}_{punc , u} = max ( 0 , {N}_{CW , u} \cdot {L}_{LDPC , u} - {N}_{avbits , u} - {N}_{shrt , u} ) \qquad ( 12 )$$

For N_{punc,u}=0, puncturing may not be performed. For N_{punc,u}>0, puncturing bits may be equally distributed over all N_{CW,u} codewords with the first rem(N_{punc,u},N_{CW,u}) codewords being punctured one bit more than the remaining codewords. Only parity bits may be punctured.

In some implementations, there may be at least one user with LDPC encoding for which one or more conditions in the LDPC encoding process may be met. For example, if (N_{punc,u}>0.1·N_{CW,u}·L_{LDPC,u}·(1−Rᵤ)) AND (Nₛₕᵣₜ<1.2·N_{punc,u}·Rᵤ/(1−Rᵤ) is true OR if N_{punc,u}>0.3·N_{CW,u}·L_{LDPC,u}·(1−Rᵤ) is true, for any user u, all users with LDPC encoding may increment N_{avbits,u} by an extra symbol segment and recompute N_{punc,u} based on the new N_{avbits,u} value, as in Equation 13.

$${N}_{avbits , u} = \{ \begin{matrix}{N}_{avbits , u} + {N}_{CBPS , u} - 3 {N}_{CBPS , short , u} , & if {a}_{init} = 3 \\ {N}_{avbits , u} + {N}_{CBPS , short , u} , & otherwise\end{matrix} \qquad ( 13 )$$

Then, the transmitter may update the common pre-FEC padding factor a and N_{SYM} values for all users using Equation 14.

$$\{ \begin{matrix}{N}_{SYM} = {N}_{SYM , init} + 1 and a = 1 , & if {a}_{init} = 4 \\ {N}_{SYM} = {N}_{SYM , init} and a = {a}_{init} + 1 , & otherwise\end{matrix} \qquad ( 14 )$$

In some cases, the last OFDM symbol may be the next OFDM symbol of the initial last OFDM symbol, if aᵢₙᵢₜ=4. Since N_{avbits,u} may be updated with a larger value, more PHY coded bits may fit in the adjusted PHY coded bits boundary, which may be the end of the symbol segment a in the OFDM symbol N_{SYM}. However, if the above condition in the LDPC encoding process is not met by any of the users with LDPC encoding, or if all the users scheduled in the EHT or UHR MU PPDU are BCC encoded, no extra symbol segment may be added. Then, the common pre-FEC padding factor a and N_{SYM} values for all users may be updated using Equation 15.

$${N}_{SYM} = {N}_{SYM , init} and a = {a}_{init} \qquad ( 15 )$$

The quantity of coded bits to be repeated for user u, N_{rep,u}, may be computed, as in Equation 16.

$${N}_{rep , u} = max ( 0 , {N}_{avbits , u} - {N}_{CW , u} \cdot {L}_{LDPC , u} \cdot ( 1 - {R}_{u} ) - {N}_{pld , u} ) \qquad ( 16 )$$

For N_{rep,u}=0, repetition may not be performed. For N_{rep,u}>0, the quantity of coded bits to be repeated may be equally distributed over all N_{CW,u} codewords with one more bit repeated for the first rem(N_{rep,u},N_{CW,u}) codewords than the remaining codewords. The coded bits to be repeated for any codeword may be copied from that codeword itself, starting from the beginning of that LDPC codeword (beginning of data bits). When puncturing occurs, the coded bits may not be repeated, and vice versa.

Fifth, the LDPC or BCC pre-FEC padding and post-FEC padding may be finalized. For the users with LDPC encoding, N_{DBPS} of the last OFDM symbol may be updated as N_{DBPS,last,u}=N_{DBPS,last,init,u}. For the users with BCC encoding, the N_{DBPS} of the last OFDM symbol may be updated as in Equation 17.

$${N}_{DBPS , last , u} = \{ \begin{matrix}a \cdot {N}_{DBPS , short , u} , & if a < 4 \\ {N}_{DBPS , u} , & if a = 4\end{matrix} \qquad ( 17 )$$

For each user with either LDPC or BCC encoding, the N_{CBPS} of the last OFDM symbol may be updated, as in Equation 18.

$${N}_{CBPS , last , u} = \{ \begin{matrix}a \cdot {N}_{CBPS , short , u} , & if a < 4 \\ {N}_{CBPS , u} , & if a = 4\end{matrix} \qquad ( 18 )$$

For each user with LDPC encoding, the quantity of pre-FEC padding bits for the u^{th} user may be computed, as in Equation 19.

$${N}_{PAD , Pre - FEC , u} = ( {N}_{SYM , init} - 1 ) {N}_{DBPS , u} + {N}_{DBPS , last , init , u} - 8 \cdot {APEP}_{{LENGTH}_{u}} - {N}_{service} \qquad ( 19 )$$

The PHY payload boundary (or called pre-FEC padding boundary) for users using LDPC encoding may be the end of the symbol segment aᵢₙᵢₜ in the OFDM symbol N_{SYM,init}, and may be determined by N_{SYM,init} and aᵢₙᵢₜ. For users with BCC encoding, the quantity of pre-FEC padding bits for the u^{th} user may be calculated, as in Equation 20.

$${N}_{PAD , Pre - FEC , u} = ( {N}_{SYM} - 1 ) {N}_{DBPS , u} + {N}_{DBPS , last , u} - 8 \cdot {APEP}_{{LENGTH}_{u}} - {N}_{tail , u} - {N}_{service} \qquad ( 20 )$$

For users using BCC encoding, both the PHY payload boundary (or called pre-FEC padding boundary) and the PHY coded bits boundary may be the same as the end of the symbol segment a in the OFDM symbol N_{SYM}, determined by N_{SYM} and a. For each user with either LDPC or BCC encoding, the quantity of post-FEC padding bits in the last symbol may be computed, as in Equation 21.

$${N}_{PAD , Post - FEC , u} = {N}_{CBPS , u} - {N}_{CBPS , last , u} \qquad ( 21 )$$

The post-FEC padding may fill the data tones not occupied by PHY coded bits in the last OFDM symbol (e.g., the remaining symbol segments in the last OFDM symbol).

Among the pre-FEC padding bits, the MAC may deliver a PSDU that may fill the available octets in a data field of the EHT or UHR PPDU, toward the desired initial pre-FEC padding boundary represented by aᵢₙᵢₜ for users encoded by LDPC, and toward the desired pre-FEC padding boundary represented by a for users encoded by BCC, in the last OFDM symbol. The PHY may determine the quantity of padding bits to add and may append them to the PSDU. The quantity of pre-FEC padding bits added by PHY may be between 0 and 7.

In some implementations, the APs 102 or other devices participating in CoBF, C-SR, or similar procedures may use rate matched transmissions, as described herein, which may be LDPC rate matching. LDPC rate matching in non-extended long range (non-ELR) transmissions may be similar to other methods of LDPC rate matching, with some modifications.

In some cases, a wireless communications network may implement a new LDPC scheme (e.g., 2×LDPC), as described herein. The 2×LDPC may use twice the maximum LDPC nominal codeword size (e.g., 1944 of 3888) for better error performance and throughput performance. To accommodate 2×LDPC, the LDPC codeword size may be modified. For example, to accommodate 2×LDPC, a 1-bit 2×LDPC subfield may be added in the UHR variant user information field in the sync frame 415, and in MU-MIMO and non-MU-MIMO user field formats in UHR-SIG. The 2×LDPC subfield may be set to 1 to indicate 2×LDPC (nominal codeword size of 3888) is used, or set to 0 to indicate it's not used, if the coding scheme is LDPC. If the FEC coding scheme is LDPC and N_{avbits}≤3888, the 2×LDPC subfield may be set to 0 and the LDPC codeword length selection may follow the procedure described with reference to Equations 1-21 and Table 1, specifically using codeword lengths (648, 1296, or 1944) bits based on Table 2. If the FEC coding scheme is LDPC and N_{avbits}>3888, the 2×LDPC subfield may be set to 0 to disable 2×LDPC nominal codeword size of 3888, or set to 1 to enable 2×LDPC nominal codeword size of 3888. Table 36, which may be a modified version of Table 35, may be used to select the codeword size and calculate the quantity of LDPC codewords. Table 36 and the codeword size selection may depend on the 2×LDPC subfield of the user. The 2×LDPC subfield may indicate enabling or disabling 2×LDPC for the user, which may be determined and indicated by the serving AP 102 of the user. For each user in the sharing BSS, if the MCS may be pre-determined and indicated by the sharing AP 102 in the invite 405, the 2×LDPC subfield may be indicated by the sharing AP 102 in the invite 405 and codeword size selection may be done accordingly. For each user in the shared BSS, the MCS, codeword size selection, and 2×LDPC subfields may be determined by the shared AP 102 based on rough or exact packet size or data field duration information exchanged via the invite 405, and the MCS and 2×LDPC subfields may be indicated in the response 410. For each user in the sharing BSS, if the MCS, codeword size selection and 2×LDPC subfields may be determined by the sharing AP 102 after receiving the response 410, the MCS and 2×LDPC subfield may be indicated in the sync 415. Additionally, or alternatively, for each user in the shared BSS, if the codeword size selection may not be done and the 2×LDPC subfield may not be indicated by the shared AP 102 in the response 410, the shared AP may indicate the 2×LDPC capability of the user in the response 410, and the sharing AP may select the codeword size for the user and indicate the 2×LDPC subfield of the user in the sync 415.

TABLE 36
Example of table for determining modified PPDU encoding parameters

| Ranges of | Number of LDPC | LDPC codeword length |
|---|---|---|
| N_{avbits} (bits) | codewords (N_{CW}) | L_{LDPC} (bits) |
| N_{avbits} ≤ 648 | 1 | 1296, if N_{avbits} ≥ N_{pld} + 912 × |
| | | (1 − R) 648, otherwise |
| 648 < N_{avbits} ≤ | 1 | 1944, if N_{avbits} ≥ N_{pld} + 1464 × |
| 1296 | | (1 − R) 1296, otherwise |
| 1296 < N_{avbits} ≤ | 1 | 1944 |
| 1944 | | |
| 1944 < N_{avbits} ≤ | 2 | 1944, if N_{avbits} ≥ N_{pld} + 2916 × |
| 2592 | | (1 − R) 1296, otherwise |
| 2592 < N_{avbits} ≤ 3888 | $⌈ \frac{{N}_{pld}}{1944 \cdot R} ⌉$ | 1944 |
| N_{avbits} > 3888 | $⌈ \frac{{N}_{pld}}{{L}_{LDPC} \cdot R} ⌉$ | 1944, if 2xLDPC subfield is set to 0, i.e., codeword size of 3888 is not enabled |
| | | 3888, if 2xLDPC subfield is set to 1, |
| | | i.e., codeword size of 3888 is enabled |

LDPC rate matching may be implemented for a CoBF procedure, based on the PPDU length and LDPC encoding parameters conveyed in the CoBF Invite 405 or CoBF Response 410 or both. In a CoBF procedure, two APs 102 (e.g., the initiating AP 102-a and the responding AP 102-b) may coordinate their downlink CoBF transmissions, and each AP 102 may null the interference to the scheduled users by the other AP 102. The CoBF transmission may be synchronized between the two APs 102, sharing a common, non-beamformed preamble from L-STF to UHR-SIG, and nulling may happen in the UHR portion of the PPDUs, starting from UHR-short training field (STF).

To share a common preamble of L-SIG (and RL-SIG), U-SIG and UHR-SIG, the multiple users served by the two APs 102 may share the same PPDU length (i.e., the length field in L-SIG and the PE disambiguity subfield in the common field in UHR-SIG) and the same LDPC encoding parameters (i.e., the pre-FEC padding factor subfield and LDPC extra symbol segment subfield in the common field in UHR-SIG), similar to how multiple users in the same BSS may share the same set of parameters in a single-BSS transmission.

In some implementations, an initiating AP 102-a (e.g., a TXOP holder) may determine the PPDU length and the LDPC encoding parameters for the CoBF procedure. The initiating AP 102-a may calculate the PPDU length and LDPC encoding parameters for its serving users, and may send the information in a CoBF Invite 405 to the responding AP 102-b. The responding AP 102-b may tailor the packet sizes of serving users associated with the responding AP 102-b to meet the same PPDU length and use the same LDPC encoding requirements.

For example, the initiating APs 102-a may send the information of a 12-bit length field (L_{LENGTH}) defined in L-SIG, a 2-bit common pre-FEC padding factor subfield (a), a 1-bit LDPC extra symbol segment subfield (b_{LDPC-extra-sym-seg}), and a 1-bit PE disambiguity subfield (b_{PE-Disambiguity}) defined in the common field in UHR-SIG in a CoBF Invite 405 or CoBF Sync 415 to the responding AP 102-b. The quantity of OFDM symbols may be derived using Equation 22.

$${N}_{SYM} = ⌊ \frac{\frac{{L}_{LENGTH} + 3}{3} \times 4 - {T}_{UHR - PREAMBLE}}{{T}_{SYM}} ⌋ - {b}_{PE - Disambiguity} \qquad ( 22 )$$

T_{SYM} may be the symbol duration (including GI) in the Data field, and the UHR preamble duration may be the total duration of preamble fields from RL-SIG to UHR-LTF, such that T_{UHR-PREAMBLE}=T_{RL-SIG}+T_{U-SIG}+N_{UHR-SIG}T_{UHR-SIG}+T_{UHR-STF-NT}+N_{UHR-LTF}T_{UHR-LTF-SYM} where T_{RL-SIG}=4 us may be the RL-SIG field duration, T_{U-SIG}=8 us may be the U-SIG field duration, T_{UHR-SIG}=4 us may be the duration of each OFDM symbol (including GI) in the UHR-SIG field, T_{UHR-STF-NT}=4 us may be the UHR-STF field duration in UHR MU PPDUS, T_{UHR-LTF-SYM} may be the duration of each OFDM symbol (including GI) in the UHR-LTF field, N_{UHR-SIG} may be the quantity of UHR-SIG symbols, and N_{UHR-LTF} may be the quantity of UHR-LTF symbols. In some cases, the quantity of UHR-SIG symbols N_{UHR-SIG} and the quantity of UHR-LTF symbols N_{UHR-LTF} may not be known by the sharing AP 102 at the time of the invite 405. The sharing AP 102 may define an alternative parameter modified length (12 bits) (L_{LENGTH,modified}) (e.g., in the unit of octets) assuming the quantity of UHR-SIG symbols N_{UHR-SIG,sharingBSS} may be determined based on the number of users in the sharing BSS, and the quantity of UHR-LTF symbols N_{UHR-LTF,sharingBSS} may be determined based on the per-user Nss of users in the sharing BSS, in deriving the modified UHR preamble duration. The sharing AP 102 may also define an alternative parameter of PE disambiguity in the sharing BSS according to the modified length for each definition of number of data OFDM symbols, e.g., one or more PE disambiguity bits for the one or more modified length based on one or more number of data OFDM symbols, a PE disambiguity for the average modified length based on the average number of data OFDM symbols, a PE disambiguity for the minimum modified length based on the minimum number of data OFDM symbols, and a PE disambiguity for the maximum modified length based on the maximum number of data OFDM symbols. The modified length (e.g., 12 bits) and a paired PE disambiguity (1 bit) for the modified length may replace the length (e.g., 12 bits) and PE disambiguity (1 bit) and be exchanged in the invite 405.

Additionally, or alternatively, the initiating AP 102-a may send the information of the 2-bit common pre-FEC padding factor subfield (a), the 1-bit LDPC extra symbol segment subfield (b_{LDPC-extra-sym-seg}) defined in the common field in UHR-SIG, and a 9- or 10-bit quantity of OFDM symbols (N_{SYM}) in a CoBF Invite 405 to the responding AP 102-b. If the LDPC extra symbol segment subfield value is 0, the initial pre-FEC padding factor aᵢₙᵢₜ=a and the initial quantity of OFDM symbols N_{SYM,init}=N_{SYM}. If the LDPC Extra Symbol Segment subfield value is 1, the initial pre-FEC padding factor and the initial quantity of OFDM symbols may be determined by Equation 23.

$$\{ \begin{matrix}{N}_{SYM , init} = {N}_{SYM} - 1 and {a}_{init} = 4 , & if a = 1 \\ {N}_{SYM , init} = {N}_{SYM} and {a}_{init} = a - 1 , & otherwise\end{matrix} \qquad ( 23 )$$

Additionally, or alternatively, the initiating AP 102-a may send the information of the 1-bit LDPC extra symbol segment subfield (b_{LDPC-extra-sym-seg}) defined in the common field in UHR-SIG, a 2-bit initial pre-FEC padding factor (aᵢₙᵢₜ), and a 9- or 10-bit initial quantity of OFDM symbols (N_{SYM,init}) in a CoBF Invite 405 to the responding AP 102-b. For each user served by the responding AP 102-b, the PHY payload size N_{pld,u} and available PHY coded bits N_{avbits,u} may be computed using Equations 1-10. For each user, the responding AP may choose the actual payload according to N_{pld,u}. If the LDPC extra symbol segment (b_{LDPC-extra-sym-seg}) may be set as either 0 or 1 by the initiating AP 102-a, the responding AP 102-b may not be able to control the puncturing ratio in LDPC codewords. If the LDPC extra symbol segment (b_{LDPC-extra-sym-seg}) may be set to 1 by the initiating AP 102-a, the puncturing ratio in LDPC codewords may be lower.

In some implementations, the initiating AP 102-a and the responding AP 102-b may exchange the PPDU length and LDPC encoding parameters information in order to jointly determine the PPDU length and encoding parameters. The initiating AP 102-a may calculate the PPDU length and LDPC encoding parameters for the serving users associated with the initiating AP 102-a, and may send the information in a CoBF Invite 405 to the responding AP 102-b. The responding AP 102-b may also calculate the PPDU length and LDPC encoding parameters for the serving users associated with the responding AP 102-b, and may send the information in a CoBF Response 410 to the initiating AP 102-a. At each AP 102, the same LDPC rate matching procedure may be used to determine the final PPDU length and LDPC encoding parameters.

For example, each AP 102 may send the information of the 12-bit length field (L_{LENGTH}) defined in L-SIG, the 2-bit common pre-FEC padding factor subfield (a), the 1-bit LDPC extra symbol segment subfield (b_{LDPC-extra-sym-seg}) and 1-bit PE disambiguity subfield (b_{PE-Disambiguity}) defined in the common field in UHR-SIG in a CoBF Invite 405 or CoBF Response 410 to the other AP 102. If the modified length (e.g., 12 bits) and the paired PE disambiguity (e.g., 1 bit) for the modified length, in place of the length (e.g., 12 bits) and PE disambiguity (e.g., 1 bit) may be sent in the invite 405, these parameters may be used to derive the quantity of OFDM symbols or initial quantity of OFDM symbols in the same way, assuming the quantity of UHR-SIG symbols N_{UHR-SIG,sharingBSS} may be determined based on the number of users in the sharing BSS, and the quantity of UHR-LTF symbols N_{UHR-LTF,sharingBSS} may be determined based on the per-user Nss of users in the sharing BSS, in the derivation. Additionally, or alternatively, each AP 102 may send the information of the 2-bit common pre-FEC padding factor subfield (a) and 1-bit LDPC extra symbol segment subfield (b_{LDPC-extra-sym-seg}) defined in the common field in UHR-SIG, and a 9- or 10-bit quantity of OFDM symbols (N_{SYM}) in a CoBF Invite 405 or CoBF Response 410 to the other AP 102. Additionally, or alternatively, each AP 102 may send the information of the 1-bit LDPC extra symbol segment subfield (b_{LDPC-extra-sym-seg}) defined in the common field in UHR-SIG, a 2-bit initial pre-FEC padding factor (aᵢₙᵢₜ), and a 9- or 10-bit initial quantity of OFDM symbols (N_{SYM,init}) in a CoBF Invite 405 or CoBF Response 410 to the other AP 102.

Each AP 102 may obtain or derive the initial pre-FEC padding factor (aᵢₙᵢₜ) and initial quantity of OFDM symbols (N_{SYM,init}) from the other AP 102. For example, the initial pre-FEC padding factor (a_{init,APj}) and initial quantity of OFDM symbols (N_{SYM,init,APj}) may be the set of parameters of the j^{th} AP 102, where j=1 or 2. Additionally, or alternatively, the common pre-FEC padding factor (a_{APj}), quantity of OFDM symbols (N_{SYM,APj}), and LDPC extra symbol segment (b_{LDPC-extra-sym-seg-APj}) may be the set of parameters of the j^{th} AP 102, where j=1 or 2. The PPDU length and LDPC encoding parameters may be determined based on the initial pre-FEC padding factor and initial quantity of OFDM symbols of each BSS in the same LDPC rate matching algorithm as in multiple users in one BSS.

For example, each AP 102 may first determine the LDPC pre-FEC padding boundary. Each AP 102 may choose a reference BSS, which may have a data field with longer length. The APs 102 may compare the pre-FEC padding boundaries

$$( {N}_{SYM , init , AP 1} - 1 + \frac{{a}_{init , AP 1}}{4} ) and ( {N}_{SYM , init , AP 2} - 1 + \frac{{a}_{init , AP 2}}{4} )$$

to choose the set of parameter of the j^{th} AP, where j=1 or 2, where

$$( {N}_{SYM , init , APj} - 1 + \frac{{a}_{init , APj}}{4} ) \geq ( {N}_{SYM , init , APk} - 1 + \frac{{a}_{init , APk}}{4} ) ,$$

j≠k. If two BSSs have same pre-FEC padding boundaries,

$$( e . g . , ( {N}_{SYM , init , APj} - 1 + \frac{{a}_{init , APj}}{4} ) = ( {N}_{SYM , init , APk} - 1 + \frac{{a}_{init , APk}}{4} ) )$$

and same LDPC extra symbol segment values (e.g., b_{LDPC-3xtra-sym-seg-APj}=b_{LDPC-3xtra-sym-seg-APk}), there may be no need to recalculate the PPDU length and any LDPC encoding parameters. The two BSSs may already share the same set of parameters. If two BSSs have same pre-FEC padding boundaries

$$( e . g . , ( {N}_{SYM , init , APj} - 1 + \frac{{a}_{init , APj}}{4} ) = ( {N}_{SYM , init , APk} - 1 + \frac{{a}_{init , APk}}{4} ) )$$

but different LDPC extra symbol segment values (e.g., i.e., b_{LDPC-3xtra-sym-seg-APj}=1>b_{LDPC-3xtra-sym-seg-APk}=0), the APs 102 may set b_{LDPC-3xtra-sym-seg-APK}=1 and may recalculate the remaining LDPC parameters. If two BSSs have different pre-FEC padding boundaries, e.g.,

$$( {N}_{SYM , init , APj} - 1 + \frac{{a}_{init , APj}}{4} ) > ( {N}_{SYM , init , APk} - 1 + \frac{{a}_{init , APk}}{4} ) ,$$

the APs 102 may choose the j^{th} BSS as the reference BSS, may use an initial pre-FEC padding factor (a_{init,APj}) associated with the reference BSS, and an initial quantity of OFDM symbols (N_{SYM,init,APj}) to be the initial pre-FEC padding factor (aᵢₙᵢₜ) and initial quantity of OFDM symbols (N_{SYM,init}) for the users associated with the k^{th} AP 102. That is, the APs 102 may compare

$$( {N}_{SYM , AP 1} - 1 + \frac{{a}_{AP 1} - {b}_{LDPC - extra - sym - seg - AP 1}}{4} ) and$$

$$( {N}_{SYM , AP 2} - 1 + \frac{{a}_{AP 2} - {b}_{LDPC - extra - sym - seg - AP 2}}{4} )$$

to choose the set of parameter of the j^{th} AP 102, where j=1 or 2, where

$$( {N}_{SYM , APj} - 1 + \frac{{a}_{APj} - {b}_{LDPC - 3 xtra - sym - seg - APj}}{4} ) \geq ( {N}_{SYM , APk} - 1 + \frac{{a}_{APk} - {b}_{LDPC - extra - sym - seg - APk}}{4} ) ,$$

j≠k.

Second, the APs 102 may recalculate the LDPC parameters for the users associated with the other APs 102 (e.g., the k^{th} AP 102). That is, there may be no need to recalculate the LDPC parameters for the users associated with the j^{th} AP of the reference BSS. In order to recalculate the LDPC parameters, the APs 102 may use the LDPC rate matching algorithm, described with respect to Equations 1-21.

Finally, the APs 102 may determine the final LDPC extra symbol segment. If the LDPC extra symbol segment is 1 in at least one BSS, it may be set to 1. Otherwise, it may be 0. Each AP 102 may use the algorithm to update the PPDU length and LDPC encoding parameters individually, and may not exchange further information.

In other implementations, the sharing AP 102 may not know the MCS of users in the sharing BSS at the time of the invite 405. The sharing AP 102 may indicate the maximum total number of spatial streams (Nss,total) allowed for the shared AP 102 in the invite 405. If the shared AP 102 accepts to participate in CoBF transmissions, the shared AP 102 may transmit a total number of spatial streams no greater than the maximum total number of spatial streams allowed for the shared AP 102, as specified in the invite 405. In some cases, the shared AP 102 may only transmit one total spatial stream (e.g., one spatial stream to a single user), and the sharing AP 102 may estimate the highest MCS of each user in the sharing BSS accordingly, the sharing AP 102 may derive the minimum number of data OFDM symbols and the minimum initial number of data OFDM symbols based on the packet sizes of its serving users.

Additionally, or alternatively, assuming that the shared AP may only transmit the total number of spatial streams as the maximum total number of spatial streams allowed for the shared AP 102, as specified in the invite 405, the sharing AP 102 may estimate the lowest MCS of each user in the sharing BSS accordingly and derive the maximum number of data OFDM symbols and maximum initial number of data OFDM symbols based on the packet sizes of its serving users. Additionally, or alternatively, assuming that the shared AP 102 may transmit the total number of spatial streams equals a value from 1 to a maximum total number of spatial streams allowed for the shared AP 102, as specified in the invite 405, the sharing AP 102 may estimate the corresponding MCSs, and derive and indicate the corresponding one or more numbers of data OFDM symbols or one or more initial numbers of data OFDM symbols in the invite 405. Additionally, or alternatively, the sharing AP 102 may only indicate a number of data OFDM symbols or an initial number of Data OFDM Symbols in the invite 405, and it may correspond to the total number of spatial streams transmitted by the shared AP being a certain value. Additionally, or alternatively, the sharing AP 102 may also derive the average number of data OFDM symbols based on the mean value of the minimum and maximum numbers of data OFDM symbols, or the mean value of the numbers of data OFDM symbols, each number derived based on assuming the shared AP 102 may transmit the total number of spatial streams equals from 1 to up to the maximum total number of spatial streams allowed for the shared AP, as specified in the invite 405. The sharing AP 102 may also derive the average initial number of data OFDM symbols based on the mean value of the minimum and maximum initial numbers of data OFDM symbols, or the mean value of the initial numbers of data OFDM symbols, each number derived based on assuming the shared AP may transmit the total number of spatial streams equals from 1 to up to the maximum total number of spatial streams allowed for the shared AP 102, as specified in the invite 405.

In some examples, the sharing AP 102 may indicate the range of data field duration, such as the average number of data OFDM symbols, the minimum number of data OFDM symbols, the maximum number of data OFDM symbols, the average initial number of data OFDM symbols, the minimum initial number of data OFDM symbols, the maximum initial number of data OFDM symbols, or any combinations thereof, in the invite 405. The shared AP 102 may know that the final data field duration (which may be determined by the sharing AP 102 and the 12-bit length may be indicated in the sync 415) may depend on the total number of spatial streams at the shared AP 102. The shared AP 102 may balance a choice of the number of users and per-user number of spatial streams (Nss) in the shared BSS and the expected data field duration, to make a scheduling decision. The shared AP 102 may indicate the per-user Nss in the shared BSS in the response 410.

Upon receiving the response 410, the sharing AP 102 may know the per-user Nss of all scheduled users across two BSSs and thus know the total number of spatial streams across two BSSs. It may derive the per-user MCS and 2×LDPC subfield for users in the sharing BSS, perform rate matching based on the packet sizes, determine the final PPDU length and LDPC encoding parameters such as the length (12 bits), pre-FEC padding factor (2 bits), LDPC extra symbol segment (1 bit) and PE disambiguity (1 bit) and indicate these quantities in the sync 415. In some examples, there may be one or more sets of the pre-FEC padding factor and the LDPC extra symbol segment, which may each be grouped with the one or more quantities of data OFDM symbols, the average quantity of data OFDM symbols, the minimum quantity of data OFDM symbols or the maximum quantity of data OFDM symbols to determine the corresponding one or more data field durations, average data field duration, minimum data field duration and maximum data field duration, respectively. In some examples, there may be one or more sets of the pre-FEC padding factor and the LDPC extra symbol segment, which may each be grouped with the one or more initial quantities of data OFDM symbols, the average initial quantity of data OFDM symbols, the minimum initial quantity of data OFDM symbols or the maximum initial quantity of data OFDM symbols to determine the corresponding one or more data field durations, average data field duration, minimum data field duration and maximum data field duration, respectively. In some examples, the pre-FEC padding factor, the LDPC extra symbol segment, or both may be fixed values. For example, the pre-FEC padding factor may be set to 3 and post-FEC padding may be avoided. The LDPC extra symbol segment may be fixed to 1. Fixing the values of these fields may render them optional and they may, in some examples, be omitted from the any frame, e.g., the invite 405, response 410, and sync 415.

As discussed herein, in some cases, the LDPC extra symbol segment, pre-FEC padding factor, and PE disambiguity may be fixed values, or may be non-baseline information. For example, the LDPC extra symbol segment may be a fixed value, such as 1. In some examples, the pre-FEC padding factor may depend on the per-user MCS. For example, the pre-user MCS in the sharing BSS may be pre-determined by the sharing AP 102 and may be indicated in the invite 405. The sharing AP 102 may determine (e.g., decide) the exact data field duration, including the quantity of data OFDM symbols and the pre-FEC padding factor, based on the packet size or sizes. Although a per-user MCS in the sharing BSS may be unknown at the time of the invite 405, the sharing AP 102 may determine and indicate at least a rough data field duration, and thus may also determine the pre-FEC padding factor. In some examples, the pre-FEC padding factor may be a fixed value (e.g., 3) and post-FEC padding may be avoided or skipped. In some cases, the PE disambiguity may be indicated along the length subfield in the L-SIG in the sync 415 (e.g., synchronization frame, trigger frame) or may be omitted and each AP 102 may derive the PE disambiguity.

FIG. 5 shows an example of a timing diagram 500 that supports CoBF information exchange for transmission phase. The timing diagram 500 may implement, or be implemented by, aspects of the wireless communication network 100, the example PDUs 200 and 300, or the timing diagram 400. For example, the timing diagram 500 may include one or more APs 102, including at least the initiating AP 102-c and the responding AP 102-d, which may be examples of corresponding devices as described herein, including with reference to FIG. 1 and FIG. 4. The techniques described herein in the context of the timing diagram 500 may support the initiating AP 102-a to perform a single frame information exchange with the responding AP 102-b to support C-SR transmission. In some examples, by including an information exchange specific to C-SR transmission, the described techniques may be used to limit interference during the C-SR transmission and improve communication reliability.

In some implementations, such as for C-SR transmission, information exchange between an initiating AP 102-c and a responding AP 102-d may occur in a single frame, rather than a three stage or frame process, as described at FIG. 4. The single frame, an invite/sync 505, may combine information that may have been included in an invite and a trigger, separately, in the three-stage information exchange described at FIG. 4. For example, the initiating AP 102-c may transmit the C-SR invite/sync 505 to the responding AP 102-d, which may include information for the U-SIG, information for the L-SIG, such as the length field, and interference or power control information for the responding AP 102-d. The contents of this information may be described more with respect to FIG. 4. In the single frame procedure, the responding AP 102-d may not transmit a response. In some cases, transmissions form the initiating AP 102-c. such as indicating a C-SR and a second BSS color, may be affected if the responding AP 102-d may not participate in the C-SR but may have no way of indicating that to the initiating AP 102-c. After transmitting the invite/sync 505, the initiating AP 102-c and the responding AP 102-d may perform synchronous transmission of the downlink PPDUs 510 within the shared TXOP 515 per the C-SR procedure.

In some implementations, the information exchange may also be a two frame process, which may allow for asynchronous transmissions. For example, the initiating AP 102-c (e.g., sharing AP 102) may transmit an initialization (e.g., invite frame) for the C-SR procedure and the responding AP 102-d (e.g., shared AP 102) may transmit an initialization response (e.g., response frame). After receiving the response, the initiating AP 102-c may begin the PPDU transmission for the C-SR procedure, and a PHY preamble of the transmission may act as a C-SR indication, or trigger, for the responding AP 102-d, which may then begin PPDU transmission.

Although the single frame information exchange may be illustrated separately from the three-stage information exchange in FIG. 4, aspects of FIG. 4, particularly related to the invite message 405, the response message 410, and the sync message 415, may apply for the single frame information exchange of FIG. 5, as well as the two frame information exchange for asynchronous C-SR described herein.

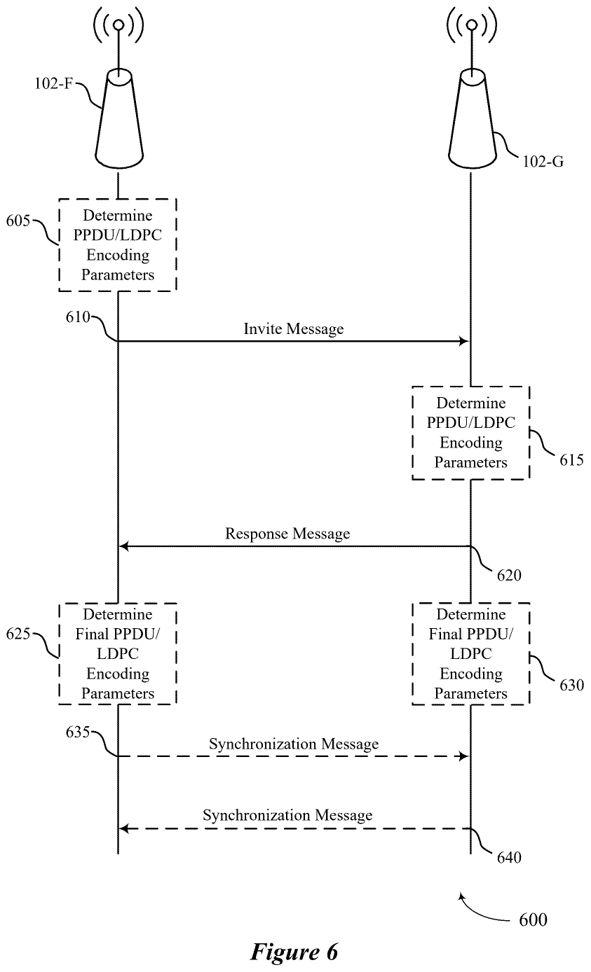

FIG. 6 shows an example of a process flow 600 that supports CoBF information exchange for transmission phase. The process flow 600 may implement, or be implemented by, aspects of the wireless communication network 100, the example PDUs 200 and 300, or the timing diagrams 400 and 500. For example, the process flow 600 may include one or more APs 102, including at least the AP 102-f and the AP 102-g, which may be examples of corresponding devices as described herein, including with reference to FIG. 1, FIG. 4, and FIG. 5. The techniques described herein in the context of the process flow 600 may support the AP 102-f to perform information exchange with the AP 102-g in order to support CoBF and C-SR transmission.

In some implementations, at 605, the AP 102-f may determine, for inclusion in an invite message, as described at 610, or based on information included in a response message, as described further at 620 and 625, one or more PPDU length and LDPC encoding parameters. For example, the AP 102-f may determine one or more PPDU length and LDPC encoding parameters at 605 prior to transmitting the invite message, as described at 610, or, additionally, or alternatively, after receiving the response message, as described at 620.

At 610, in some implementations, the AP 102-f (e.g., initiating AP, first AP, second AP) may transmit, and the AP 102-g (e.g., responding AP, first AP, second AP) may receive, an invite message associated with a CoBF procedure, the invite message including information that pertains to a U-SIG, information that pertains to at least one of a L-SIG and a common field of a UHR-SIG, and user information associated with one or more user fields of the UHR-SIG. In some cases, the information that pertains to the U-SIG may include at least one of a PHY version identifier, a bandwidth associated with the AP 102-f, an indication of uplink or downlink communication associated with the AP 102-f, an indication of a TXOP duration, an identifier associated with the AP 102-f, an identifier associated with the AP 102-g, one or more first parameters associated with a PPDU type and compression mode, an indication of the CoBF procedure, information associated with punctured channels, and an indication of a MCS of the UHR-SIG. In some cases, the information that pertains to at least one of the L-SIG and the common field of the UHR-SIG may include at least one of a GI+LTF size, a quantity of users associated with the AP 102-f and the CoBF procedure, one or more second parameters associated with a PPDU and LDPC encoding, a modified PPDU length, a range of PPDU length, a data field duration, an average quantity of data OFDM symbols, a range of values associated with the data field duration, a minimum quantity of data OFDM symbols, a maximum quantity of data OFDM symbols, a pre-FEC padding factor, an LDPC extra symbol segment, and a PE disambiguity indication. In some cases, the user information associated with one or more user fields of the UHR-SIG, where the user information associated with each user field may include at least one of a STA identifier, an indication of a MCS, an indication of a BSS color, an indication of an AP 102, one or more third parameters associated with LDPC encoding, and an indication of a quantity of spatial streams. In some cases, the invite message may include an invitation for the AP 102-g to participate in the CoBF procedure, an indication of bandwidth information associated with the AP 102-g, synchronization leader information, or both.

At 610, in some implementations, at the AP 102-f may transmit the invite message associated with a CoBF procedure. The invite message may include baseline information that includes control information and preamble information. In some cases, the preamble information may include the information that pertains to the U-SIG, the information that pertains to at least one of the L-SIG and the common field of the UHR-SIG, the user information associated with the one or more user fields of the UHR-SIG, or any combination thereof. In some cases, the control information may include an invitation for the AP 102-g to participate in the CoBF procedure, bandwidth information associated with the AP 102-g, synchronization leader information, an immediate response notification, a MAP scheme, an information type, or any combination thereof. In some cases, the user information associated with one or more user fields of the UHR-SIG may be for users in a sharing BSS, where the sharing BSS may be associated with the AP 102-f.

In some implementations, at 615, the AP 102-g may determine, based on information included in the invite message or for inclusion in the response message, one or more PPDU length and LDPC encoding parameters.

At 620, the AP 102-f may receive, and the AP 102-g may transmit, in response to transmission of the invite message as described at 610, a response message associated with the CoBF procedure. In some cases, the response message may indicate participation by the AP 102-g in the CoBF procedure. In some cases, the response message may include information that pertains to at least one of a second L-SIG and a common field of a second UHR-SIG associated with the second access point, second user information associated with one or more user fields of the second UHR-SIG, bandwidth information associated with the second access point, synchronization leader information, or any combination thereof. In some cases, the response message may include the one or more PPDU length and LDPC encoding parameters, as determined at 615. In some cases, the response message may include second baseline information that may include second control information and second preamble information. The second control information may include an indication of participation of the AP 102-g in the CoBF procedure, bandwidth information associated with the AP 102-g, synchronization leader information, an immediate response notification, a MAP scheme, an information type, or any combination thereof. In some cases, the second user information associated with one or more user fields of the second UHR-SIG may be for users in a shared BSS, where the shared BSS may be associated with the AP 102-g.

The second preamble information may include information that pertains to a second U-SIG, information that pertains to at least one of a second L-SIG and a common field of a second UHR-SIG, second user information associated with one or more user fields of the second UHR-SIG, or any combination thereof. In some examples, the information that pertains to the second U-SIG may include at least one of a PHY version identifier, a bandwidth associated with the AP 102-f, an indication of uplink or downlink communication associated with the AP 102-f, an indication of a TXOP duration, an identifier associated with the AP 102-f, an identifier associated with the AP 102-g, one or more first parameters associated with a PPDU type and compression mode, an indication of the CoBF procedure, information associated with punctured channels, and an indication of a MCS of the second UHR-SIG. In some examples, the information that pertains to at least one of the second L-SIG and the common field of the second UHR-SIG may include at least one of a GI-LTF size, a quantity of users associated with the AP 102-f or the AP 102-g and the CoBF procedure, one or more second parameters associated with a PPDU and LDPC encoding, a modified PPDU length, a range of PPDU length, a data field duration, an average quantity of OFDM data symbols, a range of values associated with the data field duration, a minimum quantity of OFDM data symbols, a maximum quantity of OFDM data symbols, a pre-FEC padding factor, an LDPC extra symbol segment, and a PE disambiguity indication. In some examples, the user information may include user information associated with each user field of the one or more user fields of the second UHR-SIG that may include at least one of a STA identifier, an indication of a MCS, an indication of a BSS color, an indication of an AP 102, one or more third parameters associated with LDPC encoding, and an indication of a number of spatial streams.

In some cases, the first UHR-SIG may be the same UHR-SIG as the second UHR-SIG. In some examples, the first UHR-SIG and the second UHR-SIG may contain the same information, may contain different information, or may contain some overlapping information that may be the same between both UHR-SIGs.

In some implementations, at 625, the AP 102-f may determine final PPDU length and LDPC encoding parameters. The AP 102-f may determine the final PPDU length and LDPC encoding parameters based on previous determinations of PPDU length and LDPC encoding parameters (e.g., may update the PPDU length and LDPC encoding parameters), as described at 605, based on information included in the response message, as described at 620, or both. In some cases, at 625, the AP 102-f may determine one or more LDPC parameters for inclusion in the synchronization message at 635.

In some implementations, at 630, the AP 102-g may determine the final PPDU length and LDPC encoding parameters. The AP 102-g may determine the final PPDU length and LDPC encoding parameters based on previous determinations of PPDU length and LDPC encoding parameters (e.g., may update the PPDU length and LDPC encoding parameters), as described at 615, based on information included in the invite message, as described at 605, or both. In some cases, at 630, the AP 102-g may determine one or more LDPC parameters for inclusion in the synchronization message at 640.

In some implementations, at 635, the AP 102-f may transmit, and the AP 102-g may receive, in response to reception of the response message as described at 620, a synchronization message (e.g., trigger message) that may indicate that the CoBF procedure is to begin. In some cases, the synchronization message may include third baseline information (e.g., second baseline information), where the third baseline information may include third control information (e.g., second control information) and third preamble information (e.g., second preamble information). The third preamble information may include information that pertains to a third U-SIG (e.g., second U-SIG), information that pertains to at least one of a third L-SIG (e.g., second L-SIG) and a common field of a third UHR-SIG (e.g., second UHR-SIG), third user information (e.g., second user information) associated with one or more user fields of the third UHR-SIG, or any combination thereof. In some examples, the third user information associated with one or more user fields of the third UHR-SIG may be for users in a sharing BSS, where the sharing BSS may be associated with the AP 102-f. In some examples, the second user information associated with one or more user fields of the second UHR-SIG may not be included in the response message at 620, and the third user information associated with one or more user fields of the third UHR-SIG may be for users in the sharing BSS associated with the AP 102-f and for users in the shared BSS associated with the AP 102-g (e.g., all users). In some examples, the information that pertains to the third U-SIG may include at least one of a PHY version identifier, a bandwidth associated with the AP 102-f, an indication of uplink or downlink communication associated with the AP 102-f, an indication of a TXOP duration, an identifier associated with the AP 102-f, an identifier associated with the AP 102-g, one or more first parameters associated with a PPDU type and compression mode, an indication of the CoBF procedure, information associated with punctured channels, and an indication of a MCS of the second UHR-SIG. In some examples, the information that pertains to at least one of the third L-SIG and the common field of the third UHR-SIG may include at least one of a GI+LTF size, a quantity of users associated with the AP 102-f and the CoBF procedure, one or more second parameters associated with a PPDU and LDPC encoding, a modified PPDU length, a range of PPDU length, a data field duration, a range of values associated with the data field duration, a minimum quantity of OFDM data symbols, a maximum quantity of OFDM data symbols, a pre-FEC padding factor, an LDPC extra symbol segment, a PE disambiguity indication, or any combination thereof. In some examples, the third user information associated with one or more user fields of the third UHR-SIG may include user information associated with each user field that includes at least one of a STA identifier, an indication of a MCS, an indication of a BSS color, an indication of an AP 102, one or more third parameters associated with LDPC encoding, an indication of a number of spatial streams, or any combination thereof. In some cases, the invite message, the response message, the synchronization message, or any combination thereof may include a trigger frame, wherein the trigger frame may include a BSRP trigger frame, a STA-specific BSRP trigger frame (e.g., a trigger frame that may solicit one or more PPDUs not using one or more TB PPDU formats (e.g., HE/EHT/UHR TB PPDU formats)) (e.g., a BSRP G13 trigger frame), a MU-RTS trigger frame, a MU-RTS TXS trigger frame, a new trigger type frame, or any combination thereof. The invite message, the response message, the synchronization message, or any combination thereof may trigger transmission of a PPDU including a quality of service (QoS) Null frame, a BlockAck frame, a multi-STA BlockACK frame, or any combination thereof.

In some cases, the first UHR-SIG, the second UHR-SIG, the third UHR-SIG, or any combination thereof may be the same UHR-SIG. In some examples, the first UHR-SIG, the second UHR-SIG, the third UHR-SIG, or any combination thereof may contain the same information, may contain different information, or may contain some overlapping information that may be the same between the UHR-SIGs. That is, the information that the respective UHR-SIGs may contain (e.g., the common field of the respective UHR-SIG, the one or more user fields of the respective UHR-SIG) may be the same, may overlap, or may be different.

In some cases, the synchronization message may indicate optional information, where the optional information may include third information that may pertain to the second U-SIG, third information that may pertain to at least one of the second L-SIG and a common field of the second UHR-SIG, third user information associated with one or more user fields of the second UHR-SIG, or any combination thereof. In some examples, the third information that pertains to the second U-SIG may include at least one of an uplink or downlink indication, an indication of one or more BSS colors, information associated with a TXOP, one or more first parameters associated with a PPDU type and compression mode, an indication of a MCS of the UHR-SIG field, an indication of the CoBF procedure, an indication of a quantity of UHR-SIG symbols. In some examples, the third information that pertains to at least one of the second L-SIG and the common field of the second UHR-SIG may include at least one of an indication of a spatial reuse scheme, one or more second parameters associated with a PPDU and LDPC encoding, a pre-FEC padding factor, and information associated with a quantity of users. In some examples, the third user information associated with one or more user fields of the second UHR-SIG may include user information associated with each user field, where the user information associated with each user field may include at least one of an indication of a BSS color, an indication of an access point, information associated with a spatial configuration, and an indication of a number of spatial streams (e.g., quantity of spatial streams).

In other implementations, at 640, the AP 102-f may receive, and the AP 102-g may transmit, in response to reception of the response message as described at 620 and in accordance with a synchronization leader parameter associated with the AP 102-f, the AP 102-g, or both, a synchronization message (e.g., trigger message) that indicates that the CoBF procedure is to begin. In some cases, the synchronization message may include second baseline information, where the second baseline information may include second control information and second preamble information. The second preamble information may include information that pertains to a second U-SIG, information that pertains to at least one of a second L-SIG and a common field of a second UHR-SIG, second user information associated with one or more user fields of the second UHR-SIG, or any combination thereof.

FIGS. 7A and 7B show examples of timing diagrams 700 and 701 (e.g., transmit sequences), respectively, that support CoBF information exchange for a transmission phase. The timing diagrams 700 and 701 may implement, or be implemented by, aspects of the wireless communication network 100, the example PDUs 200 and 300, the timing diagrams 400 and 500, or the process flow 600. The techniques described herein in the context of the timing diagrams 700 and 701 may support multiple frame designs for the information exchange for different MAP schemes.

In some implementations, part of a CoBF information exchange (e.g., transmission phase) may include three frames: the invite 705, response 710, and sync 715 (e.g., synchronization frame) within a shared TXOP 725. Each AP 102 may also exchange initial control frame(s) (ICF) 730 and initial control response(s) (ICR) with serving STAs of the AP 102 to make sure that the STAs may be activated to receive downlink PPDUs 720. There may be different options for transmitting the intra-BSS ICF 730 and ICR 735 frames, as in FIGS. 7A and 7B.

With respect to timing diagram 700, the per-BSS ICF/ICR exchange may be decoupled from the invite 705 and the response 710. That is, the invite 705 and response 710 may be used for communication between APs, and may not solicit responses form the STAs associated with each AP. In some cases, if no scheduled STAs associated with the shared AP 102 (e.g., the responding AP 102-j) may be activated, which may be indicated in the response 710-a, the sync 715-a may indicate transmission form the sharing AP 102 (e.g., the initiating AP 102-h) and not the responding AP 102-j (e.g., no CoBF may occur), or the sync 715-a may be omitted. In some cases, if no scheduled STAs associated with the initiating AP 102-h may be activated, which may be indicated in the invite 705-a, the sync 715-a may indicate transmission from the responding AP 102-j and not the initiating AP 102-h (e.g., no CoBF may occur), or may remain in the CoBF transmission configuration or scheme, with transmission only from the responding AP 102-j (e.g., waste or leave some spatial degrees of freedom unused). Between each frame transmitted in the timing diagram 700, there may be a gap (e.g., SIFS period). Each AP 102 may have an associated silent period 740 after reception of a respective ICR 735. For example, the initiating AP 102-h may transmit an ICF 730-a after receiving the response 710-a (e.g., after a SIFS period), and may receive the ICR 735-a after transmitting the ICF 730-a (e.g., after a SIFS period). The silent period 740-a may last from reception of the ICR 735-a until transmission of the downlink PPDU 720-a. the responding AP 102-j may transmit an ICF 730-b after the initiating AP 102-h may receive the ICR 735-a (e.g., after a SIFS period), and may receive the ICR 735-b after transmitting the ICF 730-b (e.g., after a SIFS period). The silent period 740-b may last from reception of the ICR 735-b until transmission of the downlink PPDU 720-b. After transmission of the DL PPDU 720 (e.g., after a SIFS period), the initiating AP 102-h may transmit a multi-user block acknowledgement (ACK) request (MU-BAR) frame, such as to STAs associated with the initiating AP 102-h. The initiating AP 102-h may receive a block acknowledgement (BA) frame in response (e.g., after a SIFS period). Similarly, the responding AP 102-h may transmit a MU-BAR frame, such as to STAs associated with the initiating AP 102-h, after reception of the BA frame at the initiating AP 102-h. The responding AP 102-j may receive a BA frame in response (e.g., after a SIFS period). Between the end of the DL PPDU 720 and the transmission of the MU-BAR at the responding AP 102-j, the responding AP 102-j may be in a silent period 740.

With respect to timing diagram 701, the intra BSS ICF 730 and ICR 735 exchange may be coupled with the inter-BSS information exchange between the APs 102. For example, each of the CoBF invite 705-b and the response 710-b may act as ICFs 730 that may solicit response from both the STAs associated with the AP 102 and, in some cases, the other AP 102. The other AP 102 may or may not respond with an ICR 735, along with other STAs. The shared AP 102 may respond with the CoBF response 710-b after the ICRs 735 in response to the CoBF invite 705-b. The sharing AP 102 may respond with the CoBF sync 715-b (e.g., synchronization frame) after the ICRs 735 in response to the CoBF response 710-b. Between each frame transmitted in the timing diagram 701, there may be a gap (e.g., SIFS period). For example, the initiating AP 102-k may transmit the CoBF invite 705-b, which may act as an ICF 730. The responding AP 102-m may transmit an ICR 735-d (which may be received at the ICR 735-c), and STAs associated with initiating AP 102-k may, additionally, or alternatively, transmit ICRs 735, which may be received at ICR 735-c. The responding AP 102-m may then transmit the CoBF response 710-b, which may act as an ICF 730. The initiating AP 102-k may transmit an ICR 735-e (which may be received at the ICR 735-f), and STAs associated with responding AP 102-m may, additionally, or alternatively, transmit ICRs 735, which may be received at ICR 735-f. Each AP 102 may have an associated silent period 740 after reception of a respective ICR 735. For example, the initiating AP 102-k may receive the ICR 735-c, and the silent period 740-c may last from reception of the ICR 735-c until transmission of the downlink PPDU 720-c. The responding AP 102-m may receive the ICR 735-f, and the silent period 740-d may last from reception of the ICR 735-d until transmission of the downlink PPDU 720-d. In some cases, the initiating AP 102-k may receive a BA in a BA frame after the downlink PPDU 720-c (e.g., after a SIFS period). The responding AP 102-m may receive a BA concurrently (e.g., a SIFS period after the downlink PPDU 720-d).

With respect to both timing diagrams 700 and 701, in some implementations, the ICFs 730 (e.g., polling frames) may be transmitted as part of a MAP procedure (e.g., Co-TDMA operation), and may be example of buffer status report poll (BSRP) trigger frames. In some implementations, as part of the MAP procedure (e.g., Co-TDMA procedure) and to share a portion of the TXOP (e.g., the shared TXOP 725), a sharing AP 102 (e.g., initiating AP 102) may transmit a multi-user request-to-send (MU-RTS) trigger frame (e.g., an MU-RTS TXOP sharing (TXS) trigger frame) to another non-collocated AP 102 (e.g., the responding AP 102). In some cases, the allocation duration field of the frame may indicate the duration of the time portion. In some cases, the duration field of the frame may be set to the time required to transmit a solicited response frame and one SIFS. In some implementations, as part of the MAP procedure (e.g., Co-TDMA operation), a poll response from a polled AP 102 solicited by the ICF 730 may be carried in a multi-STA block ACK frame (M-BA) frame. In some implementations, in response to the BSRP trigger frame for an ICF 730 transmitted by a non-AP STA as a TXOP holder, an AP 102 may transmit a M-BA frame which may or may not include a block ACK starting sequence control subfield, a block ACK bitmap subfield, or both.

In some implementations, a MU-RTS TXS trigger frame may be implemented for the sync 715. A fixed value (e.g., 3) may be used for the TXS mode subfield to indicate that MAP is implemented, and then a MAP coordination type subfield may be used to indicate the type of MAP scheme (e.g., Co-TDMA, Type-I and Type-II C-SR, Co-BF). In some cases, both subfields may be in the common info field (including a trigger-dependent common info field where the field size and structure may depend on the trigger type). In some examples, some subfields in the common information field may be repurposed to carry new information for another AP 102. In some cases, there may be no redesign of the common information field. These subfields and new information for another AP 102 may be in the special user info field (including the trigger-dependent user info field). In some cases, these subfields and new information for anther AP 102 may be in the AP user info field (e.g., CoBF user info field) (including the trigger-dependent user info field). That is, the UHR variant user info field may be redesigned to accommodate indications of these parameters. In some cases, the receiver address (RA) field may be set to another AP 102, so other APs 102 or STAs won't process the trigger frame, and there may be no need for the AID12 subfield. In some examples, the common user information field and any user information fields (including the trigger-dependent user info field) may be repurposed to carry these subfields and new information for the target AP 102.

In some cases, the CoBF sync 715 may be a MU-RTS TXS frame, which may solicit a clear to send (CTS) frame in response by default. This may not match the CoBF transmission sequence, which may include downlink PPDUs that may be transmitted a SIFS period after the CoBF sync 715. The CTS response may be stopped or disabled. In some examples, a user information field (including the trigger-dependent user info field) may include a fixed AID12 value dedicated for CoBF (and, in some examples, another value for C-SR). Since the AID12 value may not match the AID12 of the shared AP 102, the shared AP 102 may not respond with a CTS. The shared AP 102 may still detect the frame and decode the content of that user information field tagged with the AID12 value dedicated to CoBF or C-SR, but may react by sending the downlink PPDUs and not the CTS. In other examples, a special user information field (including the trigger-dependent user info field) may include the AP ID in the contents. No User Information fields may include an AID12 set to the AP ID of the shared AP 102. A Special User Information field (including the trigger-dependent user info field) may include an AID12 set to some value (e.g., 2007, other values) and the AP ID of the shared AP 102. The shared AP 102 may be mandated to decode the frame including the Special User Information field. After detecting the AP ID of itself within, the shared AP 102 may interpret this as a trigger to send the downlink PPDU (e.g., not the CTS).

With respect to timing diagram 700, the CoBF invite 705-a and the CoBF sync 715-a may be used for communication between APs 102, and may not be used to solicit responses from non-AP STAs associated with the AP 102 (e.g., the initiating AP 102-h) The CoBF invite 705-a and the CoBF sync 715-b may be BSRP trigger frames or MU-RTS trigger frames. The CoBF response 710-a may be a M-BA frame (e.g., in response to a BSRP trigger frame), a BSRP trigger frame, or a MU-RTS trigger frame.

With respect to timing diagram 701, the CoBF invite 705-b and the CoBF response 710-b may be used for communication between APs 102, and may also act as ICFs 730 that solicit responses (e.g., ICR 735) from both the STAs associated with the AP 102 that may transmit the CoBF invite 705-b and the AP 102 that may transmit the CoBF response 710-b, respectively, and the other AP 102. The CoBF invite 705-b and the CoBF response 710-b may be BSRP trigger frames. The CoBF sync 715-b may be used for communication between the APs 102, and may not be used to solicit responses from STAs (e.g., non-AP STAs). The CoBF sync 715-b may be a BSRP trigger frame or a MU-RTS trigger frame.

With respect to both timing diagrams 700 and 701, in some implementations, the BSRP trigger frame may be used for the invite 705 and the sync 715, or the invite 705, response 710, and sync 715. The BSRP trigger frames may or may not solicit responses from non-AP STAs at the same time as communicating with other APs 102. In some implementations, the MU-RTS trigger frame made used for the invite 705, response 710, and sync 715, and may not be used to solicit responses from non-AP STAs. In some implementations, the M-BA frame may be used for the response 710, such as in response to a CoBF invite 705 that may be transmitted as a BSRP trigger frame.

In some implementations, the BSRP trigger frame may implement a frame design. The CoBF or C-SR invite 705, response 710, and synchronization 715 frames may use a UHR variant BSRP Trigger Frame. The trigger type may be a BSRP, which may not include trigger dependent common information or user information. The BSRP trigger frame may include a special user info field (e.g., identified by AID12 value being 2007) and a PHY version identifier may be set to a value (e.g., 1, indicating UHR). In some cases, there may be at least one AP user field to carry PHY information for another AP 102. There may be two types of information for the other AP 102. In some examples, if the BSRP is addressed to multiple STAs including another AP, TB PPDU information may be carried in the UHR variant user information field (e.g., RU allocation, MCS, number (e.g., quantity) of spatial streams, etc.), similar to a user information field for non-AP STAs. This information may be used to solicit an ICR 735 response from the other AP 102 (e.g., using the first AP user information field). In some examples, control and PHY information for another AP 102 may be carrier. In some examples, all control and PHY information for the other AP 102 may be carrier in the one or more AP user information fields (including the trigger-dependent user info field). In other examples, such as if the trigger frame may not solicit a TB response from non-AP STAs, some bits in the common information field (including the trigger-dependent common info field) and special user information field (including the trigger-dependent user info field) may be repurposed, and the one or more AP user information fields may be used. For example, a BSRP trigger frame may include a frame control (e.g., 2 octets), a duration (e.g., 2 octets), a RA (e.g., 6 octets), a transmitter address (TA) (e.g., 6 octets), a common information field (e.g., 8 octets) (including a trigger-dependent common info field where the field size and structure may depend on the trigger type), a special user information field (including a trigger-dependent user info field where the field size and structure may depend on the trigger type) that may indicate a PHY version identifier (e.g., PHY version identifier set to 1 to indicate UHR) (e.g., 5 octets), one or more user information fields (e.g., 5 octets each) that may be UHR variant user information fields for non-AP STAs when non-AP STAs may be present, an AP user information field (e.g., AID set to the AP ID of the other AP or a special AP ID (AID) value (e.g., 2009, 2020, 2011) (e.g., 5 octets) (including the trigger-dependent user info field), one or more user information fields for the other AP 102 if present (e.g., K octets), padding (e.g., variable quantity of octets), and a frame check sequence (FCS) (e.g., 4 octets).

In some cases, the AP user information fields (including the trigger-dependent user info field) may include many options. The first AP user information field (including the trigger-dependent user info field) may be identified by an AID12 value being set to the shared AP's 102 AP ID and may have a total of 5 octets. The sharing AP 102 that may transmit a trigger frame as part of a transmission sequence in a MAP coordinated transmission scheme (e.g., C-SR, CoBF, Co-TDMA), may identify the shared AP 102 via an AP ID carried in the AID12 field of the user information field of the trigger frame. An AP ID may be chosen from values not used by any non-AP STAs (e.g., in a range of {2008-4094} and, in some examples, in particular {2008-2044, 2046-4094}). In some cases, there may be more than one AP user information field and the remaining user information fields (including the trigger-dependent user info field) may have different designs. For example, a remaining user information field may use the same design as the first AP user information field. Additionally, or alternatively, a remaining user information field may be identified by the AID12 value being set to a fixed value (e.g., 2009, 2020, 2011) and may have total 5 octets. Additionally, or alternatively, a remaining user information field may be identified by the AID12 value being set to 4095 (e.g., “Start of Padding field” in HE/EHT) and may have a new fixed size or varying size depending on control information. In some examples, the AID12 value 4094 may be used as a “Start of Padding field” in UHR.

In some cases, in each UHR variant AP information field, a set of bits (e.g., B0-B11) may be the AID12 field. For a five octet design, there may be up to a maximum quantity of bits (e.g., 28 bits (B12-B39)) to carry information for the AP 102. For a K-octet design, there may be a maximum quantity of bits (e.g., (8*K−12) bits) to carry information for the AP 102. Unused bits in each AP information field may be reserved bits. In some cases, since the AP information field may be in a BSRP trigger frame, the trigger dependent user information subfield may not be present, or may use a variable quantity of bits.

In some implementations, as described herein, the various frames may include control information. In some cases, a 3 or 4 bit Multi-AP (MAP) scheme subfield may be added to a frame to indicate the MAP scheme (e.g., No MAP, Co-BF, Type-I Co-SR, Type-II Co-SR, co-TDMA). In some examples, the control information may also indicate other MAP schemes (e.g., Joint Transmission (JT) or (‘JT from multiple APs to a single user’ and ‘JT from multiple APs to multiple users in a single BSS or multiple BSSs’), coordinated OFDMA (Co-OFDMA), coordinated CDMA (Co-CDMA)). In some examples, this field may be an advanced scheme subfield and may further include other techniques like dynamic subchannel operation (DSO), non-primary channel access (NPCA), and the like. In some cases, an information type subfield may also be added. For example, 2 bits may be used to indicate the information type (e.g., ‘Invite’, ‘Acceptance’ (or ‘Response’, ‘Confirmation’), ‘Rejection’, ‘Sync’), or 1 bit may be used to indicate {‘Invite’, ‘Sync’} if the response 710 uses a M-BA frame instead of a trigger frame. The existence, bitwidth, and definition of the information type field may depend on the indicated MAP scheme (or advanced scheme). In some cases, a 1-bit ‘Immediate Response Needed’ subfield may be introduced to indicate if a response right after SIFS may be needed or not. For example, in the synchronization 715, the uplink length subfield in the common information field may be set to a value (e.g., 0) to indicate that there may not be an immediate response. In some cases, a 1-bit Sync-Leader indication subfield may be included in a frame to indicate if the sharing AP 102 is the Sync-Leader or Sync-Follower (e.g., if the Information Type is ‘Invite’). Additionally, or alternatively, a 1-bit Sync-Leader indication subfield may be included in a frame to indicate if the shared AP 102 is the Sync-Leader or Sync-Follower (e.g., if the Information Type is ‘Response’). In some cases, the control information may be indicated in a special user information field (including a trigger-dependent user info field where the field size and structure may depend on the trigger type), a common information field (including a trigger-dependent common info field where the field size and structure may depend on the trigger type), or an AP user information field (including the trigger-dependent user info field).

In some implementations, when a UHR variant BSRP trigger frame may be individually addressed to a single STA (e.g., another AP 102) which may be a BSRP GI3 trigger frame (by setting the GI And HE/UHR-LTF Type field to 3), in addition to original reserved bits (e.g., B22, B26, B53, B63 in the common information field (including the trigger-dependent common info field), B37-B39 in the special user information field (including the trigger-dependent user info field) where the AID12 field is set to 2007), some bits (e.g., B23-B54 (e.g., the Number Of HE/UHR-LTF field, the LDPC Extra Symbol Segment field, the AP Tx Power field, the Pre-FEC Padding Factor field, the PE Disambiguity field, the UL Spatial Reuse field and the HE/UHR P160 field) and B56-B63) of the common information field may be reserved, and the user information field with the AID12 field set to the STA's AID (e.g., the AP ID as the first AP user information field) (including the trigger-dependent user info field) or a special AID value, e.g., 2009, 2010, 2011, and all the other fields of this user information field (e.g., 28 bits from B12-B39) may be reserved. These bits may be used to carry information for another AP 102. In some examples, one or more successive AP user information fields (e.g., AID set to the AP ID or a special AID value, e.g., 2009, 2010, 2011) (e.g., 5 octets) (e.g., AID set to 4095 and with size of K octets) (including the trigger-dependent user info field) may be present before the padding and FCS and may carry information for another AP 102.

In some implementations, the MU-RTS trigger frame may implement a frame design. For example, the CoBF or C-SR invite 705, response 710, or synchronization 715 frames may use a UHR variant MU-RTS trigger frame (e.g., an MU-RTS TXS trigger frame where the TXS mode may be set to 3). In some cases, a trigger type may be MU-RTS (e.g., without trigger dependent common information or user information). In some cases, the MU-RTS trigger frame may include one special user information field (e.g., identified by AID12 value being 2007) (including the trigger-dependent user info field), and a PHY version identifier may be a fixed value (e.g., 1, indicating UHR). In some cases, the MU-RTS trigger frame may include at least one AP user information field (including the trigger-dependent user info field) to carry PHY info for another AP 102, which may carry control information and PHY information. In some examples, the control and PHY information for the other AP 102 may be carried in one or more AP user information fields (including the trigger-dependent user info field). In other examples, if the trigger frame does not solicit TB responses from the non-AP STAs, the MU-RTS trigger frame may include some bits in the common information field and the special user information field (including the trigger-dependent user info field) that may repurposed for carrying the control and PHY information, and the one or more AP user information fields may be used. In some examples, in an MU-RTS trigger frame, the uplink length (e.g., bits B4-B15) and subfields in one or more sets of bits (e.g., bits B22-B53 and B56-B63 in the common information field, B17-B39 in the special user information field (including the trigger-dependent user info field), and B20-B39 in the EHT/UHR variant user information fields) may be reserved. These bits may be used to carry information for another AP 102. For example, a MU-RTS trigger frame may include a frame control (e.g., 2 octets), a duration (e.g., 2 octets), a RA (e.g., 6 octets), a TA (e.g., 6 octets), a common information field (e.g., 8 octets), a special user information field (including the trigger-dependent user info field) that may indicate a PHY version identifier (e.g., PHY version identifier set to 1 to indicate UHR) (e.g., 5 octets), a first AP user information field (e.g., AID set to an AP ID or a special AID value, e.g., 2009, 2010, 2011) (e.g., 5 octets) (including the trigger-dependent user info field), one or more successive AP user information fields for the other AP 102 if present (e.g., K octets), padding (e.g., variable quantity of octets), and a FCS (e.g., 4 octets).

In some implementations, the M-BA frame may implement a frame design. That is, the CoBF or C-SR response 710 frames may use a M-BA frame. In some cases, the BA type may be multi-STA. In some cases, the BA information field of the M-BA frame may include one or more per-AID TID Information subfields. In some cases, the AID11 subfield in the AID TID information subfield may be set to 0 to indicate that the response 710 may be sent to an AP 102. The identifier of the sharing AP 102 (e.g., the AP ID or BSS color) may be indicated in the RA field or in a BlockAckBitmap subfield. Additionally, or alternatively, the AID11 subfield may be set to the AP ID of the sharing AP. In some cases, the ACK Type subfield and TID subfield values may use a combination (e.g., ACK Type subfield set to 0 or 1 and TID subfield set to 8-13, or ACK Type subfield set to 0 and TID subfield set to 14) for a MAP response 710. in some examples, one combination may be used to indicate both ‘Acceptance’ and ‘Rejection’. Additionally, or alternatively, different combinations may be used to indicate the information type being ‘Acceptance’ (or ‘Confirmation’) or ‘Rejection’. In some examples, the existence and size of BlockAckBitmap may depend on the value of the information type. For example, a TID subfield may be set to 14 and an ACK Type subfield may be set to 0, which may indicate the BlockAckBitmap is present (e.g., ‘Acceptance’), or the ACK Type subfield may be set to 1 to indicate that the BlockAckBitmap is not present (e.g., ‘Rejection’). That is, for an information type of ‘Acceptance’, a BlockAckStartingSequence subfield and the BlockAckBitmap subfield may be included. The BlockAckBitmap may have at least 8 octets. In some examples, the BlockAckBitmap may have 8, 16, or 32 octets. The first two bits (e.g., B1-B2) in the BlockAckStartingSequence subfield may be set to 0, 1 or 2. In some cases, remaining control and PHY information for the sharing AP 102 may be indicated in the BlockAckBitmap. For example, an information type of ‘Rejection’, the BlockAckBitmap size may be 0. In other examples, a TID subfield may be set to 14 and an ACK Type subfield may be set to 0, which may indicate the BlockAckBitmap may be present, for both ‘Acceptance’ and ‘Rejection’. In some cases, the size of the BlockAckBitmap may be different for the information types of ‘Acceptance’ and ‘Rejection’. In sone examples, the information type of ‘Acceptance’ may be indicated by the BlockAckBitmap and may have a size greater than 4 octets (e.g., 8, 16, or 32 octets). The first two bits (e.g., B1-B2) in the BlockAckStartingSequence subfield may be set to 0, 1 or 2. In some cases, remaining control and PHY information for the sharing AP 102 may be indicated in the BlockAckBitmap. The information type of ‘Rejection’ may be indicated by the BlockAckBitmap may have a size of 4 octets. The first two bits (e.g., B1-B2) in the BlockAckStartingSequence subfield may be set to 3. in some cases, some control and PHY information for the sharing AP 102 may be indicated in the BlockAckBitmap. The information may include the bandwidth of the shared AP, the punctured channel information of the shared AP, or other parameters for negotiation on the bandwidth, PPDU length, maximum total quantity of spatial streams allowed for the shared AP 102. In other cases, the size of the BlockAckBitmap may be same for the information types of ‘Acceptance’ and ‘Rejection’, and the differentiation between ‘Acceptance’ and ‘Rejection’ may be based on explicit indication of the information type in a subfield. In some examples, the baseline PHY information that may be included in the BlockAckBitmap may include a 1-bit field to indicate whether 0.8GI may be allowed.

In some cases, the BlockAckBitmap design for the response 710 may be a minimum size of 8 octets for control and PHY information for up to three users. Tables 37 and 38 may be examples of the minimum size BlockAckBitmap. Table 39 may be an example of a BlockAckBitmap with byte alignment. In some cases, for byte alignment, the BlockAckBitmap may be fixed at 16 octets to carry control information, PHY common information and user information for up to 3 users in the shared BSS, or may use a varying size that may depend on the number of users in the shared BSS or may allow for padding in the BlockAckBitmap. In some cases, for padding, the BlockAckBitmap may contain more octets (e.g., 32, 64, 128 octets for padding purposes).

TABLE 37
Example of a BlockAckBitmap for a Response 710 (Minimum Size, without 0.8GI Allowed)

| Bits | B0-B2 | B3-B5 | B6 | B7 | B8-B9 | B10-B20 | B21-B25 | B26 |
|---|---|---|---|---|---|---|---|---|
| Response | PHY | MAP | Information | Extra | Quantity | STA ID | MCS | Nss |
| 710 | Version | Scheme | Type | LTF | of CoBF | | | |
| Parameter | Identifier | | | Allowed | Users in | | | |
| | | | | | Shared | | | |
| | | | | | BSS | | | |

| Bits | B27 | B28-B38 | B39-B43 | B44 | B45 | B46-B56 | B57-B61 | B62 | B63 |
|---|---|---|---|---|---|---|---|---|---|
| Response | 2xLDPC | STA ID | MCS | Nss | 2xLDPC | STA ID | MCS | Nss | 2xLDPC |
| 710 | | | | | | | | | |
| Parameter | | | | | | | | | |

TABLE 38
Example of a BlockAckBitmap for a Response 710 (Minimum Size, with 0.8GI Allowed)

| Bits | B0-B2 | B3-B5 | B6 | B7 | B8-B9 | B10-B20 | B21-B25 | B26 |
|---|---|---|---|---|---|---|---|---|
| Response | PHY | MAP | 0.8GI | Extra | Quantity | STA ID | MCS | Nss |
| 710 | Version | Scheme | Allowed | LTF | of CoBF | | | |
| Parameter | Identifier | | | Allowed | Users in | | | |
| | | | | | Shared | | | |
| | | | | | BSS | | | |

| Bits | B27 | B28-B38 | B39-B43 | B44 | B45 | B46-B56 | B57-B61 | B62 | B63 |
|---|---|---|---|---|---|---|---|---|---|
| Response | 2xLDPC | STA ID | MCS | Nss | 2xLDPC | STA ID | MCS | Nss | 2xLDPC |
| 710 | | | | | | | | | |
| Parameter | | | | | | | | | |

TABLE 39
Example of a BlockAckBitmap for a Response 710 (With Byte Alignment)

| Bits | B0-B2 | B3-B5 | B6 | B7 | B8 | B9-B10 | B11 |
|---|---|---|---|---|---|---|---|
| Response | PHY | MAP | Information | Reserved | Extra | Quantity | 0.8GI Allowed |
| 710 | Version | Scheme | Type | | LTF | of CoBF | |
| Parameter | Identifier | | | | Allowed | Users in | |
| | | | | | | Shared | |
| | | | | | | BSS | |

| Bits | B12-B15 | B16-B26 | B27-B31 | B32 | B33 | B34-B39 | B40-B50 | B51-B55 |
|---|---|---|---|---|---|---|---|---|
| Response | Reserved | STA ID | MCS | Nss | 2xLDPC | Reserved | STA ID | MCS |
| 710 | | | | | | | | |
| Parameter | | | | | | | | |

| Bits | B56 | B57 | B51-B55 | B64-B74 | B75-B79 | B80 | B81 | B82-B127 |
|---|---|---|---|---|---|---|---|---|
| Response | Nss | 2xLDPC | Reserved | STAID | MCS | Nss | 2xLDPC | Reserved |
| 710 | | | | | | | | |
| Parameter | | | | | | | | |

In some cases, as described herein, the response 710 frames may include control information. In some cases, a 3 or 4 bit Multi-AP (MAP) scheme subfield may be added to a frame to indicate the MAP scheme (e.g., No MAP, Co-BF, Type-I Co-SR, Type-II Co-SR, co-TDMA). In some examples, the control information may also indicate other MAP schemes (e.g., Joint Transmission (JT) or (‘JT from multiple APs to a single user’ and ‘JT from multiple APs to multiple users in a single BSS or multiple BSSs’), coordinated OFDMA (Co-OFDMA), coordinated CDMA (Co-CDMA)). In some examples, this field may be an advanced scheme subfield and may further include other techniques like dynamic subchannel operation (DSO), non-primary channel access (NPCA), and the like. In some cases, an information type subfield may also be added. For example, one bit may be included to indicate either ‘Acceptance (or ‘Response’) or ‘Rejection’. In some examples, a 1-bit ‘Immediate Response Needed’ subfield may be introduced to indicate if a response right after SIFS may be needed or not.

In some examples, the CoBF invite 705 may use a BSRP trigger frame or an MU-RTS trigger frame. The trigger frame may include two AP user information fields (e.g., AID12 subfield set to the AP ID of the shared AP), which may have up to 56 bits (e.g., 28×2 bits) and may include a Sync-Leader indication (1 bit), a bandwidth of the PPDU sent by the initiating AP 102-a (3 bits), a punctured channel information (e.g., 5 bits), a minimum quantity of data OFDM symbols (9 bits), a maximum quantity of data OFDM symbols (9 bits), a GI+LTF Size (e.g., 1 bit to indicate {2×LTF+1.6 us GI, 4×LTF+3.2 us GI}), a Maximum Total Nss allowed for the shared AP (2 bits to indicate {1, 2, 3}), a quantity of CoBF users served by the sharing AP (e.g., initiating AP 102-a) (e.g., 1 bit to indicate 1 user or 2 users), and information for two users (e.g., 12 bits for each user) in the sharing BSS where the information for each user include a station identification (11 bits) and a number of spatial streams (Nss, 1 bit to indicate 1 or 2 spatial streams). The special user info field may include a PHY Version Identifier (e.g., 3 bits). Reserved bits in the common info field or special user info field (including a trigger-dependent common info field where the field size and structure may depend on the trigger type) may include an information type (e.g., 2 bits, indicate the invite 705, the response 710, or the sync 715), a MAP scheme subfield (e.g., 3 bits to indicate ‘CoBF’, ‘Type-I C-SR’, ‘Type-II C-SR’, etc.), and an immediate response notification (1 bit). In some examples, if the invite 705 uses a BSRP trigger frame is individually addressed to the shared AP, or an MU-RTS trigger frame, the reserved bits in the common info field (including the trigger-dependent common info field) and special user info field (including the trigger-dependent user info field) may be used to carry some of the aforementioned information. Any unused reserved bits and additional AP user information fields (including the trigger-dependent user info field) may further carry some optional information, such as the BSS color of the sharing AP (e.g., 6 bits), the BSS color of the shared AP (e.g., 6 bits), a TXOP (7 bits), an LDPC extra symbol segment (e.g., 1 bit), a pre-FEC padding factor (e.g., 2 bits), a PE disambiguity (e.g., 1 bit), or any combination thereof.

In some examples, the CoBF Response 710 may use a BSRP trigger frame or an MU-RTS trigger frame. The trigger frame may include two AP user information fields (e.g., AID12 subfield set to the AP ID of the sharing AP) (including the trigger-dependent user info field), which may have up to 56 bits (e.g., 28×2 bits) and may include an indication of Extra LTF Allowed (1 bit), a quantity of CoBF users served by the shared AP 102 (e.g., responding AP 102-b) (e.g., 1 bit to indicate 1 user or 2 users), and information for two users (e.g., 18 bits for each user) in the shared BSS, where the information for each user include a station identification (11 bits), MCS (5 bits), a number of spatial streams (Nss, 1 bit to indicate 1 or 2 spatial streams), an indication of enabling or disabling 2×LDPC (1 bit). The special user info field may include a PHY Version Identifier (e.g., 3 bits). Reserved bits in the common info field or special user info field (including the trigger-dependent common info field) may include an information type (e.g., 2 bits, indicate the invite 705, the response 710, or the sync 715), a MAP scheme subfield (e.g., 3 bits to indicate ‘CoBF’, ‘Type-I C-SR’, ‘Type-II C-SR’, etc.), and an immediate response notification (1 bit). In some examples, if the response 710 uses a BSRP trigger frame is individually addressed to the sharing AP, or an MU-RTS trigger frame, the reserved bits in the common info field (including the trigger-dependent common info field) and special user info field (including the trigger-dependent user info field) may be used to carry some of the aforementioned information. Any unused reserved bits, unused bits in the first two AP user information fields and additional AP user information fields (including the trigger-dependent user info field) may further carry some optional information, such as the BSS color of the sharing AP (e.g., 6 bits), the BSS color of the shared AP (e.g., 6 bits), a TXOP (7 bits), an LDPC extra symbol segment (e.g., 1 bit), a pre-FEC padding factor (e.g., 2 bits), a PE disambiguity (e.g., 1 bit), or any combination thereof.

In some examples, the CoBF sync 715 may use a BSRP trigger frame or an MU-RTS trigger frame (and, in some examples, Type-I and Type-II C-SR trigger/sync (e.g., C-SR sync 715) frames may be BSRP trigger frames or MU-RTS trigger frames). The trigger frame may include one AP user information field (e.g., AID12 subfield set to the AP ID of the shared AP 102) (including the trigger-dependent user info field), which may have up to 28 bits and may include a length in L-SIG (e.g., 12 bits), a Number Of UHR-LTF Symbols (3 bits), a PE disambiguity (e.g., 1 bit), and information for two users (e.g., 6 bits for each user) in the sharing BSS, where the information for each user include a MCS (5 bits) and an indication of enabling or disabling 2×LDPC (1 bit). The special user info field may include a PHY Version Identifier (e.g., 3 bits). Reserved bits in the common info field or special user info field (including the trigger-dependent common info field) may include an information type (e.g., 2 bits, indicate the invite 705, the response 710, or the sync 715), a MAP scheme subfield (e.g., 3 bits to indicate ‘CoBF’, ‘Type-I C-SR’, ‘Type-II C-SR’, etc.), and an immediate response notification (1 bit). In some examples, if the sync 415 uses a BSRP trigger frame is individually addressed to the sharing AP, or an MU-RTS trigger frame, the reserved bits in the common info field and special user info field (including the trigger-dependent common info field) may be used to carry some of the aforementioned information. Any unused reserved bits, unused bits in the first two AP user information fields and additional AP user information fields (including the trigger-dependent user info field) may further carry some optional information, such as the BSS color of the sharing AP 102 (e.g., 6 bits), the BSS color of the shared AP (e.g., 6 bits), a TXOP (7 bits), an uplink/downlink indication (1 bit), a PPDU Type And Compression Mode (2 bits), a CoBF/C-SR Indication (1 bit), a bandwidth (3 bits), a punctured channel information (5 bits), a UHR-SIG MCS (1-2 bits), a quantity of UHR-SIG Symbols (1-5 bits), a Spatial Reuse (1-4 bits), a GI+LTF Size (1-2 bits), an LDPC extra symbol segment (e.g., 1 bit), a pre-FEC padding factor (e.g., 2 bits), a Number of CoBF Users (i.e., Number of Non-OFDMA Users, 2-3 bits), and information for four users (e.g., 21-22 bits for each user) across two BSSs, where the information for each user include a station identification (11 bits), MCS (5 bits), a spatial configuration (4 bits) and an indication of enabling or disabling 2×LDPC (1 bit), or any combination thereof.

In some examples, the CoBF Response 710 may use a multi-STA BlockAck frame. The TID subfield may be set to 14 and an ACK Type subfield may be set to 0, to indicate the BlockAckBitmap is present (e.g., ‘Acceptance’), or the ACK Type subfield may be set to 1 to indicate that the BlockAckBitmap is not present (e.g., ‘Rejection’). That is, for an information type of ‘Acceptance’, a BlockAckStartingSequence subfield and the BlockAckBitmap subfield may be included. The BlockAckBitmap may have 8 octets. The first two bits (e.g., B1-B2) in the BlockAckStartingSequence subfield may be set to 0. The BlockAckBitmap may include an indication of Extra LTF Allowed (1 bit), a quantity of CoBF users served by the shared AP (e.g., responding AP 102-b) (e.g., 1 bit to indicate 1 user or 2 users), and information for two users (e.g., 18 bits for each user) in the shared BSS, where the information for each user include a station identification (11 bits), MCS (5 bits), a number of spatial streams (Nss, 1 bit to indicate 1 or 2 spatial streams), an indication of enabling or disabling 2×LDPC (1 bit), a PHY Version Identifier (e.g., 3 bits), a MAP scheme subfield (e.g., 3 bits to indicate ‘CoBF’, ‘Type-I C-SR’, ‘Type-II C-SR’, etc.), and an immediate response notification (1 bit). Any unused bits in the BlockAckBitmap may further carry some optional information, such as the BSS color of the sharing AP (e.g., 6 bits), the BSS color of the shared AP (e.g., 6 bits), a TXOP (7 bits), an LDPC extra symbol segment (e.g., 1 bit), a pre-FEC padding factor (e.g., 2 bits), a PE disambiguity (e.g., 1 bit), or any combination thereof.

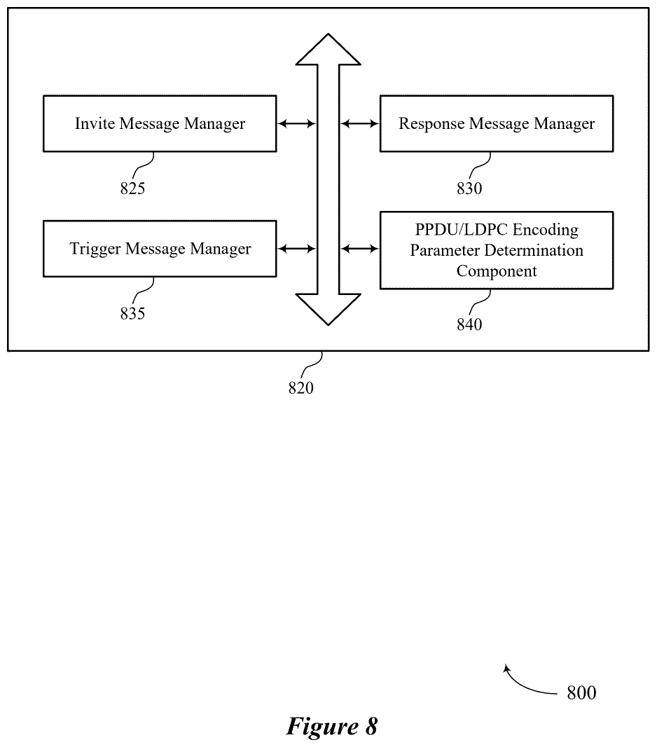

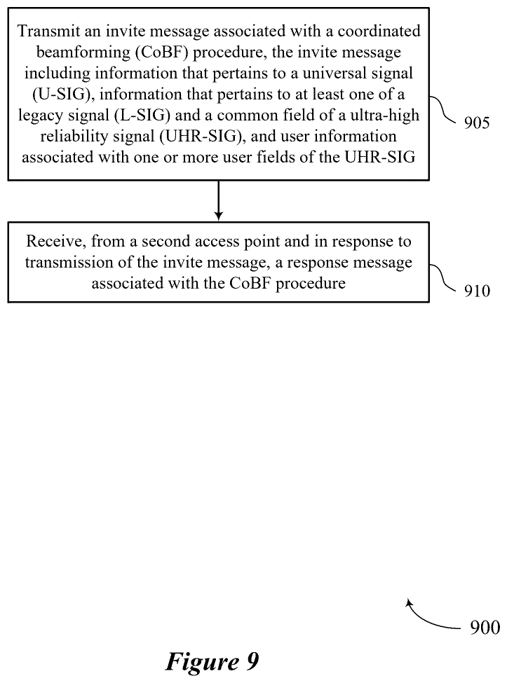

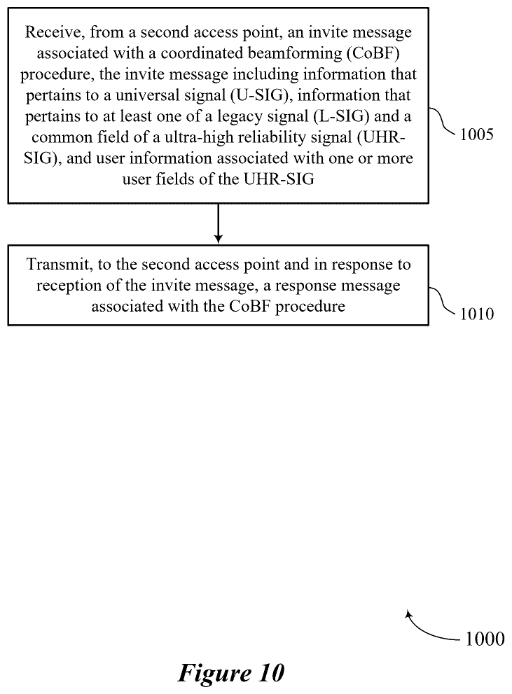

FIG. 8 shows a block diagram of an example wireless communication device 800 that supports CoBF information exchange for a transmission phase. In some examples, the wireless communication device 800 is configured to perform the processes 900 and 1000 described with reference to FIGS. 9 and 10, respectively. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is then passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 800 can be configurable or configured for use in an AP, such as the AP 102 described with reference to FIG. 1. In some other examples, the wireless communication device 800 can be an AP that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some examples, the wireless communication device 800 also includes or can be coupled with one or more application processors which may be further coupled with one or more other memories. In some examples, the wireless communication device 800 further includes at least one external network interface coupled with the processing system that enables communication with a core network or backhaul network that enables the wireless communication device 800 to gain access to external networks including the Internet.

The wireless communication device 800 includes an invite message manager 825, a response message manager 830, a trigger message manager 835, and an PPDU/LDPC encoding parameter determination component 840. Portions of one or more of the invite message manager 825, the response message manager 830, the trigger message manager 835, and the PPDU/LDPC encoding parameter determination component 840 may be implemented at least in part in hardware or firmware. For example, one or more of the invite message manager 825, the response message manager 830, the trigger message manager 835, and the PPDU/LDPC encoding parameter determination component 840 may be implemented at least in part by at least a processor or a modem. In some examples, portions of one or more of the invite message manager 825, the response message manager 830, the trigger message manager 835, and the PPDU/LDPC encoding parameter determination component 840 may be implemented at least in part by a processor and software in the form of processor-executable code stored in memory.

The wireless communication device 800 may support wireless communications in accordance with examples as disclosed herein. The invite message manager 825 is configurable or configured to transmit an invite message associated with a CoBF procedure, the invite message including information that pertains to a universal signal (U-SIG), information that pertains to at least one of a legacy signal (L-SIG) and a common field of a ultra-high reliability signal (UHR-SIG), and user information associated with one or more user fields of the UHR-SIG. The response message manager 830 is configurable or configured to receive, from a second access point and in response to transmission of the invite message, a response message associated with the CoBF procedure.

In some examples, the trigger message manager 835 is configurable or configured to transmit, in response to reception of the response message, a trigger message that indicates that the CoBF procedure is to begin.

In some examples, the trigger message manager 835 is configurable or configured to receive, in accordance with the response message and in accordance with a synchronization leader parameter associated with the first access point, a trigger message that indicates that the CoBF procedure is to begin.

In some examples, the PPDU/LDPC encoding parameter determination component 840 is configurable or configured to determine, for inclusion in the invite message or based on information included in the response message, one or more physical layer protocol data unit (PPDU) length and low-density parity-check (LDPC) encoding parameters.

In some examples, the information that pertains to the U-SIG includes at least one of a PHY version identifier, a bandwidth associated with the first access point, an indication of uplink or downlink communication associated with the first access point, an indication of a transmission opportunity, an identifier associated with the second access point, one or more first parameters associated with a physical layer protocol data unit (PPDU), an indication of the CoBF procedure, information associated with a punctured channel, and an indication of a modulation and coding scheme. In some examples, the information that pertains to at least one of the L-SIG and the common field of the UHR-SIG includes at least one of a guard interval and long training field size, a quantity of users associated with the CoBF procedure, one or more second parameters associated with a physical layer protocol data unit (PPDU) and low-density parity-check (LDPC) encoding. In some examples, the user information associated with one or more user fields of the UHR-SIG includes at least one of a station identifier, an indication of a modulation and coding scheme, one or more third parameters associated with low-density parity-check (LDPC) encoding, an indication of enabling or disabling 2×LDPC, and an indication of a number of spatial streams.

In some examples, the invite message includes an invitation for the second access point to participate in the CoBF procedure, bandwidth information associated with second access point, synchronization leader information, or any combination thereof.

In some examples, the response message indicates participation by the second access point in the CoBF procedure.

In some examples, the response message includes information that pertains to at least one of a second L-SIG and a common field of a second UHR-SIG associated with the second access point, second user information associated with one or more user fields of the second UHR-SIG, bandwidth information associated with the second access point, synchronization leader information, or any combination thereof.

Additionally, or alternatively, the wireless communication device 800 may support wireless communications in accordance with examples as disclosed herein. In some examples, the invite message manager 825 is configurable or configured to receive, from a second access point, an invite message associated with a CoBF procedure, the invite message including information that pertains to a universal signal (U-SIG), information that pertains to at least one of a legacy signal (L-SIG) and a common field of a ultra-high reliability signal (UHR-SIG), and user information associated with one or more user fields of the UHR-SIG. In some examples, the response message manager 830 is configurable or configured to transmit, to the second access point and in response to reception of the invite message, a response message associated with the CoBF procedure.

In some examples, the trigger message manager 835 is configurable or configured to receive, in accordance with transmission of the response message, a trigger message that indicates that the CoBF procedure is to begin.

In some examples, the trigger message manager 835 is configurable or configured to transmit, in accordance with the response message and in accordance with a synchronization leader parameter associated with the first access point, a trigger message that indicates that the CoBF procedure is to begin.

In some examples, the PPDU/LDPC encoding parameter determination component 840 is configurable or configured to determine, based on information included in the invite message or for inclusion in the response message, one or more physical layer protocol data unit (PPDU) length and low-density parity-check (LDPC) encoding parameters.

In some examples, the information that pertains to the U-SIG includes at least one of a PHY version identifier, a bandwidth associated with the first access point, an indication of uplink or downlink communication associated with the first access point, an indication of a transmission opportunity, an identifier associated with the second access point, one or more first parameters associated with a physical layer protocol data unit (PPDU), an indication of the CoBF procedure, information associated with a punctured channel, and an indication of a modulation and coding scheme. In some examples, the information that pertains to at least one of the L-SIG and the common field of the UHR-SIG includes at least one of a guard interval and long training field size, a quantity of users associated with the CoBF procedure, one or more second parameters associated with a physical layer protocol data unit (PPDU) and low-density parity-check (LDPC) encoding. In some examples, the user information associated with one or more user fields of the UHR-SIG includes at least one of a station identifier, an indication of a modulation and coding scheme, one or more third parameters associated with low-density parity-check (LDPC) encoding, an indication of enabling or disabling 2×LDPC, and an indication of a number of spatial streams.

In some examples, the invite message includes an invitation for the first access point to participate in the CoBF procedure, bandwidth information associated with first access point, synchronization leader information, or any combination thereof.

In some examples, the response message indicates participation by the second access point in the CoBF procedure.

In some examples, the response message includes information that pertains to at least one of a second L-SIG and a common field of a second UHR-SIG associated with the first access point, second user information associated with one or more user fields of the second UHR-SIG, bandwidth information associated with the first access point, synchronization leader information, or any combination thereof.

FIG. 9 shows a flowchart illustrating an example process 900 performable by or at a first access point that supports CoBF information exchange for a transmission phase. The operations of the process 900 may be implemented by a first access point or its components as described herein. For example, the process 900 may be performed by a wireless communication device, such as the wireless communication device 800 described with reference to FIG. 8, operating as or within a wireless AP. In some examples, the process 900 may be performed by a wireless AP, such as one of the APs 102 described with reference to FIG. 1.

In some examples, in 905, the first access point may transmit an invite message associated with a CoBF procedure, the invite message including information that pertains to a universal signal (U-SIG), information that pertains to at least one of a legacy signal (L-SIG) and a common field of a ultra-high reliability signal (UHR-SIG), and user information associated with one or more user fields of the UHR-SIG. The operations of 905 may be performed in accordance with examples as disclosed herein. In some implementations, aspects of the operations of 905 may be performed by an invite message manager 825 (e.g., using one or more processors, memory, or other components of the wireless communication device 800) as described with reference to FIG. 8.

In some examples, in 910, the first access point may receive, from a second access point and in response to transmission of the invite message, a response message associated with the CoBF procedure. The operations of 910 may be performed in accordance with examples as disclosed herein. In some implementations, aspects of the operations of 910 may be performed by a response message manager 830 (e.g., using one or more processors, memory, or other components of the wireless communication device 800) as described with reference to FIG. 8.

FIG. 10 shows a flowchart illustrating an example process 1000 performable by or at a first access point that supports CoBF information exchange for a transmission phase. The operations of the process 1000 may be implemented by a first access point or its components as described herein. For example, the process 1000 may be performed by a wireless communication device, such as the wireless communication device 800 described with reference to FIG. 8, operating as or within a wireless AP. In some examples, the process 1000 may be performed by a wireless AP, such as one of the APs 102 described with reference to FIG. 1.

In some examples, in 1005, the first access point may receive, from a second access point, an invite message associated with a CoBF procedure, the invite message including information that pertains to a universal signal (U-SIG), information that pertains to at least one of a legacy signal (L-SIG) and a common field of a ultra-high reliability signal (UHR-SIG), and user information associated with one or more user fields of the UHR-SIG. The operations of 1005 may be performed in accordance with examples as disclosed herein. In some implementations, aspects of the operations of 1005 may be performed by an invite message manager 825 (e.g., using one or more processors, memory, or other components of the wireless communication device 800) as described with reference to FIG. 8.

In some examples, in 1010, the first access point may transmit, to the second access point and in response to reception of the invite message, a response message associated with the CoBF procedure. The operations of 1010 may be performed in accordance with examples as disclosed herein. In some implementations, aspects of the operations of 1010 may be performed by a response message manager 830 (e.g., using one or more processors, memory, or other components of the wireless communication device 800) as described with reference to FIG. 8.

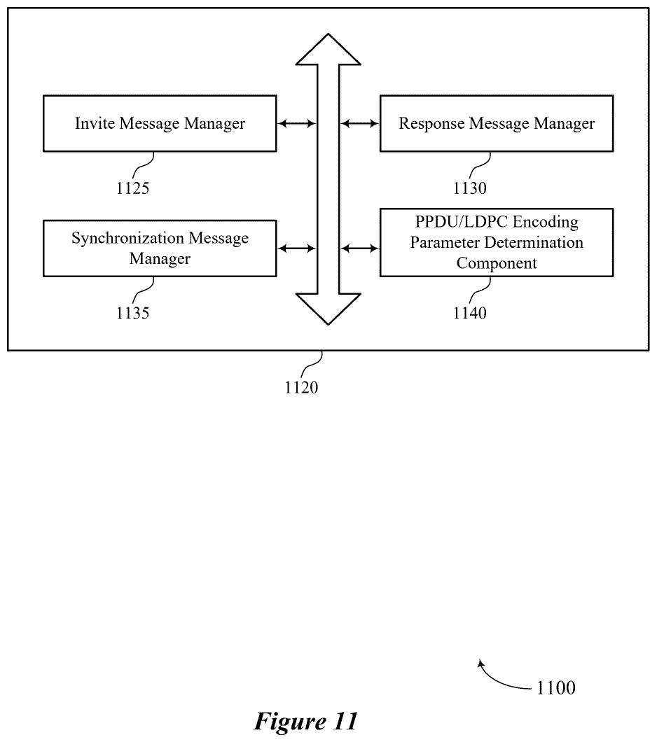

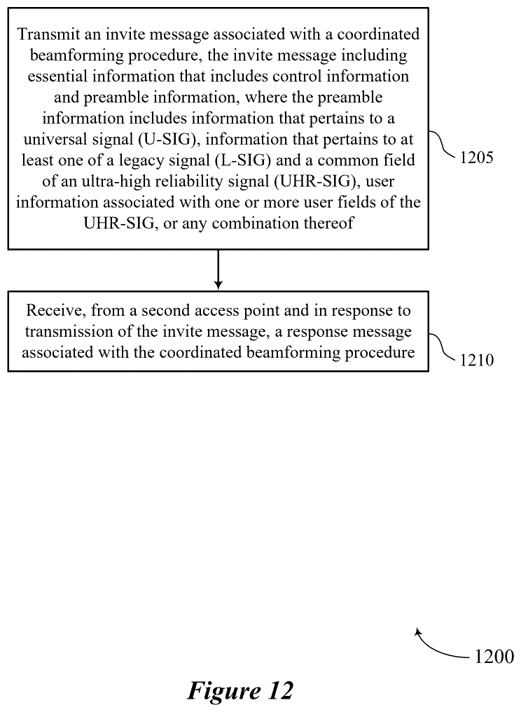

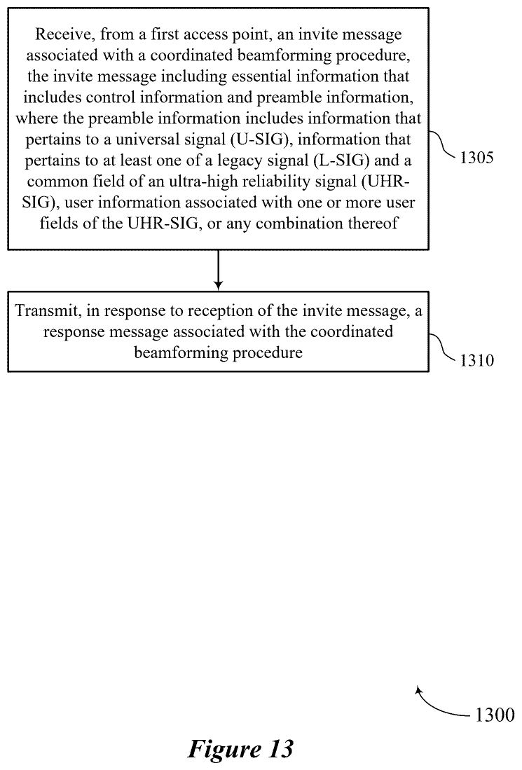

FIG. 11 shows a block diagram of an example wireless communication device 1100 that supports coordinated beamforming information exchange for a transmission phase. In some examples, the wireless communication device 1100 is configured to perform the processes 1200 and 1300 described with reference to FIGS. 12 and 13, respectively. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in an AP, such as the AP 102 described with reference to FIG. 1. In some other examples, the wireless communication device 1100 can be an AP that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3 GPP specifications including those for 5G NR or 6G. In some examples, the wireless communication device 1100 also includes or can be coupled with one or more application processors which may be further coupled with one or more other memories. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes an invite message manager 1125, a response message manager 1130, a synchronization message manager 1135, and an PPDU/LDPC encoding parameter determination component 1140. Portions of one or more of the invite message manager 1125, the response message manager 1130, the synchronization message manager 1135, and the PPDU/LDPC encoding parameter determination component 1140 may be implemented at least in part in hardware or firmware. For example, one or more of the invite message manager 1125, the response message manager 1130, the synchronization message manager 1135, and the PPDU/LDPC encoding parameter determination component 1140 may be implemented at least in part by at least a processor or a modem. In some examples, portions of one or more of the invite message manager 1125, the response message manager 1130, the synchronization message manager 1135, and the PPDU/LDPC encoding parameter determination component 1140 may be implemented at least in part by a processor and software in the form of processor-executable code stored in memory.

The wireless communication device 1100 may support wireless communications in accordance with examples as disclosed herein. The invite message manager 1125 is configurable or configured to transmit an invite message associated with a coordinated beamforming procedure, the invite message including baseline information that includes control information and preamble information, where the preamble information includes information that pertains to a universal signal (U-SIG), information that pertains to at least one of a legacy signal (L-SIG) and a common field of an ultra-high reliability signal (UHR-SIG), user information associated with one or more user fields of the UHR-SIG, or any combination thereof. The response message manager 1130 is configurable or configured to receive, from a second access point and in response to transmission of the invite message, a response message associated with the coordinated beamforming procedure.

In some examples, the synchronization message manager 1135 is configurable or configured to transmit, in response to reception of the response message, a synchronization message that indicates that the coordinated beamforming procedure is to begin.

In some examples, the synchronization message includes second baseline information. In some examples, the second baseline information includes second control information and second preamble information. In some examples, the second preamble information includes information that pertains to a second U-SIG, information that pertains to at least one of a second L-SIG and a common field of a second UHR-SIG, second user information associated with one or more user fields of the second UHR-SIG, or any combination thereof.

In some examples, the information that pertains to the second U-SIG includes at least one of a physical layer (PHY) version identifier, a bandwidth associated with the first access point, an indication of uplink or downlink communication associated with the first access point, an indication of a transmission opportunity duration, an identifier associated with the first access point, an identifier associated with the second access point, one or more first parameters associated with a physical layer protocol data unit (PPDU) type and compression mode, an indication of the coordinated beamforming procedure, information associated with punctured channels, and an indication of a modulation and coding scheme of the second UHR-SIG. In some examples, the information that pertains to at least one of the second L-SIG and the common field of the second UHR-SIG includes at least one of a guard interval and long training field size, a quantity of users associated with the first access point and the coordinated beamforming procedure, one or more second parameters associated with a physical layer protocol data unit (PPDU) and low-density parity-check (LDPC) encoding, a modified PPDU length, a range of PPDU length, a data field duration, a range of values associated with the data field duration, a minimum quantity of data orthogonal frequency division multiplexing (OFDM) symbols, a maximum quantity of Data OFDM symbols, a pre-forward error correction (FEC) padding factor, an LDPC extra symbol segment, a packet extension (PE) disambiguity indication. In some examples, the second user information associated with one or more user fields of the second UHR-SIG, where the user information associated with each user field includes at least one of a station identifier, an indication of a modulation and coding scheme, an indication of a basic service set (BSS) color, an indication of an access point, one or more third parameters associated with low-density parity-check (LDPC) encoding, an indication of enabling or disabling 2×LDPC, and an indication of a number of spatial streams.

In some examples, the synchronization message indicates optional information. In some examples, the optional information includes third information that pertains to a second U-SIG, third information that pertains to at least one of a second L-SIG and a common field of a second UHR-SIG, third user information associated with one or more user fields of the second UHR-SIG, or any combination thereof.

In some examples, the third information that pertains to the second U-SIG includes at least one of an uplink or downlink indication, an indication of one or more basic service set (BSS) colors, information associated with a transmit opportunity (TXOP), one or more first parameters associated with a physical layer protocol data unit (PPDU) type and compression mode, an indication of a modulation and coding scheme of the UHR-SIG field, an indication of the coordinated beamforming procedure, an indication of a quantity of UHR-SIG symbols. In some examples, the third information that pertains to at least one of the second L-SIG and the common field of the second UHR-SIG includes at least one of an indication of a spatial reuse scheme, one or more second parameters associated with a physical layer protocol data unit (PPDU) and low-density parity-check (LDPC) encoding, a pre-forward error correction (FEC) padding factor, and information associated with a quantity of users. In some examples, the third user information associated with one or more user fields of the second UHR-SIG, where the user information associated with each user field includes at least one of an indication of a basic service set (BSS) color, an indication of an access point, information associated with a spatial configuration, and an indication of a number of spatial streams.

In some examples, the PPDU/LDPC encoding parameter determination component 1140 is configurable or configured to determine, for inclusion in the synchronization message, one or more low-density parity-check (LDPC) parameters.

In some examples, the invite message, the response message, the synchronization message, or any combination thereof may include trigger frame, where the trigger frame may include a BSRP trigger frame, a STA-specific BSRP trigger frame, a MU-RTS TXS trigger frame, a new trigger type frame, or any combination thereof, and the invite message, the response message, the synchronization message, or any combination thereof may trigger transmission of a PPDU that may include a QoS null frame, a BlockAck frame, a multi-STA BlockACK frame, or any combination thereof.

In some examples, the PPDU/LDPC encoding parameter determination component 1140 is configurable or configured to determine, for inclusion in the invite message, one or more physical layer protocol data unit (PPDU) bandwidth parameters and punctured channel information.

In some examples, the information that pertains to the U-SIG includes at least one of a physical layer (PHY) version identifier, a bandwidth associated with the first access point, an indication of uplink or downlink communication associated with the first access point, an indication of a transmission opportunity duration, an identifier associated with the first access point, an identifier associated with the second access point, one or more first parameters associated with a physical layer protocol data unit (PPDU) type and compression mode, an indication of the coordinated beamforming procedure, information associated with punctured channels, and an indication of a modulation and coding scheme of the UHR-SIG. In some examples, the information that pertains to at least one of the L-SIG and the common field of the UHR-SIG includes at least one of a guard interval and long training field size, a quantity of users associated with the first access point and the coordinated beamforming procedure, one or more second parameters associated with a physical layer protocol data unit (PPDU) and low-density parity-check (LDPC) encoding, a modified PPDU length, a range of PPDU length, a data field duration, a range of values associated with the data field duration, a minimum quantity of data orthogonal frequency division multiplexing (OFDM) symbols, a maximum quantity of Data OFDM symbols, a pre-forward error correction (FEC) padding factor, an LDPC extra symbol segment, a packet extension (PE) disambiguity indication. In some examples, the user information includes user information associated with each user field of the one or more user fields of the UHR-SIG that includes at least one of a station identifier, an indication of a modulation and coding scheme, an indication of a basic service set (BSS) color, an indication of an access point, one or more third parameters associated with low-density parity-check (LDPC) encoding, an indication of enabling or disabling 2×LDPC, and an indication of a number of spatial streams.

In some examples, the control information includes an invitation for the second access point to participate in the coordinated beamforming procedure, bandwidth information associated with the second access point, synchronization leader information, an immediate response notification, a multi-access point scheme, an information type, or any combination thereof.

In some examples, the response message indicates participation by the second access point in the coordinated beamforming procedure.

In some examples, the response message includes second baseline information that includes second control information and second preamble information. In some examples, the second control information includes an indication of participation of the second access point in the coordinated beamforming procedure, bandwidth information associated with the second access point, synchronization leader information, an immediate response notification, a multi-access point scheme, an information type, or any combination thereof. In some examples, the second preamble information includes pertains to a second U-SIG, information that pertains to at least one of a second L-SIG and a common field of a second UHR-SIG, second user information associated with one or more user fields of the second UHR-SIG, or any combination thereof.

In some examples, the information that pertains to the second U-SIG includes at least one of a physical layer (PHY) version identifier, a bandwidth associated with the first access point, an indication of uplink or downlink communication associated with the first access point, an indication of a transmission opportunity duration, an identifier associated with the first access point, an identifier associated with the second access point, one or more first parameters associated with a physical layer protocol data unit (PPDU) type and compression mode, an indication of the coordinated beamforming procedure, information associated with punctured channels, and an indication of a modulation and coding scheme of the second UHR-SIG. In some examples, the information that pertains to at least one of the second L-SIG and the common field of the second UHR-SIG includes at least one of a guard interval and long training field size, a quantity of users associated with the first access point and the coordinated beamforming procedure, one or more second parameters associated with a physical layer protocol data unit (PPDU) and low-density parity-check (LDPC) encoding, a modified PPDU length, a range of PPDU length, a data field duration, a range of values associated with the data field duration, a minimum quantity of data orthogonal frequency division multiplexing (OFDM) symbols, a maximum quantity of Data OFDM symbols, a pre-FEC padding factor, an LDPC extra symbol segment, a packet extension (PE) disambiguity indication. In some examples, the user information includes user information associated with each user field of the one or more user fields of the second UHR-SIG that includes at least one of a station identifier, an indication of a modulation and coding scheme, an indication of a basic service set (BSS) color, an indication of an access point, one or more third parameters associated with low-density parity-check (LDPC) encoding, an indication of enabling or disabling 2×LDPC, and an indication of a number of spatial streams.

Additionally, or alternatively, the wireless communication device 1100 may support wireless communications in accordance with examples as disclosed herein. In some examples, the invite message manager 1125 is configurable or configured to receive, from a first access point, an invite message associated with a coordinated beamforming procedure, the invite message including baseline information that includes control information and preamble information, where the preamble information includes information that pertains to a universal signal (U-SIG), information that pertains to at least one of a legacy signal (L-SIG) and a common field of an ultra-high reliability signal (UHR-SIG), user information associated with one or more user fields of the UHR-SIG, or any combination thereof. In some examples, the response message manager 1130 is configurable or configured to transmit, in response to reception of the invite message, a response message associated with the coordinated beamforming procedure.

In some examples, the synchronization message manager 1135 is configurable or configured to receive, in response to transmission of the response message, a synchronization message that indicates that the coordinated beamforming procedure is to begin.

In some examples, the synchronization message includes second baseline information. In some examples, the second baseline information includes second control information and second preamble information. In some examples, the second preamble information includes information that pertains to a second U-SIG, information that pertains to at least one of a second L-SIG and a common field of a second UHR-SIG, second user information associated with one or more user fields of the second UHR-SIG, or any combination thereof.

In some examples, the information that pertains to the second U-SIG includes at least one of a physical layer (PHY) version identifier, a bandwidth associated with the first access point, an indication of uplink or downlink communication associated with the first access point, an indication of a transmission opportunity duration, an identifier associated with the first access point, an identifier associated with the second access point, one or more first parameters associated with a physical layer protocol data unit (PPDU) type and compression mode, an indication of the coordinated beamforming procedure, information associated with punctured channels, and an indication of a modulation and coding scheme of the second UHR-SIG. In some examples, the information that pertains to at least one of the second L-SIG and the common field of the second UHR-SIG includes at least one of a guard interval and long training field size, a quantity of users associated with the first access point and the coordinated beamforming procedure, one or more second parameters associated with a physical layer protocol data unit (PPDU) and low-density parity-check (LDPC) encoding, a modified PPDU length, a range of PPDU length, a data field duration, a range of values associated with the data field duration, a minimum quantity of data orthogonal frequency division multiplexing (OFDM) symbols, a maximum quantity of Data OFDM symbols, a pre-forward error correction (FEC) padding factor, an LDPC extra symbol segment, a packet extension (PE) disambiguity indication. In some examples, the second user information associated with one or more user fields of the second UHR-SIG, where the user information associated with each user field includes at least one of a station identifier, an indication of a modulation and coding scheme, an indication of a basic service set (BSS) color, an indication of an access point, one or more third parameters associated with low-density parity-check (LDPC) encoding, an indication of enabling or disabling 2×LDPC, and an indication of a number of spatial streams.

In some examples, the synchronization message indicates optional information. In some examples, the optional information includes third information that pertains to a second U-SIG, third information that pertains to at least one of a second L-SIG and a common field of a second UHR-SIG, third user information associated with one or more user fields of the second UHR-SIG, or any combination thereof.

In some examples, the third information that pertains to the second U-SIG includes at least one of an uplink or downlink indication, an indication of one or more basic service set (BSS) colors, information associated with a transmit opportunity (TXOP), one or more first parameters associated with a physical layer protocol data unit (PPDU) type and compression mode, an indication of a modulation and coding scheme of the UHR-SIG field, an indication of the coordinated beamforming procedure, an indication of a quantity of UHR-SIG symbols. In some examples, the third information that pertains to at least one of the second L-SIG and the common field of the second UHR-SIG includes at least one of an indication of a spatial reuse scheme, one or more second parameters associated with a physical layer protocol data unit (PPDU) and low-density parity-check (LDPC) encoding, a pre-forward error correction (FEC) padding factor, and information associated with a quantity of users. In some examples, the third user information associated with one or more user fields of the second UHR-SIG, where the user information associated with each user field includes at least one of an indication of a basic service set (BSS) color, an indication of an access point, information associated with a spatial configuration, and an indication of a number of spatial streams.

In some examples, the PPDU/LDPC encoding parameter determination component 1140 is configurable or configured to determine, based on information included in the synchronization message, one or more low-density parity-check (LDPC) parameters.

In some examples, the invite message, the response message, the synchronization message, or any combination thereof may include trigger frame, where the trigger frame may include a BSRP trigger frame, a STA-specific BSRP trigger frame, a MU-RTS TXS trigger frame, a new trigger type frame, or any combination thereof, and the invite message, the response message, the synchronization message, or any combination thereof may trigger transmission of a PPDU that may include a QoS null frame, a BlockAck frame, a multi-STA BlockACK frame, or any combination thereof.

In some examples, the PPDU/LDPC encoding parameter determination component 1140 is configurable or configured to determine, for inclusion in the invite message or based on information included in the response message, one or more physical layer protocol data unit (PPDU) length and low-density parity-check (LDPC) encoding parameters.

In some examples, the information that pertains to the U-SIG includes at least one of a physical layer (PHY) version identifier, a bandwidth associated with the first access point, an indication of uplink or downlink communication associated with the first access point, an indication of a transmission opportunity duration, an identifier associated with the first access point, an identifier associated with the second access point, one or more first parameters associated with a physical layer protocol data unit (PPDU) type and compression mode, an indication of the coordinated beamforming procedure, information associated with punctured channels, and an indication of a modulation and coding scheme of the UHR-SIG. In some examples, the information that pertains to at least one of the L-SIG and the common field of the UHR-SIG includes at least one of a guard interval and long training field size, a quantity of users associated with the first access point and the coordinated beamforming procedure, one or more second parameters associated with a physical layer protocol data unit (PPDU) and low-density parity-check (LDPC) encoding, a modified PPDU length, a range of PPDU length, a data field duration, a range of values associated with the data field duration, a minimum quantity of data orthogonal frequency division multiplexing (OFDM) symbols, a maximum quantity of Data OFDM symbols, a pre-forward error correction (FEC) padding factor, an LDPC extra symbol segment, a packet extension (PE) disambiguity indication. In some examples, the user information includes user information associated with each user field of the one or more user fields of the UHR-SIG that includes at least one of a station identifier, an indication of a modulation and coding scheme, an indication of a basic service set (BSS) color, an indication of an access point, one or more third parameters associated with low-density parity-check (LDPC) encoding, an indication of enabling or disabling 2×LDPC, and an indication of a number of spatial streams.

In some examples, the control information includes an invitation for the second access point to participate in the coordinated beamforming procedure, bandwidth information associated with the second access point, synchronization leader information, an immediate response notification, a multi-access point scheme, an information type, or any combination thereof.

In some examples, the response message indicates participation by the second access point in the coordinated beamforming procedure.

In some examples, the response message includes second baseline information that includes second control information and second preamble information. In some examples, the second control information includes an indication of participation of the second access point in the coordinated beamforming procedure, bandwidth information associated with the second access point, synchronization leader information, an immediate response notification, a multi-access point scheme, an information type, or any combination thereof. In some examples, the second preamble information includes pertains to a second U-SIG, information that pertains to at least one of a second L-SIG and a common field of a second UHR-SIG, second user information associated with one or more user fields of the second UHR-SIG, or any combination thereof.

In some examples, the information that pertains to the second U-SIG includes at least one of a physical layer (PHY) version identifier, a bandwidth associated with the first access point, an indication of uplink or downlink communication associated with the first access point, an indication of a transmission opportunity duration, an identifier associated with the first access point, an identifier associated with the second access point, one or more first parameters associated with a physical layer protocol data unit (PPDU) type and compression mode, an indication of the coordinated beamforming procedure, information associated with punctured channels, and an indication of a modulation and coding scheme of the second UHR-SIG. In some examples, the information that pertains to at least one of the second L-SIG and the common field of the second UHR-SIG includes at least one of a guard interval and long training field size, a quantity of users associated with the first access point and the coordinated beamforming procedure, one or more second parameters associated with a physical layer protocol data unit (PPDU) and low-density parity-check (LDPC) encoding, a modified PPDU length, a range of PPDU length, a data field duration, a range of values associated with the data field duration, a minimum quantity of data orthogonal frequency division multiplexing (OFDM) symbols, a maximum quantity of Data OFDM symbols, a pre-FEC padding factor, an LDPC extra symbol segment, a packet extension (PE) disambiguity indication. In some examples, the user information includes user information associated with each user field of the one or more user fields of the second UHR-SIG that includes at least one of a station identifier, an indication of a modulation and coding scheme, an indication of a basic service set (BSS) color, an indication of an access point, one or more third parameters associated with low-density parity-check (LDPC) encoding, an indication of enabling or disabling 2×LDPC, and an indication of a number of spatial streams.

FIG. 12 shows a flowchart illustrating an example process 1200 performable by or at a first access point that supports coordinated beamforming information exchange for a transmission phase. The operations of the process 1200 may be implemented by a first access point or its components as described herein. For example, the process 1200 may be performed by a wireless communication device, such as the wireless communication device 1100 described with reference to FIG. 11, operating as or within a wireless AP. In some examples, the process 1200 may be performed by a wireless AP, such as one of the APs 102 described with reference to FIG. 1.

In some examples, in 1205, the first access point may transmit an invite message associated with a coordinated beamforming procedure, the invite message including baseline information that includes control information and preamble information, where the preamble information includes information that pertains to a universal signal (U-SIG), information that pertains to at least one of a legacy signal (L-SIG) and a common field of an ultra-high reliability signal (UHR-SIG), user information associated with one or more user fields of the UHR-SIG, or any combination thereof. The operations of 1205 may be performed in accordance with examples as disclosed herein, such as in accordance with the invite 405 in FIG. 4 and transmission of the invite message at 610 in FIG. 6. In some implementations, aspects of the operations of 1205 may be performed by an invite message manager 1125 as described with reference to FIG. 11.

In some examples, in 1210, the first access point may receive, from a second access point and in response to transmission of the invite message, a response message associated with the coordinated beamforming procedure. The operations of 1210 may be performed in accordance with examples as disclosed herein, such as in accordance with the response 410 in FIG. 4 and reception of the response message at 620 in FIG. 6. In some implementations, aspects of the operations of 1210 may be performed by a response message manager 1130 as described with reference to FIG. 11.

FIG. 13 shows a flowchart illustrating an example process 1300 performable by or at a second access point that supports coordinated beamforming information exchange for a transmission phase. The operations of the process 1300 may be implemented by a second access point or its components as described herein. For example, the process 1300 may be performed by a wireless communication device, such as the wireless communication device 1100 described with reference to FIG. 11, operating as or within a wireless AP. In some examples, the process 1300 may be performed by a wireless AP, such as one of the APs 102 described with reference to FIG. 1.

In some examples, in 1305, the second access point may receive, from a first access point, an invite message associated with a coordinated beamforming procedure, the invite message including baseline information that includes control information and preamble information, where the preamble information includes information that pertains to a universal signal (U-SIG), information that pertains to at least one of a legacy signal (L-SIG) and a common field of an ultra-high reliability signal (UHR-SIG), user information associated with one or more user fields of the UHR-SIG, or any combination thereof. The operations of 1305 may be performed in accordance with examples as disclosed herein, such as in accordance with the invite 405 in FIG. 4 and reception of the invite message at 610 in FIG. 6. In some implementations, aspects of the operations of 1305 may be performed by an invite message manager 1125 as described with reference to FIG. 11.

In some examples, in 1310, the second access point may transmit, in response to reception of the invite message, a response message associated with the coordinated beamforming procedure. The operations of 1310 may be performed in accordance with examples as disclosed herein, such as in accordance with the response 410 in FIG. 4 and transmission of the response message at 620 in FIG. 6. In some implementations, aspects of the operations of 1310 may be performed by a response message manager 1130 as described with reference to FIG. 11.

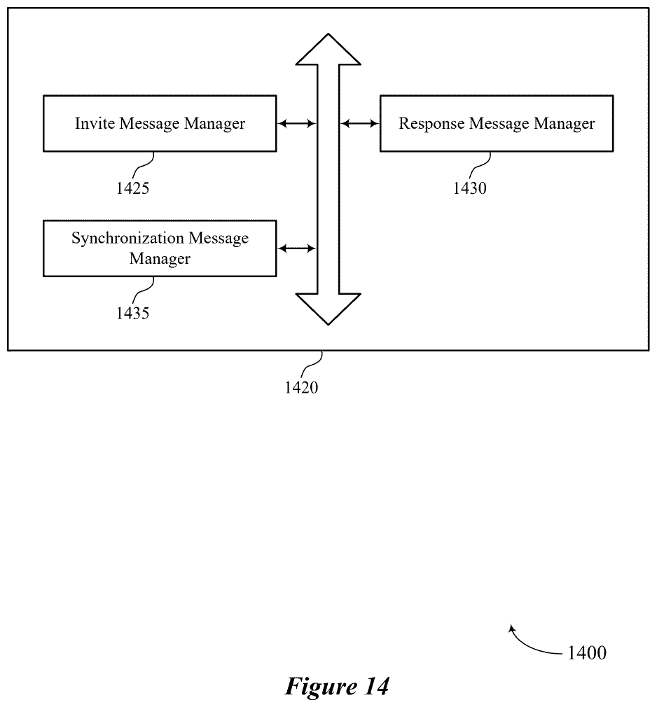

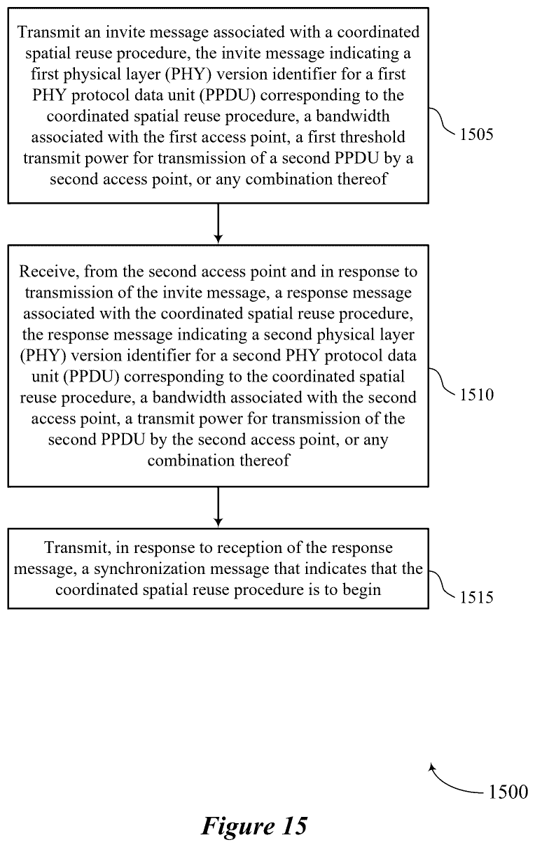

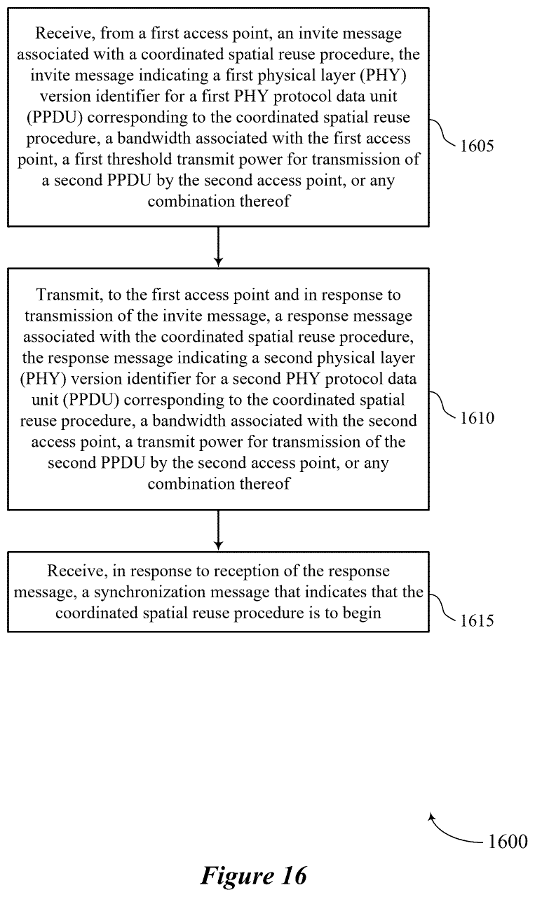

FIG. 14 shows a block diagram of an example wireless communication device 1400 that supports coordinated beamforming information exchange for a transmission phase. In some examples, the wireless communication device 1400 is configured to perform the processes 1500 and 1600 described with reference to FIGS. 15 and 16, respectively. The wireless communication device 1400 may include one or more chips, SoCs, chipsets, packages, components or devices that individually or collectively constitute or include a processing system. The processing system may interface with other components of the wireless communication device 1400, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1400 may transmit the information output from the chip. In such an example, the second interface may refer to an interface between the processing system of the chip and a reception component, such that the wireless communication device 1400 may receive information that is then passed to the processing system. In some such examples, the first interface also may obtain information, such as from the transmission component, and the second interface also may output information, such as to the reception component.

The processing system of the wireless communication device 1400 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1400 can be configurable or configured for use in an AP, such as the AP 102 described with reference to FIG. 1. In some other examples, the wireless communication device 1400 can be an AP that includes such a processing system and other components including multiple antennas. The wireless communication device 1400 is capable of transmitting and receiving wireless communications in the form of, for example, wireless packets. For example, the wireless communication device 1400 can be configurable or configured to transmit and receive packets in the form of physical layer PPDUs and MPDUs conforming to one or more of the IEEE 802.11 family of wireless communication protocol standards. In some other examples, the wireless communication device 1400 can be configurable or configured to transmit and receive signals and communications conforming to one or more 3GPP specifications including those for 5G NR or 6G. In some examples, the wireless communication device 1400 also includes or can be coupled with one or more application processors which may be further coupled with one or more other memories. In some examples, the wireless communication device 1400 further includes at least one external network interface coupled with the processing system that enables communication with a core network or backhaul network that enables the wireless communication device 1400 to gain access to external networks including the Internet.

The wireless communication device 1400 includes an invite message manager 1425, a response message manager 1430, and a synchronization message manager 1435. Portions of one or more of the invite message manager 1425, the response message manager 1430, and the synchronization message manager 1435 may be implemented at least in part in hardware or firmware. For example, one or more of the invite message manager 1425, the response message manager 1430, and the synchronization message manager 1435 may be implemented at least in part by at least a processor or a modem. In some examples, portions of one or more of the invite message manager 1425, the response message manager 1430, and the synchronization message manager 1435 may be implemented at least in part by a processor and software in the form of processor-executable code stored in memory.

The wireless communication device 1400 may support wireless communications in accordance with examples as disclosed herein. The invite message manager 1425 is configurable or configured to transmit an invite message associated with a coordinated spatial reuse procedure, the invite message indicating a first physical layer (PHY) version identifier for a first PHY protocol data unit (PPDU) corresponding to the coordinated spatial reuse procedure, a bandwidth associated with the first access point, a first threshold transmit power for transmission of a second PPDU by a second access point, or any combination thereof. The response message manager 1430 is configurable or configured to receive, from the second access point and in response to transmission of the invite message, a response message associated with the coordinated spatial reuse procedure, the response message indicating a second physical layer (PHY) version identifier for a second PHY protocol data unit (PPDU) corresponding to the coordinated spatial reuse procedure, a bandwidth associated with the second access point, a transmit power for transmission of the second PPDU by the second access point, or any combination thereof. The synchronization message manager 1435 is configurable or configured to transmit, in response to reception of the response message, a synchronization message that indicates that the coordinated spatial reuse procedure is to begin.

In some examples, the invite message further indicates information associated with punctured channels corresponding to the first PPDU, a length of an legacy signal (L-SIG) for the first PPDU, a quantity of data symbols of the L-SIG, a guard interval and long training field size for the first PPDU, a transmit power for transmission of the first PPDU, or any combination thereof.

In some examples, the response message further indicates information associated with punctured channels corresponding to the second PPDU, a candidate length of an legacy signal (L-SIG) for the second PPDU, a candidate quantity of data symbols of the L-SIG, a guard interval and long training field size for the second PPDU, a transmit power for transmission of the first PPDU, or any combination thereof.

In some examples, the synchronization message further indicates information corresponding to a final length of a legacy signal (L-SIG) for the second PPDU and the first PPDU, a final quantity of data symbols of the L-SIG, parameters associated with a universal signal (U-SIG) for the first PPDU and the second PPDU, or any combination thereof.

In some examples, one or more parameters for the coordinated spatial reuse procedure may be set values, the one or more parameters including a first modulation and coding scheme (MCS) for an extremely high throughput signal (EHT-SIG), a second MCS for an ultra-high reliability signal (UHR-SIG), a first quantity of symbols for the EHT-SIG, a second quantity of symbols for the UHR-SIG, or any combination thereof.

In some examples, the invite message, the synchronization message, or both indicate a final length of a legacy signal (L-SIG) for the first PPDU and the second PPDU. In some examples, a packet size of the second PPDU is based on a common preamble for the first PPDU and a common preamble for the second PPDU each including an L-SIG of the final length.

In some examples, the invite message, the response message, the synchronization message, or any combination thereof includes a trigger frame. In some examples, the trigger frame includes a buffer status report poll (BSRP) trigger frame, a station-specific BSRP trigger frame, a multi-user request-to-send (MU-RTS) trigger frame, a MU-RTS transmit opportunity sharing (TXS) trigger frame, a new trigger type frame, or any combination thereof. In some examples, the invite message, the response message, the synchronization message, or any combination thereof triggers transmission of a physical layer protocol data unit (PPDU) including a quality of service null frame, a BlockAck frame, a multi-station BlockACK frame, or any combination thereof.

In some examples, the coordinated spatial reuse procedure includes a first type of coordinated spatial reuse procedure, the first type of coordinated spatial reuse procedure corresponding to a common preamble for the first PPDU and the second PPDU, the common preamble including a legacy short training field (L-STF), a legacy long training field (L-LTF), and a legacy signal (L-SIG).

In some examples, the coordinated spatial reuse procedure includes a second type of coordinated spatial reuse procedure, the second type of coordinated spatial reuse procedure corresponding to a common preamble for the first PPDU and the second PPDU, the common preamble including a legacy short training field (L-STF), a legacy long training field (L-LTF), a legacy signal (L-SIG), and a universal signal (U-SIG).

Additionally, or alternatively, the wireless communication device 1400 may support wireless communications in accordance with examples as disclosed herein. In some examples, the invite message manager 1425 is configurable or configured to receive, from a first access point, an invite message associated with a coordinated spatial reuse procedure, the invite message indicating a first physical layer (PHY) version identifier for a first PHY protocol data unit (PPDU) corresponding to the coordinated spatial reuse procedure, a bandwidth associated with the first access point, a first threshold transmit power for transmission of a second PPDU by the second access point, or any combination thereof. In some examples, the response message manager 1430 is configurable or configured to transmit, to the first access point and in response to transmission of the invite message, a response message associated with the coordinated spatial reuse procedure, the response message indicating a second physical layer (PHY) version identifier for a second PHY protocol data unit (PPDU) corresponding to the coordinated spatial reuse procedure, a bandwidth associated with the second access point, a transmit power for transmission of the second PPDU by the second access point, or any combination thereof. In some examples, the synchronization message manager 1435 is configurable or configured to receive, in response to reception of the response message, a synchronization message that indicates that the coordinated spatial reuse procedure is to begin.

In some examples, the invite message further indicates information associated with punctured channels corresponding to the first PPDU, a length of an legacy signal (L-SIG) for the first PPDU, a quantity of data symbols of the L-SIG, a guard interval and long training field size for the first PPDU, a transmit power for transmission of the first PPDU, or any combination thereof.

In some examples, the response message further indicates information associated with punctured channels corresponding to the second PPDU, a candidate length of an legacy signal (L-SIG) for the second PPDU, a candidate quantity of data symbols of the L-SIG, a guard interval and long training field size for the second PPDU, a transmit power for transmission of the first PPDU, or any combination thereof.

In some examples, the synchronization message further indicates information corresponding to a final length of a legacy signal (L-SIG) for the second PPDU and the first PPDU, a final quantity of data symbols of the L-SIG, parameters associated with a universal signal (U-SIG) for the first PPDU and the second PPDU, or any combination thereof.

In some examples, one or more parameters for the coordinated spatial reuse procedure may be set values, the one or more parameters including a first modulation and coding scheme (MCS) for an extremely high throughput signal (EHT-SIG), a second MCS for an ultra-high reliability signal (UHR-SIG), a first quantity of symbols for the EHT-SIG, a second quantity of symbols for the UHR-SIG, or any combination thereof.

In some examples, the invite message, the synchronization message, or both indicate a final length of a legacy signal (L-SIG) for the first PPDU and the second PPDU. In some examples, a packet size of the second PPDU is based on a common preamble for the first PPDU and a common preamble for the second PPDU each including an L-SIG of the final length.

In some examples, the invite message, the response message, the synchronization message, or any combination thereof includes a trigger frame. In some examples, the trigger frame includes a buffer status report poll (BSRP) trigger frame, a station-specific BSRP trigger frame, a multi-user request-to-send (MU-RTS) trigger frame, a MU-RTS transmit opportunity sharing (TXS) trigger frame, a new trigger type frame, or any combination thereof. In some examples, the invite message, the response message, the synchronization message, or any combination thereof triggers transmission of a physical layer protocol data unit (PPDU) including a quality of service null frame, a BlockAck frame, a multi-station BlockACK frame, or any combination thereof.

In some examples, the coordinated spatial reuse procedure includes a first type of coordinated spatial reuse procedure, the first type of coordinated spatial reuse procedure corresponding to a common preamble for the first PPDU and the second PPDU, the common preamble including a legacy short training field (L-STF), a legacy long training field (L-LTF), and a legacy signal (L-SIG).

In some examples, the coordinated spatial reuse procedure includes a second type of coordinated spatial reuse procedure, the second type of coordinated spatial reuse procedure corresponding to a common preamble for the first PPDU and the second PPDU, the common preamble including a legacy short training field (L-STF), a legacy long training field (L-LTF), a legacy signal (L-SIG), and a universal signal (U-SIG).

FIG. 15 shows a flowchart illustrating an example process 1500 performable by or at a first access point that supports coordinated beamforming information exchange for a transmission phase. The operations of the process 1500 may be implemented by a first access point or its components as described herein. For example, the process 1500 may be performed by a wireless communication device, such as the wireless communication device 1400 described with reference to FIG. 14, operating as or within a wireless AP. In some examples, the process 1500 may be performed by a wireless AP, such as one of the APs 102 described with reference to FIG. 1.

In some examples, in 1505, the first access point may transmit an invite message associated with a coordinated spatial reuse procedure, the invite message indicating a first physical layer (PHY) version identifier for a first PHY protocol data unit (PPDU) corresponding to the coordinated spatial reuse procedure, a bandwidth associated with the first access point, a first threshold transmit power for transmission of a second PPDU by a second access point, or any combination thereof. In some implementations, aspects of the operations of 1505 may be performed by an invite message manager 1425 as described with reference to FIG. 14.

In some examples, in 1510, the first access point may receive, from the second access point and in response to transmission of the invite message, a response message associated with the coordinated spatial reuse procedure, the response message indicating a second physical layer (PHY) version identifier for a second PHY protocol data unit (PPDU) corresponding to the coordinated spatial reuse procedure, a bandwidth associated with the second access point, a transmit power for transmission of the second PPDU by the second access point, or any combination thereof. In some implementations, aspects of the operations of 1510 may be performed by a response message manager 1430 as described with reference to FIG. 14.

In some examples, in 1515, the first access point may transmit, in response to reception of the response message, a synchronization message that indicates that the coordinated spatial reuse procedure is to begin. In some implementations, aspects of the operations of 1515 may be performed by a synchronization message manager 1435 as described with reference to FIG. 14.

FIG. 16 shows a flowchart illustrating an example process 1600 performable by or at a second access point that supports coordinated beamforming information exchange for a transmission phase. The operations of the process 1600 may be implemented by a second access point or its components as described herein. For example, the process 1600 may be performed by a wireless communication device, such as the wireless communication device 1400 described with reference to FIG. 14, operating as or within a wireless AP. In some examples, the process 1600 may be performed by a wireless AP, such as one of the APs 102 described with reference to FIG. 1.

In some examples, in 1605, the second access point may receive, from a first access point, an invite message associated with a coordinated spatial reuse procedure, the invite message indicating a first physical layer (PHY) version identifier for a first PHY protocol data unit (PPDU) corresponding to the coordinated spatial reuse procedure, a bandwidth associated with the first access point, a first threshold transmit power for transmission of a second PPDU by the second access point, or any combination thereof. In some implementations, aspects of the operations of 1605 may be performed by an invite message manager 1425 as described with reference to FIG. 14.

In some examples, in 1610, the second access point may transmit, to the first access point and in response to transmission of the invite message, a response message associated with the coordinated spatial reuse procedure, the response message indicating a second physical layer (PHY) version identifier for a second PHY protocol data unit (PPDU) corresponding to the coordinated spatial reuse procedure, a bandwidth associated with the second access point, a transmit power for transmission of the second PPDU by the second access point, or any combination thereof. In some implementations, aspects of the operations of 1610 may be performed by a response message manager 1430 as described with reference to FIG. 14.

In some examples, in 1615, the second access point may receive, in response to reception of the response message, a synchronization message that indicates that the coordinated spatial reuse procedure is to begin. In some implementations, aspects of the operations of 1615 may be performed by a synchronization message manager 1435 as described with reference to FIG. 14.

Implementation examples are described in the following numbered clauses:

Implementation 1: A method for wireless communications at a first access point, comprising: transmitting an invite message associated with a coordinated beamforming procedure, the invite message comprising baseline information that includes control information and preamble information, wherein the preamble information comprises information that pertains to a universal signal (U-SIG), information that pertains to at least one of a legacy signal (L-SIG) and a common field of an ultra-high reliability signal (UHR-SIG), user information associated with one or more user fields of the UHR-SIG, or any combination thereof; and receiving, from a second access point and in response to transmission of the invite message, a response message associated with the coordinated beamforming procedure.

Implementation 2: The method of implementation 1, further comprising: transmitting, in response to reception of the response message, a synchronization message that indicates that the coordinated beamforming procedure is to begin.

Implementation 3: The method of implementation 2, wherein the synchronization message includes second baseline information, the second baseline information comprises second control information and second preamble information, and the second preamble information comprises information that pertains to a second U-SIG, information that pertains to at least one of a second L-SIG and a common field of a second UHR-SIG, second user information associated with one or more user fields of the second UHR-SIG, or any combination thereof.

Implementation 4: The method of implementation 3, wherein the information that pertains to the second U-SIG comprises at least one of a physical layer (PHY) version identifier, a bandwidth associated with the first access point, an indication of uplink or downlink communication associated with the first access point, an indication of a transmission opportunity duration, an identifier associated with the first access point, an identifier associated with the second access point, one or more first parameters associated with a physical layer protocol data unit (PPDU) type and compression mode, an indication of the coordinated beamforming procedure, information associated with punctured channels, and an indication of a modulation and coding scheme of the second UHR-SIG, the information that pertains to at least one of the second L-SIG and the common field of the second UHR-SIG comprises at least one of a guard interval and long training field size, a quantity of users associated with the first access point and the coordinated beamforming procedure, one or more second parameters associated with a physical layer protocol data unit (PPDU) length and low-density parity-check (LDPC) encoding, a modified PPDU length, a range of PPDU length, a data field duration, a range of values associated with the data field duration, a minimum quantity of data orthogonal frequency division multiplexing (OFDM) symbols, an initial maximum quantity of data OFDM symbols, a pre-forward error correction (FEC) padding factor, an LDPC extra symbol segment, and a packet extension (PE) disambiguity indication, and second user information associated with one or more user fields of the second UHR-SIG comprises user information associated with each user field, the user information associated with each user field comprises at least one of a station identifier, an indication of a modulation and coding scheme, an indication of a basic service set (BSS) color, an indication of an access point, one or more third parameters associated with low-density parity-check (LDPC) encoding, an indication of enabling or disabling 2×LDPC, and an indication of a number of spatial streams.

Implementation 5: The method of any of implementations 2 through 4, wherein the synchronization message indicates optional information, and the optional information comprises third information that pertains to a second U-SIG, third information that pertains to at least one of a second L-SIG and a common field of a second UHR-SIG, third user information associated with one or more user fields of the second UHR-SIG, or any combination thereof.

Implementation 6: The method of implementation 5, wherein the third information that pertains to the second U-SIG comprises at least one of an uplink or downlink indication, an indication of one or more basic service set (BSS) colors, information associated with a transmit opportunity (TXOP), one or more first parameters associated with a physical layer protocol data unit (PPDU) type and compression mode, an indication of a modulation and coding scheme of the UHR-SIG, an indication of the coordinated beamforming procedure, and an indication of a quantity of UHR-SIG symbols, third information that pertains to at least one of the second L-SIG and the common field of the second UHR-SIG comprises at least one of an indication of a spatial reuse scheme, one or more second parameters associated with a physical layer protocol data unit (PPDU) and low-density parity-check (LDPC) encoding, a pre-forward error correction (FEC) padding factor, and information associated with a quantity of users, and the third user information associated with one or more user fields of the second UHR-SIG comprises user information associated with each user field, the user information associated with each user field comprises at least one of an indication of a basic service set (BSS) color, an indication of an access point, information associated with a spatial configuration, and an indication of a number of spatial streams.

Implementation 7: The method of any of implementations 2 through 6, further comprising: determining, for inclusion in the synchronization message, one or more low-density parity-check (LDPC) parameters.

Implementation 8: The method of any of implementations 2 through 7, wherein the invite message, the response message, the synchronization message, or any combination thereof comprises a trigger frame, wherein the trigger frame comprises a buffer status report poll (BSRP) trigger frame, a station-specific BSRP trigger frame, a multi-user request-to-send (MU-RTS) trigger frame, a MU-RTS transmit opportunity sharing (TXS) trigger frame, a new trigger type frame, or any combination thereof, and the invite message, the response message, the synchronization message, or any combination thereof triggers transmission of a physical layer protocol data unit (PPDU) comprising a quality of service null frame, a BlockAck frame, a multi-station BlockACK frame, or any combination thereof.

Implementation 9: The method of any of implementations 1 through 8, wherein the information that pertains to the U-SIG comprises at least one of a physical layer (PHY) version identifier, a bandwidth associated with the first access point, an indication of uplink or downlink communication associated with the first access point, an indication of a transmission opportunity duration, an identifier associated with the first access point, an identifier associated with the second access point, one or more first parameters associated with a physical layer protocol data unit (PPDU) type and compression mode, an indication of the coordinated beamforming procedure, information associated with punctured channels, and an indication of a modulation and coding scheme of the UHR-SIG, the information that pertains to at least one of the L-SIG and the common field of the UHR-SIG comprises at least one of a guard interval and long training field size, a quantity of users associated with the first access point and the coordinated beamforming procedure, one or more second parameters associated with a physical layer protocol data unit (PPDU) length and low-density parity-check (LDPC) encoding, one or more modified PPDU lengths, a range of PPDU length, an average modified PPDU length, a minimum PPDU length, a maximum PPDU length, one or more data field durations, one or more quantities of data orthogonal frequency division multiplexing (OFDM) symbols, one or more initial quantities of data orthogonal frequency division multiplexing (OFDM) symbols, a range of values associated with the one or more data field durations, an average quantity of data OFDM symbols, a minimum quantity of data OFDM symbols, a maximum quantity of Data OFDM symbols, an average initial quantity of data OFDM symbols, a minimum initial quantity of data OFDM symbols, a maximum initial quantity of Data OFDM symbols, a pre-forward error correction (FEC) padding factor, an LDPC extra symbol segment, and a packet extension (PE) disambiguity indication, and the user information comprises user information associated with each user field of the one or more user fields of the UHR-SIG, the user information associated with each user field comprises at least one of a station identifier, an indication of a modulation and coding scheme, an indication of a basic service set (BSS) color, an indication of an access point, one or more third parameters associated with low-density parity-check (LDPC) encoding, an indication of enabling or disabling 2×LDPC, and an indication of a number of spatial streams.

Implementation 10: The method of any of implementations 1 through 9, wherein the control information comprises an invitation for the second access point to participate in the coordinated beamforming procedure, bandwidth information associated with the second access point, synchronization leader information, an immediate response notification, a multi-access point scheme, an information type, or any combination thereof.

Implementation 11: The method of any of implementations 1 through 10, wherein the response message indicates participation by the second access point in the coordinated beamforming procedure.

Implementation 12: The method of any of implementations 1 through 11, wherein the response message includes second baseline information that comprises second control information and second preamble information, the second control information comprises an indication of participation of the second access point in the coordinated beamforming procedure, bandwidth information associated with the second access point, synchronization leader information, an immediate response notification, a multi-access point scheme, an information type, or any combination thereof, and the second preamble information comprises information that pertains to a second U-SIG, information that pertains to at least one of a second L-SIG and a common field of a second UHR-SIG, second user information associated with one or more user fields of the second UHR-SIG, or any combination thereof.

Implementation 13: The method of implementation 12, wherein the information that pertains to the second U-SIG comprises at least one of a physical layer (PHY) version identifier, a bandwidth associated with the second access point, an indication of uplink or downlink communication associated with the second access point, an indication of a transmission opportunity duration, an identifier associated with the first access point, an identifier associated with the second access point, one or more first parameters associated with a physical layer protocol data unit (PPDU) type and compression mode, an indication of the coordinated beamforming procedure, information associated with punctured channels, and an indication of a modulation and coding scheme of the second UHR-SIG, the information that pertains to at least one of the second L-SIG and the common field of the second UHR-SIG comprises at least one of a guard interval and long training field size, a quantity of users associated with the first access point and the coordinated beamforming procedure, one or more second parameters associated with a physical layer protocol data unit (PPDU) length and low-density parity-check (LDPC) encoding, a modified PPDU length, a range of PPDU length, a data field duration, a range of values associated with the data field duration, a minimum quantity of data orthogonal frequency division multiplexing (OFDM) symbols, an initial maximum quantity of Data OFDM symbols, a pre-FEC padding factor, an LDPC extra symbol segment, a packet extension (PE) disambiguity indication, and the user information comprises user information associated with each user field of the one or more user fields of the second UHR-SIG that comprises at least one of a station identifier, an indication of a modulation and coding scheme, an indication of a basic service set (BSS) color, an indication of an access point, one or more third parameters associated with low-density parity-check (LDPC) encoding, an indication of enabling or disabling 2×LDPC, an indication of 2×LDPC capability, and an indication of a number of spatial streams.

Implementation 14: A method for wireless communications at a second access point, comprising: receiving, from a first access point, an invite message associated with a coordinated beamforming procedure, the invite message comprising baseline information that includes control information and preamble information, wherein the preamble information comprises information that pertains to a universal signal (U-SIG), information that pertains to at least one of a legacy signal (L-SIG) and a common field of an ultra-high reliability signal (UHR-SIG), user information associated with one or more user fields of the UHR-SIG, or any combination thereof; and transmitting, in response to reception of the invite message, a response message associated with the coordinated beamforming procedure.

Implementation 15: The method of implementation 14, further comprising: receiving, in response to transmission of the response message, a synchronization message that indicates that the coordinated beamforming procedure is to begin.

Implementation 16: The method of implementation 15, wherein the synchronization message includes second baseline information, the second baseline information comprises second control information and second preamble information, and the second preamble information comprises information that pertains to a second U-SIG, information that pertains to at least one of a second L-SIG and a common field of a second UHR-SIG, second user information associated with one or more user fields of the second UHR-SIG, or any combination thereof.

Implementation 17: The method of implementation 16, wherein the information that pertains to the second U-SIG comprises at least one of a physical layer (PHY) version identifier, a bandwidth associated with the first access point, an indication of uplink or downlink communication associated with the first access point, an indication of a transmission opportunity duration, an identifier associated with the first access point, an identifier associated with the second access point, one or more first parameters associated with a physical layer protocol data unit (PPDU) type and compression mode, an indication of the coordinated beamforming procedure, information associated with punctured channels, and an indication of a modulation and coding scheme of the second UHR-SIG, the information that pertains to at least one of the second L-SIG and the common field of the second UHR-SIG comprises at least one of a guard interval and long training field size, a quantity of users associated with the first access point and the coordinated beamforming procedure, one or more second parameters associated with a physical layer protocol data unit (PPDU) length and low-density parity-check (LDPC) encoding, a modified PPDU length, a range of PPDU length, a data field duration, a range of values associated with the data field duration, a minimum quantity of data orthogonal frequency division multiplexing (OFDM) symbols, an initial maximum quantity of data OFDM symbols, a pre-forward error correction (FEC) padding factor, an LDPC extra symbol segment, and a packet extension (PE) disambiguity indication, and second user information associated with one or more user fields of the second UHR-SIG comprises user information associated with each user field, the user information associated with each user field comprises at least one of a station identifier, an indication of a modulation and coding scheme, an indication of a basic service set (BSS) color, an indication of an access point, one or more third parameters associated with low-density parity-check (LDPC) encoding, an indication of enabling or disabling 2×LDPC, and an indication of a number of spatial streams.

Implementation 18: The method of any of implementations 15 through 17, wherein the synchronization message indicates optional information, and the optional information comprises third information that pertains to a second U-SIG, third information that pertains to at least one of a second L-SIG and a common field of a second UHR-SIG, third user information associated with one or more user fields of the second UHR-SIG, or any combination thereof.

Implementation 19: The method of implementation 18, wherein the third information that pertains to the second U-SIG comprises at least one of an uplink or downlink indication, an indication of one or more basic service set (BSS) colors, information associated with a transmit opportunity (TXOP), one or more first parameters associated with a physical layer protocol data unit (PPDU) type and compression mode, an indication of a modulation and coding scheme of the UHR-SIG, an indication of the coordinated beamforming procedure, and an indication of a quantity of UHR-SIG symbols, third information that pertains to at least one of the second L-SIG and the common field of the second UHR-SIG comprises at least one of an indication of a spatial reuse scheme, one or more second parameters associated with a physical layer protocol data unit (PPDU) and low-density parity-check (LDPC) encoding, a pre-forward error correction (FEC) padding factor, and information associated with a quantity of users, and the third user information associated with one or more user fields of the second UHR-SIG comprises user information associated with each user field, the user information associated with each user field comprises at least one of an indication of a basic service set (BSS) color, an indication of an access point, information associated with a spatial configuration, and an indication of a number of spatial streams.

Implementation 20: The method of any of implementations 15 through 19, further comprising: determining, based at least in part on information included in the synchronization message, one or more low-density parity-check (LDPC) parameters.

Implementation 21: The method of any of implementations 15 through 20, wherein the invite message, the response message, the synchronization message, or any combination thereof comprises a trigger frame, wherein the trigger frame comprises a buffer status report poll (BSRP) trigger frame, a station-specific BSRP trigger frame, a multi-user request-to-send (MU-RTS) trigger frame, a MU-RTS transmit opportunity sharing (TXS) trigger frame, a new trigger type frame, or any combination thereof, and the invite message, the response message, the synchronization message, or any combination thereof triggers transmission of a physical layer protocol data unit (PPDU) comprising a quality of service null frame, a BlockAck frame, a multi-station BlockACK frame, or any combination thereof.

Implementation 22: The method of any of implementations 14 through 21, further comprising: determining, for inclusion in the invite message or based at least in part on information included in the response message, one or more physical layer protocol data unit (PPDU) bandwidth parameters and punctured channel information.

Implementation 23: The method of any of implementations 14 through 22, wherein the information that pertains to the U-SIG comprises at least one of a physical layer (PHY) version identifier, a bandwidth associated with the first access point, an indication of uplink or downlink communication associated with the first access point, an indication of a transmission opportunity duration, an identifier associated with the first access point, an identifier associated with the second access point, one or more first parameters associated with a physical layer protocol data unit (PPDU) type and compression mode, an indication of the coordinated beamforming procedure, information associated with punctured channels, and an indication of a modulation and coding scheme of the UHR-SIG, the information that pertains to at least one of the L-SIG and the common field of the UHR-SIG comprises at least one of a guard interval and long training field size, a quantity of users associated with the first access point and the coordinated beamforming procedure, one or more second parameters associated with a physical layer protocol data unit (PPDU) length and low-density parity-check (LDPC) encoding, one or more modified PPDU lengths, a range of PPDU length, an average modified PPDU length, a minimum PPDU length, a maximum PPDU length, one or more data field durations, one or more quantities of data orthogonal frequency division multiplexing (OFDM) symbols, one or more initial quantities of data orthogonal frequency division multiplexing (OFDM) symbols, a range of values associated with the one or more data field durations, an average quantity of data OFDM symbols, a minimum quantity of data OFDM symbols, a maximum quantity of Data OFDM symbols, an average initial quantity of data OFDM symbols, a minimum initial quantity of data OFDM symbols, a maximum initial quantity of Data OFDM symbols, a pre-forward error correction (FEC) padding factor, an LDPC extra symbol segment, and a packet extension (PE) disambiguity indication, and the user information comprises user information associated with each user field of the one or more user fields of the UHR-SIG, the user information associated with each user field comprises at least one of a station identifier, an indication of a modulation and coding scheme, an indication of a basic service set (BSS) color, an indication of an access point, one or more third parameters associated with low-density parity-check (LDPC) encoding, an indication of enabling or disabling 2×LDPC, and an indication of a number of spatial streams.

Implementation 24: The method of any of implementations 14 through 23, wherein the control information comprises an invitation for the second access point to participate in the coordinated beamforming procedure, bandwidth information associated with the second access point, synchronization leader information, an immediate response notification, a multi-access point scheme, an information type, or any combination thereof.

Implementation 25: The method of any of implementations 14 through 24, wherein the response message indicates participation by the second access point in the coordinated beamforming procedure.

Implementation 26: The method of any of implementations 14 through 25, wherein the response message includes second baseline information that comprises second control information and second preamble information, the second control information comprises an indication of participation of the second access point in the coordinated beamforming procedure, bandwidth information associated with the second access point, synchronization leader information, an immediate response notification, a multi-access point scheme, an information type, or any combination thereof, and the second preamble information comprises information that pertains to a second U-SIG, information that pertains to at least one of a second L-SIG and a common field of a second UHR-SIG, second user information associated with one or more user fields of the second UHR-SIG, or any combination thereof.

Implementation 27: The method of implementation 26, wherein the information that pertains to the second U-SIG comprises at least one of a physical layer (PHY) version identifier, a bandwidth associated with the second access point, an indication of uplink or downlink communication associated with the second access point, an indication of a transmission opportunity duration, an identifier associated with the first access point, an identifier associated with the second access point, one or more first parameters associated with a physical layer protocol data unit (PPDU) type and compression mode, an indication of the coordinated beamforming procedure, information associated with punctured channels, and an indication of a modulation and coding scheme of the second UHR-SIG, the information that pertains to at least one of the second L-SIG and the common field of the second UHR-SIG comprises at least one of a guard interval and long training field size, a quantity of users associated with the first access point and the coordinated beamforming procedure, one or more second parameters associated with a physical layer protocol data unit (PPDU) length and low-density parity-check (LDPC) encoding, a modified PPDU length, a range of PPDU length, a data field duration, a range of values associated with the data field duration, a minimum quantity of data orthogonal frequency division multiplexing (OFDM) symbols, an initial maximum quantity of Data OFDM symbols, a pre-FEC padding factor, an LDPC extra symbol segment, a packet extension (PE) disambiguity indication, and the user information comprises user information associated with each user field of the one or more user fields of the second UHR-SIG that comprises at least one of a station identifier, an indication of a modulation and coding scheme, an indication of a basic service set (BSS) color, an indication of an access point, one or more third parameters associated with low-density parity-check (LDPC) encoding, an indication of enabling or disabling 2×LDPC, an indication of 2×LDPC capability, and an indication of a number of spatial streams.

Implementation 28: A first access point for wireless communications, comprising one or more memories storing processor-executable code, and one or more processors coupled with the one or more memories and individually or collectively operable to execute the code to cause the first access point to perform a method of any of implementations 1 through 13.

Implementation 29: A first access point for wireless communications, comprising at least one means for performing a method of any of implementations 1 through 13.

Implementation 30: A non-transitory computer-readable medium storing code for wireless communications, the code comprising instructions executable by one or more processors to perform a method of any of implementations 1 through 13.

Implementation 31: A second access point for wireless communications, comprising one or more memories storing processor-executable code, and one or more processors coupled with the one or more memories and individually or collectively operable to execute the code to cause the second access point to perform a method of any of implementations 14 through 27.

Implementation 32: A second access point for wireless communications, comprising at least one means for performing a method of any of implementations 14 through 27.

Implementation 33: A non-transitory computer-readable medium storing code for wireless communications, the code comprising instructions executable by one or more processors to perform a method of any of implementations 14 through 27.

Implementation 34: A method for wireless communications at a first access point, comprising: transmitting an invite message associated with a coordinated spatial reuse procedure, the invite message indicating a first physical layer (PHY) version identifier for a first PHY protocol data unit (PPDU) corresponding to the coordinated spatial reuse procedure, a bandwidth associated with the first access point, a first threshold transmit power for transmission of a second PPDU by a second access point, or any combination thereof; receiving, from the second access point and in response to transmission of the invite message, a response message associated with the coordinated spatial reuse procedure, the response message indicating a second physical layer (PHY) version identifier for a second PHY protocol data unit (PPDU) corresponding to the coordinated spatial reuse procedure, a bandwidth associated with the second access point, a transmit power for transmission of the second PPDU by the second access point, or any combination thereof; and transmitting, in response to reception of the response message, a synchronization message that indicates that the coordinated spatial reuse procedure is to begin.

Implementation 35: The method of implementation 1, wherein the invite message further indicates information associated with punctured channels corresponding to the first PPDU, a length of an legacy signal (L-SIG) for the first PPDU, a quantity of data symbols of the L-SIG, a guard interval and long training field size for the first PPDU, a transmit power for transmission of the first PPDU, or any combination thereof.

Implementation 36: The method of any of implementations 1 through 2, wherein the response message further indicates information associated with punctured channels corresponding to the second PPDU, a candidate length of an legacy signal (L-SIG) for the second PPDU, a candidate quantity of data symbols of the L-SIG, a guard interval and long training field size for the second PPDU, a transmit power for transmission of the first PPDU, or any combination thereof.

Implementation 37: The method of any of implementations 1 through 3, wherein the synchronization message further indicates information corresponding to a final length of a legacy signal (L-SIG) for the second PPDU and the first PPDU, a final quantity of data symbols of the L-SIG, parameters associated with a universal signal (U-SIG) for the first PPDU and the second PPDU, or any combination thereof.

Implementation 38: The method of any of implementations 1 through 4, wherein one or more parameters for the coordinated spatial reuse procedure may be set values, the one or more parameters comprising a first modulation and coding scheme (MCS) for an extremely high throughput signal (EHT-SIG), a second MCS for an ultra-high reliability signal (UHR-SIG), a first quantity of symbols for the EHT-SIG, a second quantity of symbols for the UHR-SIG, or any combination thereof.

Implementation 39: The method of any of implementations 1 through 5, wherein the invite message, the synchronization message, or both indicate a final length of a legacy signal (L-SIG) for the first PPDU and the second PPDU, a packet size of the second PPDU is based at least in part on a common preamble for the first PPDU and a common preamble for the second PPDU each including an L-SIG of the final length.

Implementation 40: The method of any of implementations 1 through 6, wherein the invite message, the response message, the synchronization message, or any combination thereof comprises a trigger frame, the trigger frame comprises a buffer status report poll (BSRP) trigger frame, a station-specific BSRP trigger frame, a multi-user request-to-send (MU-RTS) trigger frame, a MU-RTS transmit opportunity sharing (TXS) trigger frame, a new trigger type frame, or any combination thereof, and the invite message, the response message, the synchronization message, or any combination thereof triggers transmission of a physical layer protocol data unit (PPDU) comprising a quality of service null frame, a BlockAck frame, a multi-station BlockACK frame, or any combination thereof.

Implementation 41: The method of any of implementations 1 through 7, wherein the coordinated spatial reuse procedure comprises a first type of coordinated spatial reuse procedure, the first type of coordinated spatial reuse procedure corresponding to a common preamble for the first PPDU and the second PPDU, the common preamble comprising a legacy short training field (L-STF), a legacy long training field (L-LTF), and a legacy signal (L-SIG).

Implementation 42: The method of any of implementations 1 through 9, wherein the coordinated spatial reuse procedure comprises a second type of coordinated spatial reuse procedure, the second type of coordinated spatial reuse procedure corresponding to a common preamble for the first PPDU and the second PPDU, the common preamble comprising a legacy short training field (L-STF), a legacy long training field (L-LTF), a legacy signal (L-SIG), and a universal signal (U-SIG).

Implementation 43: A method for wireless communications at a second access point, comprising: receiving, from a first access point, an invite message associated with a coordinated spatial reuse procedure, the invite message indicating a first physical layer (PHY) version identifier for a first PHY protocol data unit (PPDU) corresponding to the coordinated spatial reuse procedure, a bandwidth associated with the first access point, a first threshold transmit power for transmission of a second PPDU by the second access point, or any combination thereof; transmitting, to the first access point and in response to transmission of the invite message, a response message associated with the coordinated spatial reuse procedure, the response message indicating a second physical layer (PHY) version identifier for a second PHY protocol data unit (PPDU) corresponding to the coordinated spatial reuse procedure, a bandwidth associated with the second access point, a transmit power for transmission of the second PPDU by the second access point, or any combination thereof; and receiving, in response to reception of the response message, a synchronization message that indicates that the coordinated spatial reuse procedure is to begin.

Implementation 44: The method of implementation 11, wherein the invite message further indicates information associated with punctured channels corresponding to the first PPDU, a length of an legacy signal (L-SIG) for the first PPDU, a quantity of data symbols of the L-SIG, a guard interval and long training field size for the first PPDU, a transmit power for transmission of the first PPDU, or any combination thereof.

Implementation 45: The method of any of implementations 11 through 12, wherein the response message further indicates information associated with punctured channels corresponding to the second PPDU, a candidate length of an legacy signal (L-SIG) for the second PPDU, a candidate quantity of data symbols of the L-SIG, a guard interval and long training field size for the second PPDU, a transmit power for transmission of the first PPDU, or any combination thereof.

Implementation 46: The method of any of implementations 11 through 13, wherein the synchronization message further indicates information corresponding to a final length of a legacy signal (L-SIG) for the second PPDU and the first PPDU, a final quantity of data symbols of the L-SIG, parameters associated with a universal signal (U-SIG) for the first PPDU and the second PPDU, or any combination thereof.

Implementation 47: The method of any of implementations 11 through 14, wherein one or more parameters for the coordinated spatial reuse procedure may be set values, the one or more parameters comprising a first modulation and coding scheme (MCS) for an extremely high throughput signal (EHT-SIG), a second MCS for an ultra-high reliability signal (UHR-SIG), a first quantity of symbols for the EHT-SIG, a second quantity of symbols for the UHR-SIG, or any combination thereof.

Implementation 48: The method of any of implementations 11 through 15, wherein the invite message, the synchronization message, or both indicate a final length of a legacy signal (L-SIG) for the first PPDU and the second PPDU, a packet size of the second PPDU is based at least in part on a common preamble for the first PPDU and a common preamble for the second PPDU each including an L-SIG of the final length.

Implementation 49: The method of any of implementations 11 through 16, wherein the invite message, the response message, the synchronization message, or any combination thereof comprises a trigger frame, the trigger frame comprises a buffer status report poll (BSRP) trigger frame, a station-specific BSRP trigger frame, a multi-user request-to-send (MU-RTS) trigger frame, a MU-RTS transmit opportunity sharing (TXS) trigger frame, a new trigger type frame, or any combination thereof, and the invite message, the response message, the synchronization message, or any combination thereof triggers transmission of a physical layer protocol data unit (PPDU) comprising a quality of service null frame, a BlockAck frame, a multi-station BlockACK frame, or any combination thereof.

Implementation 50: The method of any of implementations 11 through 17, wherein the coordinated spatial reuse procedure comprises a first type of coordinated spatial reuse procedure, the first type of coordinated spatial reuse procedure corresponding to a common preamble for the first PPDU and the second PPDU, the common preamble comprising a legacy short training field (L-STF), a legacy long training field (L-LTF), and a legacy signal (L-SIG).

Implementation 51: The method of any of implementations 11 through 18, wherein the coordinated spatial reuse procedure comprises a second type of coordinated spatial reuse procedure, the second type of coordinated spatial reuse procedure corresponding to a common preamble for the first PPDU and the second PPDU, the common preamble comprising a legacy short training field (L-STF), a legacy long training field (L-LTF), a legacy signal (L-SIG), and a universal signal (U-SIG).

Implementation 52: A first access point for wireless communications, comprising a processing system that includes processor circuitry and memory circuitry that stores code, the processing system configured to cause the first access point to perform a method of any of implementations 1 through 10.

Implementation 53: A first access point for wireless communications, comprising at least one means for performing a method of any of implementations 1 through 10.

Implementation 54: A non-transitory computer-readable medium storing code for wireless communications, the code comprising instructions executable by one or more processors to perform a method of any of implementations 1 through 10.

Implementation 55: A second access point for wireless communications, comprising a processing system that includes processor circuitry and memory circuitry that stores code, the processing system configured to cause the second access point to perform a method of any of implementations 11 through 19.

Implementation 56: A second access point for wireless communications, comprising at least one means for performing a method of any of implementations 11 through 19.

Implementation 57: A non-transitory computer-readable medium storing code for wireless communications, the code comprising instructions executable by one or more processors to perform a method of any of implementations 11 through 19.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point, comprising:
a processing system that includes processor circuitry and memory circuitry that stores code, the processing system configured to cause the first access point to:
transmit an invite message associated with a coordinated multiple access point transmission procedure, the invite message comprising baseline information that includes control information and preamble information, wherein the preamble information comprises information that pertains to a universal signal (U-SIG), information that pertains to at least one of a legacy signal (L-SIG) and a common field of an ultra-high reliability signal (UHR-SIG), user information associated with one or more user fields of the UHR-SIG, or any combination thereof;
receive, from a second access point and in response to transmission of the invite message, a response message associated with the coordinated multiple access point transmission procedure; and
transmit, in response to reception of the response message, a synchronization message that indicates that the coordinated multiple access point transmission procedure is to begin.

2. The first access point of claim 1, wherein:
the synchronization message includes second baseline information,
the second baseline information comprises second control information and second preamble information, and
the second preamble information comprises information that pertains to a second U-SIG, information that pertains to at least one of a second L-SIG and a common field of a second UHR-SIG, second user information associated with one or more user fields of the second UHR-SIG, or any combination thereof.

3. The first access point of claim 2, wherein:
the coordinated multiple access point transmission procedure comprises a coordinated beamforming procedure,
the information that pertains to the second U-SIG comprises at least one of a physical layer (PHY) version identifier, a bandwidth associated with the first access point, an indication of a transmission opportunity duration, an identifier associated with the first access point, an identifier associated with the second access point, an indication of the coordinated beamforming procedure, information associated with punctured channels, and an indication of a quantity of UHR-SIG symbols,
the information that pertains to at least one of the second L-SIG and the common field of the second UHR-SIG comprises at least one of a guard interval and long training field size, a quantity of users associated with the coordinated beamforming procedure, one or more second parameters associated with a physical layer protocol data unit (PPDU) length, and a quantity of UHR-long training field (UHR-LTF) symbols, and
the second user information associated with one or more user fields of the second UHR-SIG comprises user information associated with each user field, wherein the user information associated with each user field comprises at least one of a station identifier, an indication of a modulation and coding scheme, an indication of a basic service set (BSS) color, an indication of an access point, one or more third parameters associated with low-density parity-check (LDPC) encoding, an indication of enabling or disabling 2×LDPC, information associated with a spatial configuration, and an indication of a number of spatial streams.

4. The first access point of claim 1, wherein:
the invite message, the synchronization message, or any combination thereof comprises a trigger frame, wherein the trigger frame comprises a buffer status report poll (BSRP) trigger frame, a station-specific BSRP trigger frame, a multi-user request-to-send (MU-RTS) trigger frame, a MU-RTS transmit opportunity sharing (TXS) trigger frame, a new trigger type frame, or any combination thereof, and
the response message comprising a BlockAck frame, a multi-station BlockACK frame, or any combination thereof.

5. The first access point of claim 1, wherein:
the coordinated multiple access point transmission procedure comprises a coordinated beamforming procedure,
the information that pertains to the U-SIG comprises at least one of a physical layer (PHY) version identifier, a bandwidth associated with the first access point, an indication of a transmission opportunity duration, an identifier associated with the first access point, an identifier associated with the second access point, an indication of the coordinated beamforming procedure, and information associated with punctured channels,
the information that pertains to at least one of the L-SIG and the common field of the UHR-SIG comprises at least one of a guard interval and long training field size, a quantity of users associated with the first access point and the coordinated beamforming procedure, one or more second parameters associated with a physical layer protocol data unit (PPDU) length, one or more quantities of data orthogonal frequency division multiplexing (OFDM) symbols, one or more initial quantities of data OFDM symbols, a range of values associated with one or more data field durations, a minimum quantity of data OFDM symbols, a maximum quantity of data OFDM symbols, a minimum initial quantity of data OFDM symbols, and a maximum initial quantity of Data OFDM symbols, and
the user information comprises user information associated with each user field of the one or more user fields of the UHR-SIG, wherein the user information associated with each user field comprises at least one of a station identifier, and an indication of a number of spatial streams.

6. The first access point of claim 1, wherein the coordinated multiple access point transmission procedure comprises a coordinated beamforming procedure, and wherein the invite message comprises information indicating a threshold quantity of spatial streams associated with the second access point.

7. The first access point of claim 1, wherein the control information comprises an invitation for the second access point to participate in the coordinated multiple access point transmission procedure, bandwidth information associated with the second access point, synchronization leader information, an immediate response notification, a multi-access point scheme, an information type, or any combination thereof.

8. The first access point of claim 1, wherein:
the response message includes third baseline information that comprises third control information and third preamble information,
the third control information comprises an indication of participation of the second access point in the coordinated multiple access point transmission procedure, bandwidth information associated with the second access point, synchronization leader information, an immediate response notification, a multi-access point scheme, an information type, or any combination thereof, and
the third preamble information comprises information that pertains to a third U-SIG, information that pertains to at least one of a third L-SIG and a common field of a third UHR-SIG, third user information associated with one or more user fields of the third UHR-SIG, or any combination thereof.

9. The first access point of claim 8, wherein:
the coordinated multiple access point transmission procedure comprises a coordinated beamforming procedure,
the information that pertains to the third U-SIG comprises at least one of a physical layer (PHY) version identifier, a bandwidth associated with the second access point, an indication of a transmission opportunity duration, an identifier associated with the first access point, an identifier associated with the second access point, an indication of the coordinated beamforming procedure, and information associated with punctured channels,
the information that pertains to at least one of the third L-SIG and the common field of the third UHR-SIG comprises at least one of a guard interval and long training field size, a quantity of users associated with the second access point and the coordinated beamforming procedure, one or more second parameters associated with a physical layer protocol data unit (PPDU) length and low-density parity-check (LDPC) encoding, a data field duration, and a minimum quantity of data orthogonal frequency division multiplexing (OFDM) symbols, and
the third user information comprises user information associated with each user field of the one or more user fields of the third UHR-SIG that comprises at least one of a station identifier, an indication of a modulation and coding scheme, an indication of a basic service set (BSS) color, an indication of an access point, one or more third parameters associated with low-density parity-check (LDPC) encoding, an indication of enabling or disabling 2×LDPC, an indication of 2×LDPC capability, and an indication of a number of spatial streams.

10. The first access point of claim 1, wherein the coordinated multiple access point transmission procedure comprises a coordinated beamforming procedure, and wherein the response message comprises an indication of whether one or more extra long training fields (LTF) associated with the second access point are allowed.

11. The first access point of claim 1, wherein:
the coordinated multiple access point transmission procedure comprises a coordinated spatial reuse procedure,
the invite message indicates a first physical layer (PHY) version identifier for a first PHY protocol data unit (PPDU) corresponding to the coordinated spatial reuse procedure, a bandwidth associated with the first access point, a first threshold transmit power for transmission of a second PPDU by the second access point, information associated with punctured channels corresponding to the first PPDU, information pertaining info of a L-SIG for the first PPDU, a minimum quantity of data symbols, a maximum quantity of data symbols, a guard interval and long training field size for the first PPDU, a quantity of long training field (LTF) symbols, a transmit power for transmission of the first PPDU, or any combination thereof, and
the response message indicates a second PHY version identifier for a second PPDU corresponding to the coordinated spatial reuse procedure, a bandwidth associated with the second access point, a transmit power for transmission of the second PPDU by the second access point, information associated with punctured channels corresponding to the second PPDU, information pertaining info of a second L-SIG for the second PPDU, a candidate quantity of data symbols of the second L-SIG, a guard interval and LTF size for the second PPDU, a transmit power for transmission of the first PPDU, or any combination thereof.

12. The first access point of claim 11, wherein the synchronization message further indicates information corresponding to a final length field in an L-SIG field for the second PPDU and the first PPDU, parameters associated with a U-SIG for the first PPDU and the second PPDU, or any combination thereof.

13. The first access point of claim 12, wherein a packet size of the second PPDU is based at least in part on a common preamble for the first PPDU and a common preamble for the second PPDU each including an L-SIG field of a final length that corresponds to the final length field.

14. The first access point of claim 11, wherein one or more parameters for the coordinated multiple access point transmission procedure may be set values, the one or more parameters comprising a first modulation and coding scheme (MCS) for an extremely high throughput signal (EHT-SIG), a second MCS for the UHR-SIG, a first quantity of symbols for the EHT-SIG, a second quantity of symbols for the UHR-SIG, or any combination thereof.

15. The first access point of claim 11, wherein the coordinated spatial reuse procedure comprises a first type of coordinated spatial reuse procedure, the first type of coordinated spatial reuse procedure corresponding to a common preamble for the first PPDU and the second PPDU, the common preamble comprising a legacy short training field (L-STF), a legacy long training field (L-LTF), and a legacy signal (L-SIG).

16. The first access point of claim 11, wherein the coordinated spatial reuse procedure comprises a second type of coordinated spatial reuse procedure, the second type of coordinated spatial reuse procedure corresponding to a common preamble for the first PPDU and the second PPDU, the common preamble comprising a legacy short training field (L-STF), a legacy long training field (L-LTF), a legacy signal (L-SIG), and a U-SIG.

17. A method for wireless communications at a first access point, comprising:
transmitting an invite message associated with a coordinated multiple access point transmission procedure, the invite message comprising baseline information that includes control information and preamble information, wherein the preamble information comprises information that pertains to a universal signal (U-SIG), information that pertains to at least one of a legacy signal (L-SIG) and a common field of an ultra-high reliability signal (UHR-SIG), user information associated with one or more user fields of the UHR-SIG, or any combination thereof;
receiving, from a second access point and in response to transmission of the invite message, a response message associated with the coordinated multiple access point transmission procedure; and
transmitting, in response to reception of the response message, a synchronization message that indicates that the coordinated multiple access point transmission procedure is to begin.

18. The method of claim 17, wherein:
the synchronization message includes second baseline information,
the second baseline information comprises second control information and second preamble information, and
the second preamble information comprises information that pertains to a second U-SIG, information that pertains to at least one of a second L-SIG and a common field of a second UHR-SIG, second user information associated with one or more user fields of the second UHR-SIG, or any combination thereof.

19. A non-transitory computer-readable medium storing code for wireless communications, the code comprising instructions executable by one or more processors to:
transmit an invite message associated with a coordinated multiple access point transmission procedure, the invite message comprising baseline information that includes control information and preamble information, wherein the preamble information comprises information that pertains to a universal signal (U-SIG), information that pertains to at least one of a legacy signal (L-SIG) and a common field of an ultra-high reliability signal (UHR-SIG), user information associated with one or more user fields of the UHR-SIG, or any combination thereof;
receive, from a second access point and in response to transmission of the invite message, a response message associated with the coordinated multiple access point transmission procedure; and
transmit, in response to reception of the response message, a synchronization message that indicates that the coordinated multiple access point transmission procedure is to begin.

20. The non-transitory computer-readable medium of claim 19, wherein:
the synchronization message includes second baseline information,
the second baseline information comprises second control information and second preamble information, and
the second preamble information comprises information that pertains to a second U-SIG, information that pertains to at least one of a second L-SIG and a common field of a second UHR-SIG, second user information associated with one or more user fields of the second UHR-SIG, or any combination thereof.
